(19) United States
(12) Patent Application Publication
(10) Pub. No.: US 2024/0280596 A1
(43) Pub. Date: Aug. 22, 2024

(54) SAMPLE PROCESSING SYSTEMS, METHODS, AND DEVICES

(71) Applicant: RUBY ROBOTICS INC., Menlo Park, CA (US)

(72) Inventors: Jeffrey SCHLOSSER, San Carlos, CA (US); Daniel SHEN, Brookline, MA (US); Jeffery ALVAREZ, San Carlos, CA (US); Christopher TACKLIND, Menlo Park, CA (US)

(21) Appl. No.: 18/570,626

(22) PCT Filed: Jun. 14, 2022
(86) PCT No.: PCT/US2022/033463

§ 371 Date: Dec. 14, 2023

Related U.S. Application Data
(60) Provisional application No. 63/323,187, filed on Mar. 24, 2022.
(60) Provisional application No. 63/210,972, filed on Jun. 15, 2021.

(51) Int. Cl. G01N 35/00; B01L 9/00; G01N 1/28; G01N 1/30; G02B 21/34

(52) U.S. Cl. CPC G01N 35/00029; B01L 9/52; G01N 1/2813; G01N 1/30; G02B 21/34; B01L 2200/025; B01L 2200/04; B01L 2300/041; B01L 2300/069; B01L 2300/0822; G01N 2035/00138

(57) ABSTRACT

The present disclosure provides systems, methods, and devices for sample processing. Sample processing may include rapid onsite evaluation of samples as well as additional types of sample processing. The sample processing methods and techniques provided herein facilitate consistent and rapid sample processing to obtain sample slides and sample images. The sample processing systems and devices provided herein facilitate the sample processing methods.

### RELATED INVENTIONS

The present application claims priority to U.S. Provisional Application No. 63/210,972, filed Jun. 15, 2021 and U.S. Provisional Application No. 63/323,187, filed Mar. 24, 2022, each of which are incorporated herein by reference.

### TECHNICAL FIELD

The present invention is directed to systems, methods, and devices configured to facilitate sample processing, including automated sample processing and rapid on-site sample evaluation.

### BACKGROUND

Rapid On-Site Evaluation (ROSE) is an important aspect of biopsy procedures that can decrease the number of needle passes, increase patient safety, and increase diagnostic yield. A purpose of ROSE is to determine whether a biopsy sample has adequate cellular and tissue content to produce a definitive diagnosis when analyzed in a pathology lab. Other uses for ROSE include informing tissue collection and triage, as well as providing a preliminary diagnosis to the interventionalist.

Traditionally in ROSE, a biopsy sample is smeared or touch imprinted onto a glass slide by a cytotechnologist or cytopathologist to create a thin layer of cellular material. The slide is then manually stained to increase contrast between different biological elements of the slide using a rapid stain such as Diff Quik, Toludine Blue, or others. Finally, the slide is examined by cytology personnel under a light microscope and analyzed for adequacy, triage, and/or preliminary diagnosis.

ROSE has proven its utility in a wide range of biopsy sites including thyroid, liver, pancreas, lung, breast, sentinel lymph nodes, bone marrow, and more. ROSE is recommended by many leading clinical societies such as the Pulmonary Pathology Society, Papanicolaou Society of Cytopathology, and American Thyroid Association. Furthermore, ROSE may become increasingly important in procedures such as bronchoscopic lung biopsy in order to facilitate delivery of therapeutics (cryotherapy, microwave ablation, drug delivery, etc.) immediately following ROSE-facilitated confirmation of positive biopsy results.

However, ROSE is only used in roughly half of non-dermatological biopsy procedures due to cytology staff shortages, logistical challenges, and pathologist bandwidth. These challenges are amplified in procedures such as bronchoscopic lung biopsy, EndoBronchial UltraSound (EBUS) lymph node staging, and percutaneous CT-guided biopsy, since long procedure times put additional strain on the cytology department's resources. Furthermore, ROSE adequacy and diagnosis is subject to interoperator variability in both slide preparation and interpretation—no two cytologists will produce an equivalent slide or make the same adequacy call—which is often a source of frustration and time delays for the interventional staff. For complex procedures such as bronchoscopic lung biopsy, 20-40% or more of biopsies are unsuccessful in providing an ultimate diagnosis in the pathology lab—requiring repeat biopsy procedures—even with the use of traditional ROSE methods.

Given the shortcomings of traditional ROSE, it is not surprising that other approaches have been tried to improve the process of adequacy assessment and on-site diagnosis. There are several devices that provide ROSE slide digitization and transmission, or telerobotic microscopes that enable cytopathologists to view ROSE slides remotely. However, such devices still rely on cytology personnel in the operating room to prepare slides, which does not overcome the associated logistical and interoperator variability problems with some ROSE implementations.

Some potential solutions, such as raman scattering microscopy of excised tissue and needle-based confocal laser microscopy are being pursued. While attractive in principle, these approaches do not match the resolution and fidelity of tissue imaged on glass slides. Furthermore, these approaches create unfamiliar images which requires new training for interventionalists and pathologists.

Accordingly, there is a need for improved sample processing methods and technology to reduce sample processing times, increase uniformity of sample processing, and reduce operator hours required for sample processing.

### SUMMARY

In an embodiment, a method of sample separation is provided. The method may include depositing a sample in a sample receptacle, the sample receptacle comprising a membrane; aligning the sample receptacle with a sample slide; applying a probe to an underside of the sample receptacle to cause a motion of the membrane; pressing the sample to the sample slide via the motion to deposit at least a portion of the sample on the sample slide.

In an embodiment, a method of sample smearing is provided. The method may include engaging, via an actuated probe, a gripping device with a first side of a smear plate; controlling the actuated probe to cause contact between a second side of the smear plate and a sample disposed on a surface of the sample slide; controlling a force applied to the smear plate during contact with the sample; causing relative movement between the smear plate and the sample slide to distribute the sample on the surface of the sample slide.

In an embodiment, a method of sample staining is provided. The method may include arranging a sample slide and a coverslip in a flood start position; the flood start position being defined such that a slide surface of the sample slide having a sample disposed thereon and a slip surface of the coverslip have a vertical gap and the sample slide and the coverslip have a horizontal overlap, the vertical gap and the horizontal overlap defining a volume; applying a fluid to at least one of the sample slide or the coverslip such that the fluid is present at the vertical gap when the sample slide and the coverslip are arranged in the flood start position; arranging the sample slide and the coverslip in a flood finish position through relative movement that increases the horizontal overlap, the flood finish position being defined such that the horizontal overlap has a maximum horizontal distance, thereby causing the fluid to fill the volume; and applying additional fluid to the at least one of the sample slide or the coverslip to fill the volume as the horizontal overlap increases.

In an embodiment a sample cartridge is provided. The sample cartridge may include a first cartridge component including a slide support configured to support a sample slide; and a second cartridge component including a coverslip support configured to support a coverslip at a coverslip window, the second cartridge component being configured for movement relative to the first cartridge component, wherein: the first cartridge component and the second cartridge component are configured to cooperate to maintain a vertical gap between the sample slide and the coverslip, and the second cartridge component is further configured to move from a flood start position relative to the first cartridge component to a flood finish position relative to the first cartridge component.

In an embodiment a method for sample preparation is provided. The method may include arranging a sample slide disposed within a first cartridge component of a sample cartridge and a coverslip disposed within a second cartridge component of the sample cartridge in a flood start position, the flood start position being defined such that a slide surface of the sample slide having a sample disposed thereon and a slip surface of the coverslip have a vertical gap and the sample slide and the coverslip have a horizontal overlap, the vertical gap and the horizontal overlap defining a volume; receiving a fluid at a vertical gap between the sample slide and the coverslip; and moving the second cartridge component relative to the first cartridge component from a flood start position to a flood finish position.

In an embodiment a sample processing system is provided. The sample processing system may include at least one processing circuit; an insertion bay configured to receive a sample cartridge having a first cartridge component and a second cartridge component; a cartridge drive system, controllable by the at least one processing circuit and configured to generate relative movement between the first cartridge component and the second cartridge component.

In an embodiment, a sample cartridge is provided. The sample cartridge may include one or more sample receptacles; one or more sample slides; one or more staining fluids; and one or more cover slips.

In an embodiment, a sample processing system is provided. The sample processing system includes a sample handling system including: a sample transfer mechanism, a sample smearing mechanism, and a sample movement mechanism; a fluid distribution system; and a control system.

In an embodiment, a sample cartridge is provided. The sample cartridge comprises a first cartridge component including a slide support configured to support a sample slide; and a second cartridge component including a receptacle window, the second cartridge component being configured for movement relative to the first cartridge component, wherein: the second cartridge component is configured to adopt a sampling position relative to the first cartridge component to support a sample receptacle, and the second cartridge component is configured to adopt a transfer position relative to the first cartridge component aligning the receptacle window with the slide support in a position that permits transfer of a sample in the sample receptacle to the sample slide when positioned in the slide support.

In an embodiment, a method for sample preparation is provided. The method comprises depositing a sample in a sample receptacle of a sample cartridge having a first cartridge component and a second cartridge component arranged in a sampling position relative to one another; moving the second cartridge component relative to the first cartridge component from the sampling position to a transfer position that aligns a sample slide supported in a slide support of the first cartridge component with a receptacle window of the second cartridge component; and transferring the sample from the sample receptacle to the sample slide.

In an embodiment, a sample cartridge is provided The sample cartridge includes a first cartridge component including a slide support configured to support a sample slide; and a second cartridge component including a smear plate support configured to support a smear plate, wherein: the second cartridge component is configured to adopt a smear position relative to the first cartridge component aligning the smear plate with the sample slide for smearing the sample.

In an embodiment, a method for sample preparation is provided. The method comprises arranging a second cartridge component of a sample cartridge relative to a first cartridge component of the sample cartridge to a smear position that aligns a smear plate support of the second cartridge component with a sample slide supported by the first cartridge component; and smearing the sample against the sample slide with a smear plate disposed within the smear plate support.

### BRIEF DESCRIPTION OF THE DRAWINGS

The accompanying figures, which are incorporated herein, form part of the specification and illustrate embodiments of systems, methods, and devices for rapid on-site cytological evaluation. Together with the description, the figures further explain the principles of and enable a person skilled in the relevantart(s) to make and use the methods, systems, and devices described herein. The drawings are provided to illustrate various features of the embodiments described herein and are not necessarily drawn toscale. In the drawings, like reference numbers indicate identical or functionally similar elements.

FIG. 1 illustrates an integrated sample processing system consistent with embodiments hereof.

FIGS. 2A-C illustrate a sample cartridge consistent with embodiments hereof.

FIGS. 2D-F illustrate a cartridge frame consistent with embodiments hereof.

FIGS. 2G-I illustrate a cartridge drawer consistent with embodiments hereof.

FIGS. 2J-2L illustrate sample processing components consistent with embodiments hereof.

FIGS. 2M-2N illustrate fluid storage components consistent with embodiments hereof.

FIGS. 3A-H illustrate features of the sample cartridge consistent with embodiments hereof.

FIGS. 4A-E illustrate a sample receptacle consistent with embodiments hereof.

FIG. 5 illustrates a sampling position of the sample cartridge consistent with embodiments hereof.

FIG. 6 illustrates a receptacle release position of the sample cartridge consistent with embodiments hereof.

FIG. 7 illustrates a transfer position of the sample cartridge consistent with embodiments hereof.

FIG. 8 illustrates a smear position of the sample cartridge consistent with embodiments hereof.

FIGS. 9A-B illustrate an eject position of the sample cartridge consistent with embodiments hereof.

FIGS. 10A-10D illustrate a series of staining positions of the sample cartridge consistent with embodiments hereof.

FIG. 11 illustrates a computer system consistent with embodiments hereof

FIGS. 12A and 12B illustrate features of an integrated sample processing system consistent with embodiments hereof.

FIG. 13 illustrates a sample movement mechanism consistent with embodiments hereof.

FIGS. 14A-D illustrate aspects of the sample transfer mechanism of the sample handling system consistent with embodiments hereof.

FIG. 15 illustrates aspects of the sample smearing mechanism of the sample handling system consistent with embodiments hereof.

FIGS. 16A-16B illustrates aspects of the fluid distribution system consistent with embodiments hereof.

FIGS. 17A-17C illustrate a slide ejection operation consistent with embodiments hereof.

FIG. 18 illustrates a receptacle receipt system consistent with embodiments hereof.

FIG. 19 illustrates a sample processing method consistent with embodiments hereof.

FIGS. 20A and 20B illustrate a sample transfer operation consistent with embodiments hereof.

FIGS. 21A and 21B illustrate a sample transfer operation consistent with embodiments hereof.

FIG. 22 illustrates features of a sample cartridge consistent with embodiments hereof.

FIGS. 23A and 23B illustrate features of a sample slide consistent with embodiments hereof.

### DETAILED DESCRIPTION

The following detailed description is merely illustrative in nature and is not intended to limit the invention or the application and uses of the invention. Although the description of the invention is in the context of systems, methods, and devices for facilitating automated ROSE techniques, the disclosure should not be considered so limiting. For example, although systems, methods, and devices may be discussed herein with respect to ROSE of biopsy samples, any biological samples may be suitable for analysis by embodiments hereof. Modifications may be made to the embodiments described herein without departing from the spirit and scope of the present invention. Therefore, the following detailed description is not meant to be limiting. Furthermore, there is no intention to be bound by any expressed or implied theory presented in the preceding technical field, background, summary, or the following detailed description.

The present disclosure addresses issues outlined above. The disclosure presents a robotic automated sample processing device that rapidly produces consistent high-resolution cytologic images using raw biopsy samples harvested by an interventional staff, and is therefore suitable for ROSE. Images may be displayed directly to the interventionalist on the machine, and also available to be transmitted for remote consultation by a cytopathologist. Al algorithms may assist the cytopathologist by identifying important regions of interest and cell types. As enabled by highly repeatable sample preparation and imaging, fully automated adequacy and diagnosis (using AI) may be available directly to the interventionalist without the need for remote consultation.

With the approach described herein, the interventionalist and remotely located cytopathologist may view high resolution smear images that are prepared and stained in a familiar manner, without the need for on-site cytology personnel. Accordingly, embodiments of the disclosure provided herein may serve to reduce operator hours performing ROSE, increase throughput, reduce time to result, and increase result consistency.

Embodiments disclosed herein may facilitate rapid evaluation of samples by sample separation techniques that use a minimum or reduced amount of sample as compared to other methods. The remainder of the collected sample, which may be a majority or large majority of the collected sample, may then be preserved for further analysis if required. Sample transfer and separation techniques discussed herein may further be configured to preserve the structure of samples to assist in further analysis.

In embodiments, the systems, methods, and devices described herein may be used to assess, measure, or evaluate therapeutic effects on sample tissue. For example, after a therapy has been delivered (e.g., drug, ablation, etc.), tissue may be harvested to determine the efficacy of therapy. For example, tissue sampled from an area in the periphery of a tumor after an ablation may be evaluated to ensure or determine that the area was sufficiently ablated on a cellular level. Similarly, tissue sampled from an area in the periphery of a tumor after a drug is injected intratumorally may be evaluated to ensure or determine that the drug sufficiently penetrated the tissue on a cellular level.

The present disclosure describes devices, systems, and methods for facilitating sample processing. Sample processing methods described herein involve the collection, deposition, transfer, smearing, staining, and assessment of samples (e.g., a tissue sample or other biological sample). Sample processing devices described herein include a sample cartridge having various features that facilitate, enable, or enhance the sample processing methods described herein. Sample processing systems described herein include an integrated sample processing system that is configured to carry out one or more of the sample processing steps described above, optionally using aspects of the sample cartridge described herein. An embodiment of sample processing is described herein that employs an integrated sample processing system performing a sample processing method though use of a sample cartridge. This combination of features are discussed by way of example only, and the sample processing methods, sample cartridges, and integrated sample processing system described herein may each be used or employed with alternate methods, systems, and devices, as the case may be. Further, individual aspects of each of the methods, systems, and devices described herein may be employed individually or in any suitable combination with any other individual aspects of the methods, systems, and devices described herein. Some of these individual combinations may be discussed herein for example or illustrative purposes. Although the extensive variety of all such combinations prevents an individual description of each combination herein, it is understood that all such combinations fall within the scope of this disclosure.

For example, any of the methods or portions of the methods described herein may be carried out with suitable portions of the devices and systems described herein without requiring the entirety of the devices and systems described herein and/or may be employed with alternate devices and systems. Some methods or portions of methods may also be carried out manually with suitable portions of the devices described herein and or with systems described herein using different devices. Devices described herein may be carried out with suitable portions of the methods and systems described herein without requiring the entirety of the methods and systems described herein and/or may be employed with alternate methods and systems. Systems described herein may be carried out with suitable portions of the methods and devices described herein without requiring the entirety of the methods and devices described herein and/or may be employed with alternate methods and devices.

In embodiments, The integrated sample processing system 100 may be configured to work with common glass slides. This arrangement may place certain demands on the integrated sample processing system 100 for precise manipulators, grippers, and other positioning actuators. In embodiments, as described herein, the sample processing system 100 may be configured to accept one or more purpose built cartridges, such as sample cartridge 200, described below. Such a sample cartridge 200 may include some or all of the sample processing components needed for a particular sample processing sequence. Sample processing components may include, but are not limited to a sample slide or multiple sample slides, a coverslip, a smearing element (e.g., a smear plate), a sample collection receptacle, and one or more stain storage units. The sample cartridge may hold each element with sufficient relative position as needed for the sample processing steps. By incorporating suitable precision within the sample cartridge, the precision demands on the processing system may be reduced accordingly. Further, the sample cartridge may also be configured to contain all of the contaminated elements for safe disposal and prevention of contaminating the processing system.

The present disclosure may include references to relative terms such as “top,” “bottom,” “up,” and “down.” These terms are used for clarity and ease of reference. For example, a “top” of a structure or device may refer to the portion of that structure or device that faces up during usage as described herein. Relative directional terms as used herein are not limiting and do not limit the orientations, positions, angles, or functionality of the structures and devices discussed herein. Furthermore, the methods, systems, and devices as discussed herein are not limited to use in the orientations as described herein. For example, although the sample cartridge is described with a sample slide “above” a coverslip, the disclosure is not limited to this arrangement. One or more aspects of the system may be inverted with respect to the orientations disclosed herein without departing from the scope of this disclosure.

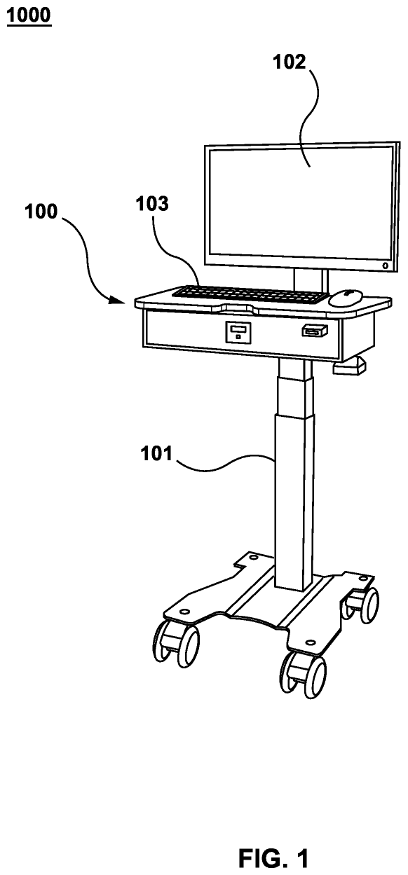

FIG. 1: illustrates a rapid onsite evaluation system consistent with embodiments hereof. The rapid onsite evaluation system 1000 may include various components. The components may be housed on a moveable cart 101 or as a benchtop system. Components may include a cart chassis with wheels, an integrated sample processing system 100 that prepares and images the biopsy samples, display 102 for viewing a prepared and imaged sample, and a user interface 103, including one or more user input devices, storage for disposable cartridges (into which the biopsy samples may be loaded and one or more consumable repositories. A waste fluid bin may also be included. The integrated sample processing system 100 may include one or more input slots into which disposable cartridges with sample may be loaded, one or more output slots for retrieving prepared slides for future analysis, and an area to retrieve used cartridges that are ready for disposal. Additionally, there may be controls, such as one or more user input devices of a user interface 103, on the cart that facilitate inputting system parameters and performing operations such as manipulating the microscope image on the screen by panning, zooming, and jumping to various regions of interest.

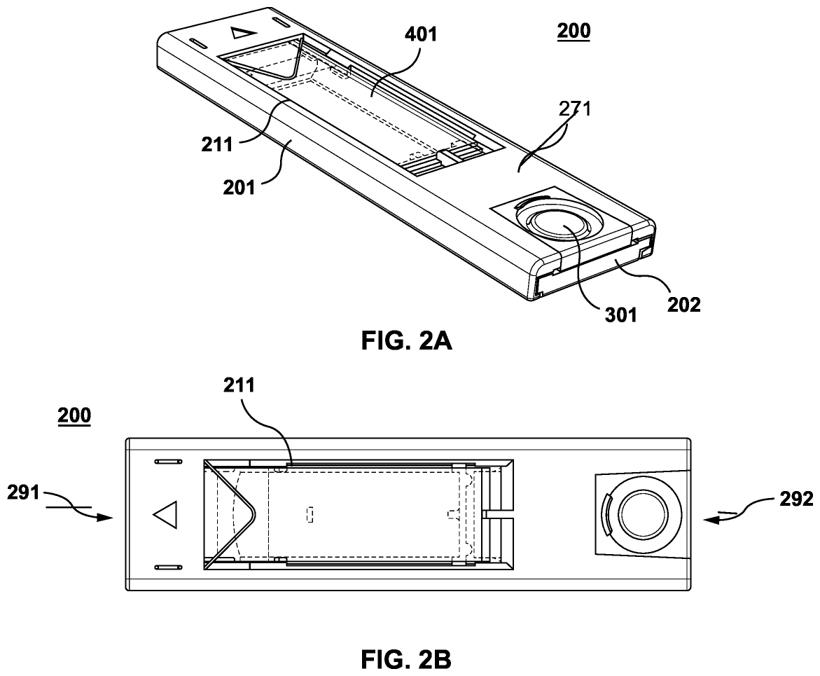

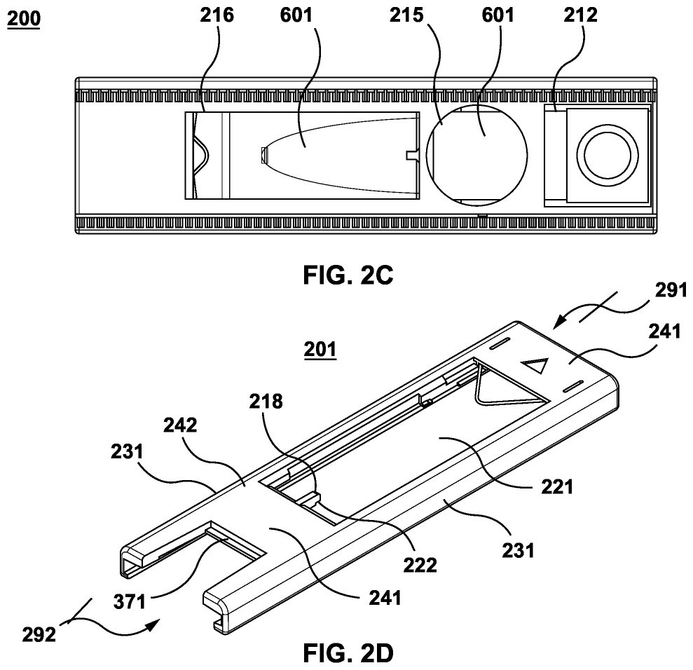

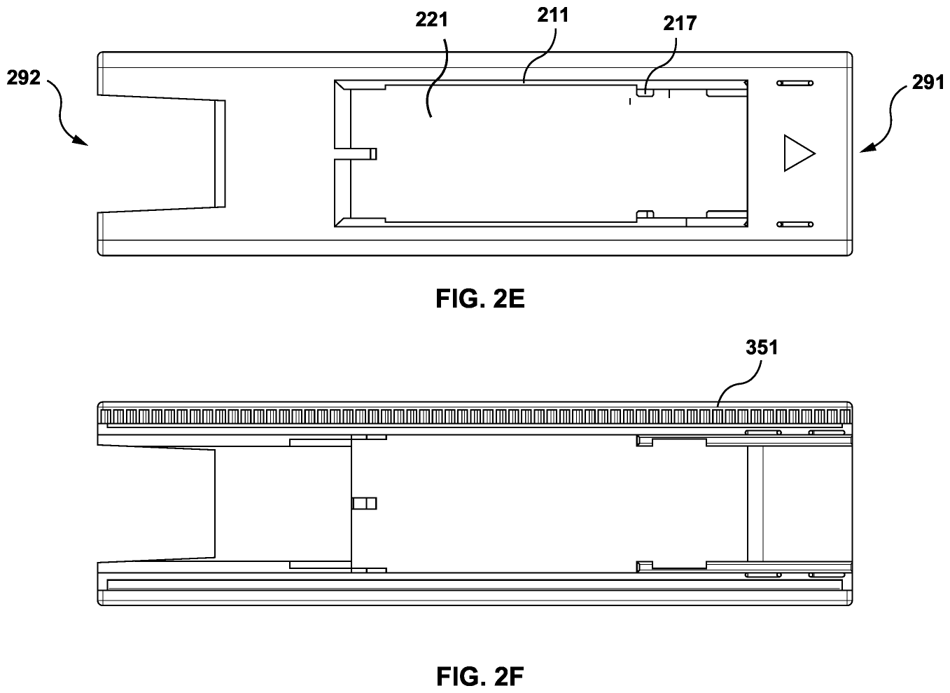

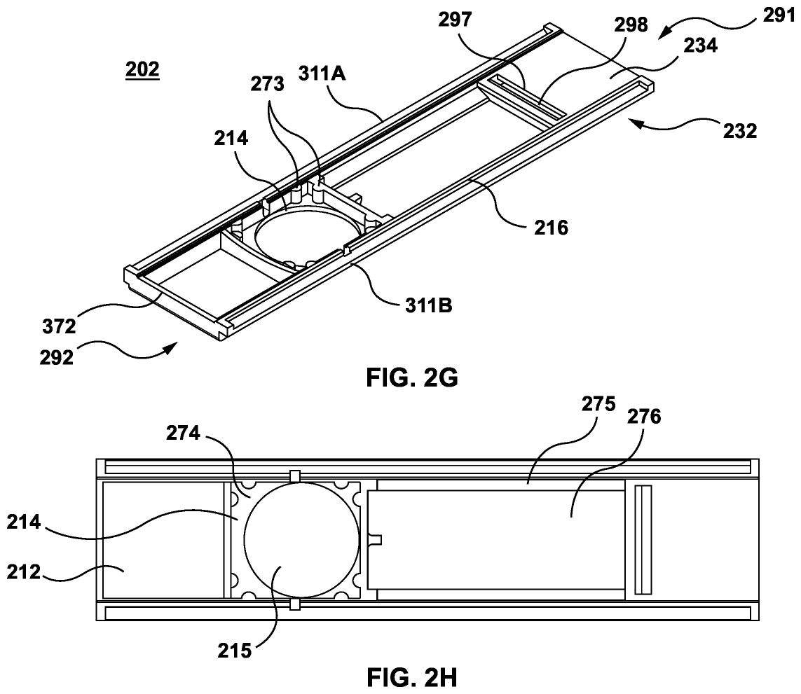

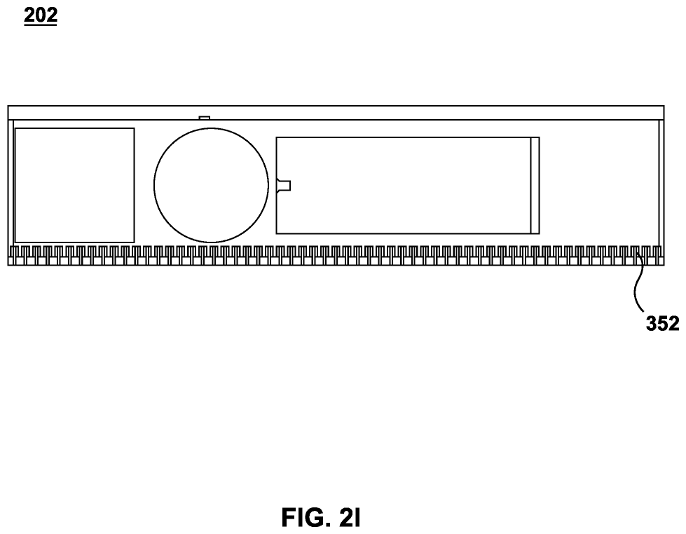

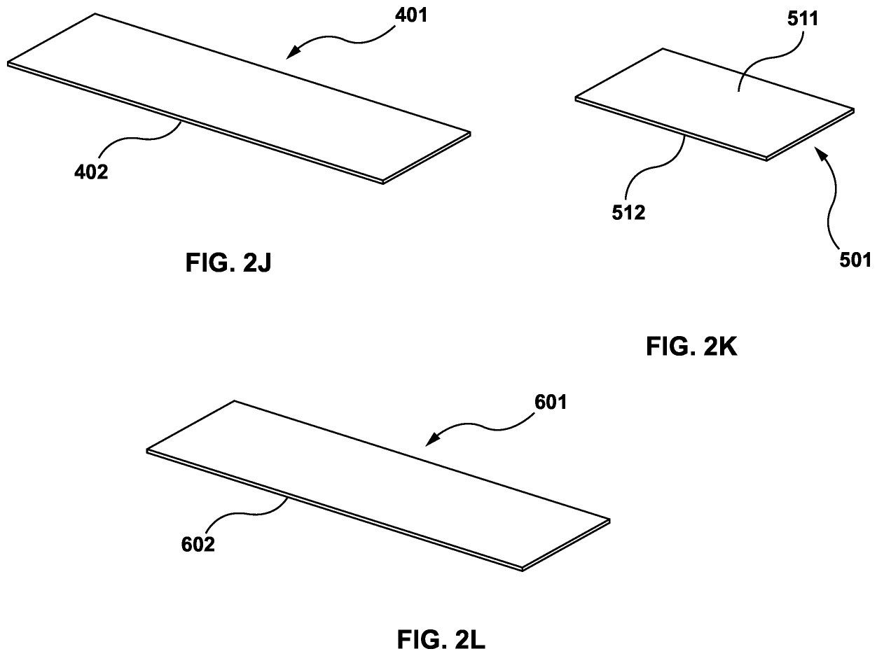

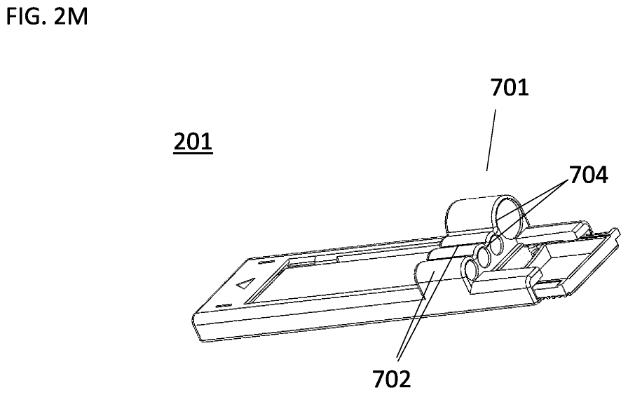

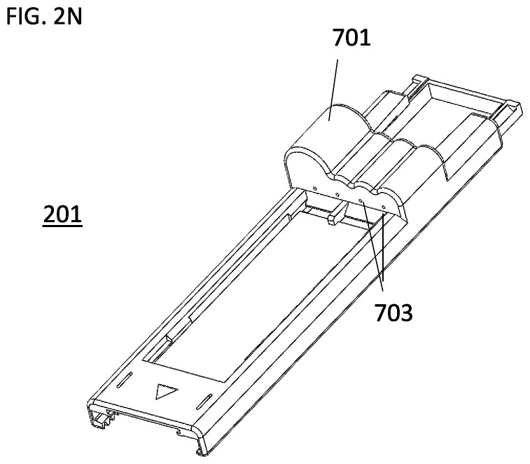

FIGS. 2A-C illustrate a sample cartridge consistent with embodiments hereof. The sample cartridge 200 is engineered to maximize ease of use for the interventional team, minimize system maintenance, and facilitate isolation and disposal of biological material. Sample cartridges 200 may include an opening or receptacle for sample insertion, one or more sample slides for microscope imaging, a moveable smearing element, such as a smear plate, and one or more stain storage units. The sample cartridge 200, as described herein, may facilitate sample processing methods described herein by providing a structure to contain and align sample processing components. The sample cartridge 200, which may be disposable, may also facilitate the isolation and disposal of biological material by providing a defined housing for the sample processing components.

The sample cartridge 200 includes a first cartridge component and a second cartridge component configured for relative movement in a dimension, such as a linear dimension, with respect to one another. As used herein, relative movement refers to a change in position of two components with respect to one another. During relative movement, one or both of the components may experience absolute movement with respect to an outside reference frame. During relative movement, one of the components may remain still with respect to an outside reference frame. Relative movement in further dimensions may be limited or unavailable. In embodiments, as discussed herein, the first cartridge component includes a cartridge frame 201 and the second cartridge component includes a cartridge drawer 202 configured for relative movement with respect to one another. The sample cartridge 200 may be configured to support and facilitate the manipulation of one or more sample processing components during sample processing. The sample processing components may include at least a sample receptacle 301, one or more sample slides 401, a smear plate 501, and a coverslip 601.

FIGS. 2D-F illustrate a cartridge frame consistent with embodiments hereof. The cartridge frame 201 may be generally rectangular in shape, having a pair of cartridge walls 231 extending substantially parallel to one another over a length of the cartridge frame 201. The cartridge frame 201 further includes a bridge portion 241 extending between the cartridge walls 231 and having an exterior surface 242. The cartridge frame 201 may have a leading end 291 and a trailing end 292. The terms “leading” and “trailing” are used for the convenience of reference only, and do not limit the orientation or functionality of the cartridge frame 201. The cartridge frame 201 is configured to support one or more sample slides 401 at a slide support 211 disposed within the bridge portion 241. The cartridge frame 201 is further configured to provide at least partial support to a sample receptacle 301 by cooperating with the cartridge drawer 202 to support the sample receptacle, as discussed in greater detail below. In embodiments one or more sample slides 401 may optionally be included with the sample cartridge 200. Further features of the cartridge frame 201 are discussed in greater detail below.

The sample slide(s) 401 may be conventional glass slides and/or may be made of any other material suitable for sample imaging. The sample slide(s) 401 may be generally flat (e.g., having a length and width significantly larger than a height) and may be shaped according to any suitable shape. In embodiments, the sample slides 401 may be sized and shaped according to conventional slides or may be sized and shaped according to any other suitable size. In embodiments, the sample slides 401 may be replaced by other types of kinds of sample substrates. For example, a sample substrate containing a plurality of microwells may be employed in place of the sample slides 401, as discussed further below.

The slide support 211 includes a slide window 221, support tabs 217, a support arm 218, and support clip 219. The slide window 221 is an opening or aperture in the bridge portion 241. In embodiments, the slide window 221 is approximately a same width as a sample slide 401. In embodiments, the slide window 221 may be longer than a length of the sample slide 401. The slide window 221 may have a first end located proximal to the leading end 291 and a second end located proximal to the trailing end 292.

The support tabs 217 extend inwards from the bridge portion 241 into the slide window 221 to provide a surface on which the sample slide(s) 401 may rest. Thus, the support tabs 217 are configured for location below the sample slide(s) 401 to support the sample slide(s) 401. The support tabs 217 are arranged on the long sides of the slide window 221. The support tabs 217 may include two support tabs 217 (or any appropriate number), located opposite one another. In embodiments, the support tabs 217 may include two support tabs 217 opposing each other and extending over all or a portion of the length of the slide window 221.

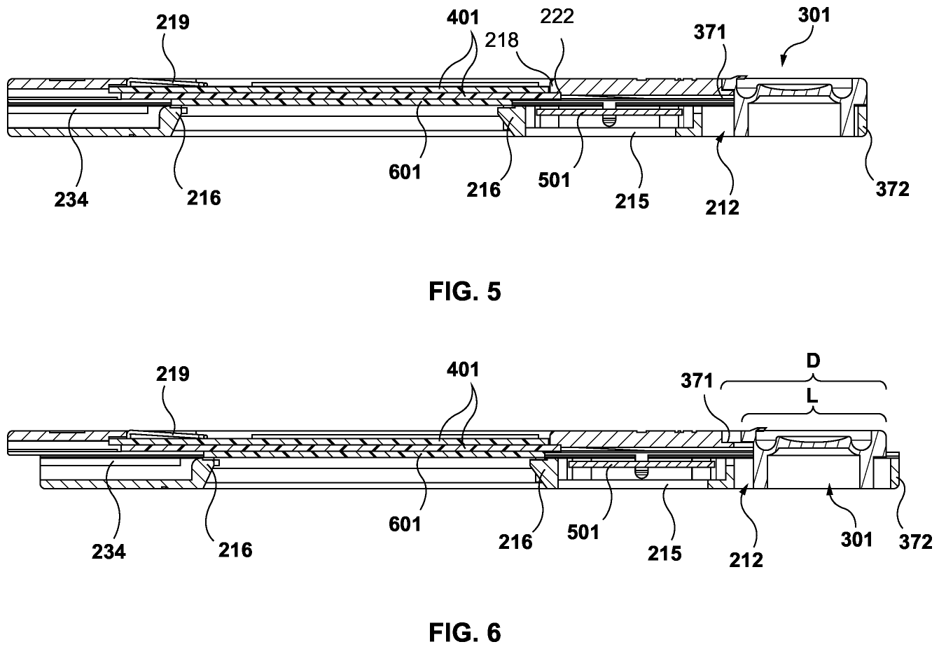

The support arm 218 extends inward into the slide window 221 from the bridge portion 241 at the first end of the slide window 221. The support arm 218 is configured with a support notch 222 (best viewed in FIG. 5). The support notch 222 of the support arm 218 contacts a top surface a sample slide 401 when the sample slide 401 is disposed within the slide support 211. When two sample slides 401 are disposed within the slide support 211, the support notch 222 contacts the top surface of the bottom sample slide 401. When one sample slide 401 is disposed within the slide support 211, the support notch 222 contacts the top surface of the one sample slide 401.

The support clip 219 extends inward into the slide window 221 from the bridge portion 241 at the second end, opposite the first end, of the slide window 221. The support clip 219 is a rotatable structure, configure to rotate around a location proximal to the trailing end 292 into the slide window 221. The support clip 219 may be constructed of metal, plastic, etc. The support clip 219 is biased (for example, spring loaded) towards the sample slides 401 disposed within the slide support 211. Thus, the support clip 219 provides a downward force on sample slides 401. In an embodiment, the support tabs 217 do not extend beyond the location at which support clip 219 contacts the sample slides 401. This arrangement causes the force provided by the support clip 219 to generate a torque around the support tabs 217 (acting as a fulcrum) that the sample slide 401 is resting on. The torque is opposed by the support arm 218 located at the opposite end of the slide window 221 from the support clip 219. Thus, the sample slides 401 may be held in place by a downward force applied by the support clip 219 at one end to the stack of two sample slides 401 and a downward force applied by the support arm 218 at an opposite end to the bottom sample slide 401 of the stack. When the bottom sample slide 401 is removed, as discussed below, the support clip 219 and the support arm 218 may both apply force to the top surface of the same sample slide 401.

This arrangement, wherein the sample slide(s) 401 are supported by the sample cartridge 200 at only a few points may prevent any twisting, bending, or torqueing forces that the sample cartridge 200 is subject to from being transferred to the sample slide(s) 401. Thus, the sample slide(s) 401, which may comprise a brittle material such as glass, may be protected from breakage due to rough handling of the sample cartridge 200.

FIGS. 2G-I illustrate a cartridge drawer consistent with embodiments hereof. The cartridge drawer 202 may be generally rectangular in shape including a generally rectangular cartridge base 232. The cartridge drawer 202 is configured to support a smear plate 501 at a smear plate support 214, to support a coverslip 601 at a coverslip support 216, and to provide at least partial support to the sample receptacle 301, as discussed further below. Each of the smear plate support 214 and the coverslip support 216 may be disposed within the cartridge base 232. In embodiments, one or more of the smear plate 501, the coverslip 601, and the sample receptacle 301 may optionally be included with the sample cartridge 200. Further features of the cartridge drawer 202 are discussed in greater detail below.

The smear plate 501 (FIG. 2K) may have a substantially flat first surface 511 and, optionally, a substantially flat second surface 512. The smear plate 501 is generally planar, having a width and length larger than a height. For example, the smear plate 501 may be approximately square or rectangular, with a length and width 5x or more larger than a height. The smear plate 501 may have a substantially flat first surface 511 configured for smearing a sample between the first surface 511 and the sample slide 401. The second surface 512, opposite the first surface 511, may also be substantially flat to facilitate gripping by a suction cup, as discussed further below. In further embodiments, the second surface 512 may also include additional or different features to facilitate gripping by any type of automated or manual gripping device. In examples, the smear plate 501 may be a glass slide. In further embodiments, the first surface 511 of the smear plate 501 may have a substantially flat portion configured for sample smearing and may further have one or more features to facilitate a smearing operation. For example, the first surface 511 may include one or more tabs configured to offset the smear plate 501 from another surface to which is brought into proximity.

The smear plate 501 may be disposed within a smear plate support 214. The smear plate support 214 may include a plurality of guides 273 surrounding a perimeter of the smear plate 501 when it is positioned within the smear plate support 214. The smear plate support 214 may further include a support frame 274 surrounding a smear plate window 215. The support frame 274 is a surface configured to support the smear plate 501 within the cartridge drawer 202. The guides 273 of the smear plate support 214 may be columns, tabs, partial walls, or any other structure, e.g. extending approximately perpendicular from the support frame 274. The guides 273 may be configured to not surround the smear plate 501 completely or may be configured as walls to completely surround the smear plate 501. The guides 273 of the smear plate support 214 serve to contain and guide movement of the smear plate 501. The smear plate window 215 is configured to permit an actuated probe, arm, or other tool to interact with the smear plate 501 from external to the sample cartridge 200.

The cartridge drawer 202 further includes a coverslip support 216. The coverslip support 216 includes a support tab 275 extending into a coverslip window 276 and a support ledge 277 disposed at a perimeter of the coverslip window 276 opposite to the support tab 275. The coverslip window 276 is an aperture or window in the cartridge base 232. The coverslip window 276 is sized larger than the coverslip 601 such that the support tab 275 contacts the coverslip 601 at one end and the support ledge 277 contacts the coverslip 601 at the other end while leaving the long edges of the coverslip 601 unsupported when the coverslip is positioned within the cartridge drawer 202. The coverslip 601 may be a transparent, flat piece of material, e.g., glass or plastic. In embodiments, the coverslip 601 may include a rounded end, as illustrated in FIG. 2H, which may facilitate fluid drainage as discussed further below. In embodiments, the coverslip 601 may be secured to the cartridge drawer 202 via adhesive. This arrangement, wherein the coverslip 601 is supported by the sample cartridge 200 at only a few points may prevent any twisting, bending, or torqueing forces that the sample cartridge 200 is subject to from being transferred to the coverslip 601. Thus, the coverslip 601, which may comprise a brittle material such as glass, may be protected from breakage due to rough handling of the sample cartridge 200.

In embodiments, the coverslip 601 may be releasably secured within the cartridge drawer 202. Some sample staining protocols (e.g., DiffQuik) may benefit from the coverslip 601 remaining within the sample cartridge and separate from the prepare sample slide 401 for subsequent processing and imaging purposes. Such protocols may be facilitated by securement of the coverslip 601 to the cartridge drawer 202. Some sample staining protocols (e.g., Toludine Blue) may rely on the coverslip 601 remaining adhered to the sample slide 401 for subsequent processing and imaging purposes. Such protocols may be facilitated by releasability of the coverslip 601 from the cartridge drawer 202.

The cartridge frame 201 and the cartridge drawer 202 are configured to facilitate sample collection, preparation, and staining (collectively referred to as sample processing) via manual, partially manual, and/or automated means. The cartridge frame 201 and the cartridge drawer 202 are configured to cooperate with one another to facilitate sample processing.

As discussed above, the sample cartridge includes a first cartridge component and a second cartridge component defined by being functionally capable of interlocking with one another and of moving relative to one another in a first dimension, for example, a linear dimension, while having limited movement with respect to one another in other dimensions. For example, in an x-y-z space, the first cartridge component and the second cartridge component may be configured for relative movement in the x dimension while having more limited relative movement in the y and z dimensions. In another example, the first dimension may be a rotational dimension. As described below, limited relative movement in the y or z dimensions may be permitted for functional and/or manufacturing reasons. In embodiments described herein, the first cartridge component may be a cartridge frame 201 and the second cartridge component may be a cartridge drawer 202. The cartridge frame 201 and the cartridge drawer 202 are not limited by the specific embodiments described above and are not limited by any structural implications of the use of the terms “frame” and “drawer.” For example, embodiments described herein include description of the cartridge frame 201 being configured to receive the cartridge drawer 202. In further embodiments, the cartridge drawer 202 may be configured to receive the cartridge frame 201. In another example, in an embodiment, one of the cartridge walls 231 of the sample cartridge 200 may be disposed on the cartridge drawer 202 and the other cartridge wall 231 of the sample cartridge 200 may be disposed on the cartridge frame 201. In an embodiment, the cartridge drawer 202 may include the pair of cartridge walls 231 while the cartridge frame 201 includes no cartridge walls 231. Further, the various supports for the sample processing components may be disposed on the cartridge drawer 202 or the cartridge frame 201 in any suitable combination. For example, the sample slide 401 may be supported by the cartridge drawer 202 while the coverslip 601 is supported by the cartridge frame 201.

The cartridge frame 201 and the cartridge drawer 202 are configured for relative movement with respect to one another to adopt or establish various positions for facilitating or enabling different aspects of the sample processing. In embodiments, the cartridge frame 201 and the cartridge drawer 202 may adopt, relative to one another, one or more of a sampling position, a transfer position, a receptacle release position, a smear position, a flood start position, a flood finish position, a flush position, and a slide eject position. These positions are explained in greater detail below.

FIGS. 2J-2N illustrate sample processing components, which may include at least a sample receptacle 301, one or more sample slides 401, a smear plate 501, a stain storage unit 701, and a coverslip 601. As discussed above, the sample cartridge 200 is configured to accommodate each of the sample processing components, which may be packaged with or separately from the sample cartridge 200.

The stain storage unit 701 (FIGS. 2M, 2N) may be disposed on the sample cartridge 200, e.g., at the cartridge frame 201. The stain storage unit 701 may include one or more stain storage modules 702, each configured to individually house a volume of fluid (e.g., staining fluid, water, alcohol, etc.). Each stain storage module 702 may include a fluid outlet 703 and a fluid seal 704. The fluid outlet 703 is configured to permit the release of fluids stored in the stain storage module 702 at a first end of the stain storage module 702 while the fluid seal 704 is configured to prevent the release of fluids at the opposite end. In an embodiment, the fluid seal 704 may be moveable or deformable and pressure or force applied to the fluid seal 704 may cause it to deform or move, thereby providing pressure to the fluid within the stain storage module 702. Pressure on the fluid within the stain storage module 702 causes ejection of the fluid at the fluid outlet 703, which may be a nozzle, an orifice, or any other type of opening. The fluid outlets 703 may be positioned, configured, and arranged such that, when fluid is ejected, it is applied to the coverslip 601 or the sample slide 401, as described in greater detail below. In embodiments, the fluid outlets 703 may be sized small enough to prevent the release of fluid when no pressure is applied. In embodiments, the fluid outlets 703 may include seal, such as a membrane, that may break or be released when pressure is applied to the fluid. In further embodiments, the stain storage unit 701 may include pouches, sacks, or any other suitable fluid container.

In embodiments, the sample cartridge 200 and the various sample processing components may be provided or packaged in any convenient or suitable combination. Separate or combined packaging may be selected or determined, for example, to facilitate sterilization of portions that require it while permitting other portions to be provided without sterilization. For example, sterilizing the sample receptacle 301 but not necessarily the sample cartridge 200 may be beneficial. Sterilization may be required for some applications (e.g. percutaneous biopsies) but not others (bronchoscopic biopsies because the whole procedure is not considered strictly sterile-airways are not sterile). For sterile biopsies, a biopsy needle may touch the sample receptacle 301 then go back in the patient, and thus the sample receptacle 301 must be sterile at a minimum.

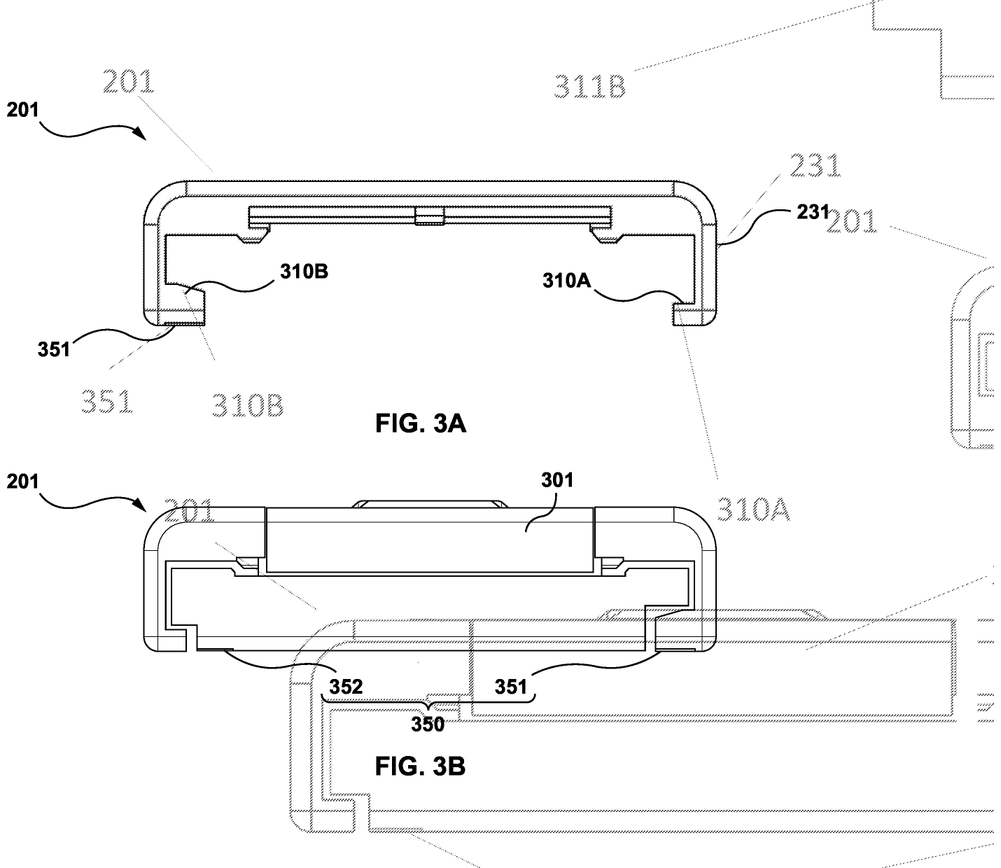

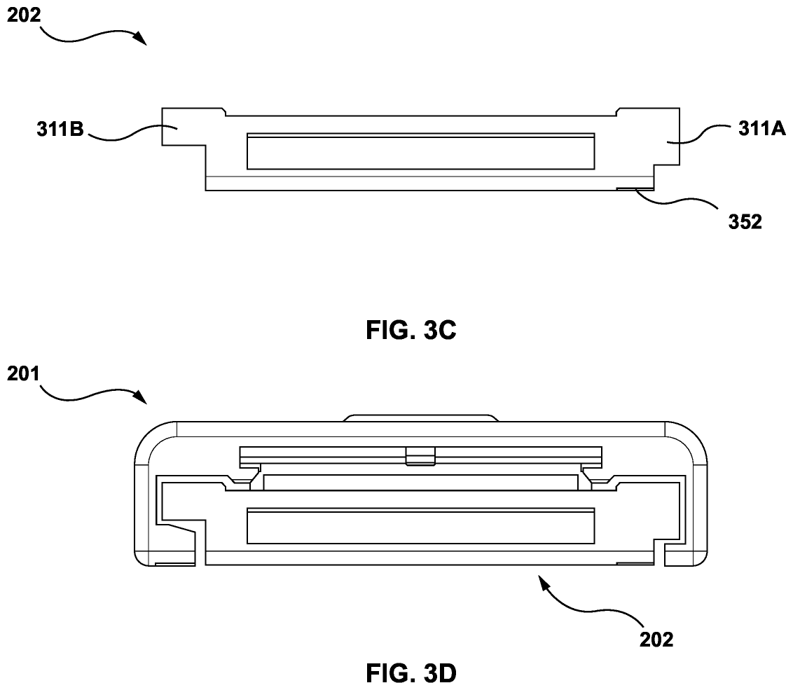

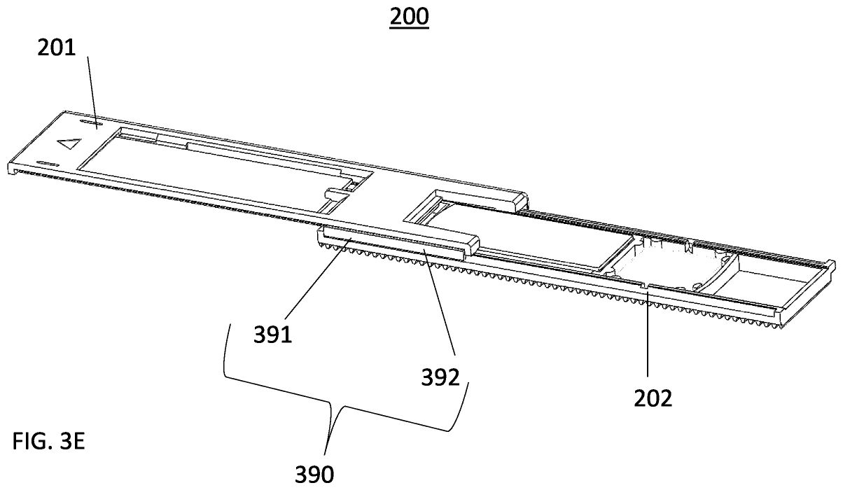

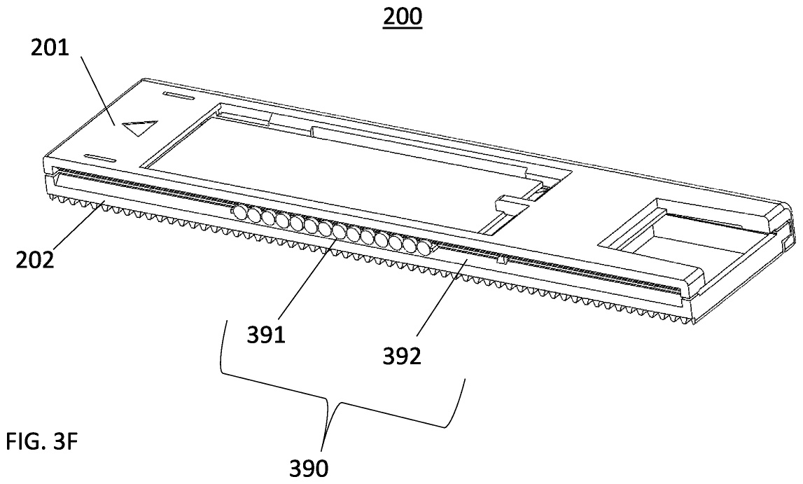

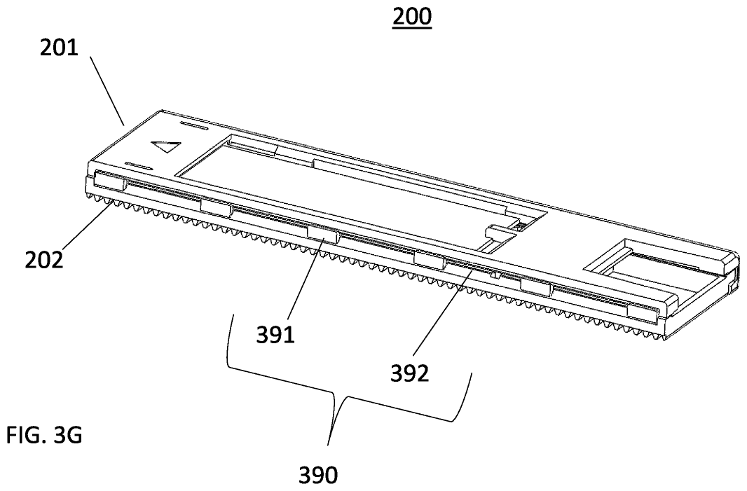

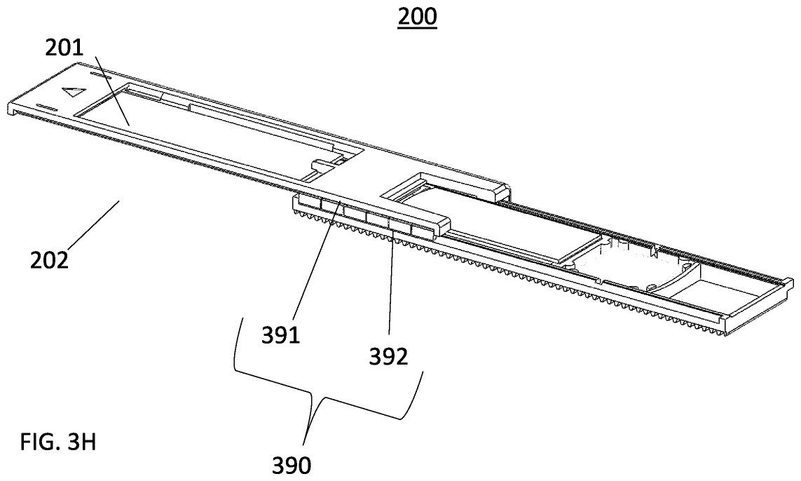

FIGS. 3A-D illustrate features of the sample cartridge 200 that may facilitate the relative movement between the cartridge frame 201 and the cartridge drawer 202. The cartridge frame 201, on an interior side of the cartridge walls 231, includes a pair of frame rails 310 (310A/310B) configured to engage a corresponding pair of drawer rails 311 (311A/311B) disposed lengthwise along the outer perimeter of the cartridge base 232 of the cartridge drawer 202. Engagement between the frame rails 310 and the drawer rails 311 provides bearing surfaces that permit the cartridge frame 201 and the cartridge drawer 202 to move relative to one another.

In embodiments, e.g., as shown in FIGS. 3E-3H, a stiffening structure may be contained within the sample cartridge 200, along one or both of the long sides of the sample cartridge 200. The stiffening structure 390 may contain one or more stiffening elements 391 contained within a stiffening enclosure 392. The stiffening enclosure 392 is an enclosure running the length of the sample cartridge 200 and is formed at a junction of the cartridge frame 201 and the cartridge drawer 202. The stiffening enclosure 392 surrounds and contains the stiffening elements 391. Because the stiffening enclosure 392 is formed from a junction between the cartridge frame 201 and the cartridge drawer 202, it changes size as the cartridge frame 201 and the cartridge drawer 202 are offset from one another. The minimum length of the stiffening enclosure 392 is approximately (accounting for the end walls) the minimum overlap length of the cartridge frame 201 and the cartridge drawer 202 and the maximum length is approximately the length of sample cartridge 200 when the cartridge frame 201 and the cartridge drawer 202 are aligned or flush with one another. The minimum length is illustrated in FIGS. 3E and 3H while the maximum length is illustrated in FIGS. 3F and 3G.

In an embodiment, the one or more stiffening elements 391 include a stiff rod, such as a rod of steel or other metal, as illustrated in FIG. 3E. When the cartridge frame 201 and the cartridge drawer 202 are offset from one another, the steel rod may substantially fill the stiffening enclosure 392 (e.g., occupy 80% or more, 90% or more, 95% or more, etc.) of the length of the stiffening enclosure 392, thus providing stiffness to the sample cartridge 200. When the cartridge frame 201 and the cartridge drawer 202 are aligned with one another, the steel rod occupies a portion of the stiffening enclosure 392, thus providing stiffness to the sample cartridge 200.

In an embodiment, the stiffening structure 390 is configured for collapsibility and expandability. The one or more stiffening elements 391 may include a plurality of stiffening elements 391, as shown in FIG. 3F, comprising a material that is stiffer than the sample cartridge material, such as metal or stiff plastic. The plurality of stiffening elements 391 may include balls, beads, or other elements. When the cartridge frame 201 and the cartridge drawer 202 are offset from one another, the stiffening elements 391 are configured to collapse such that they may substantially fill the stiffening enclosure 392 (e.g., occupy 80% or more, 90% or more, 95% or more, etc.) of the length of the stiffening enclosure 392 over its shorter length, thus providing stiffness to the sample cartridge 200. When the cartridge frame 201 and the cartridge drawer 202 are aligned with one another, causing the stiffening enclosure 392 to lengthen, the plurality of stiffening elements 391 may spread out within the length of the stiffening enclosure 392 to provide stiffness over the length of the stiffening enclosure 392.

In embodiments, the stiffening elements 391 may be, may contain, and/or may include magnets, as shown in FIGS. 3G and 3H. Each stiffening element 391 may be aligned with a neighboring stiffening element 391 such that the polarity of the included magnets matches, thus providing a force to push the stiffening elements 391 away from one another. When the sample cartridge 200 is closed and the stiffening enclosure 392 lengths, the magnets force the stiffening elements 391 to spread out within the stiffening enclosure 392. When the sample cartridge 200 is opened and the stiffening enclosure 392 shortens, the end walls of the stiffening enclosure 392 force the stiffening elements 391 close together. Accordingly, the stiffening elements 391 may remain spaced within the stiffening enclosure 392 to provide stiffening support to the sample cartridge 200 regardless of the cartridge drawer 202 and cartridge frame 201 alignment. In embodiments, collapsibility and expandability of the stiffening structure 390 may be provided by other elements, such as biasing elements (springs, foams, etc.) and/or telescoping elements.

The sample cartridge 200 further includes a cartridge drive system 350. The cartridge drive system 350 (elements of which are illustrated in FIGS. 2D-2I) is configured to drive the relative movement between the cartridge frame 201 and the cartridge drawer 202. As discussed above, the frame rails 310 and the drawer rails 311 provide the bearing surfaces necessary for the relative movement. The cartridge drive system 350 provides a means to generate the relative movement. In an embodiment, the cartridge drive system 350 may include a frame gear drive rack 351 disposed on one of the cartridge walls 231 and a drawer gear drive rack disposed longitudinally along one edge of the cartridge base 232. The frame gear drive rack 351 may include a rack having a plurality of gear teeth configured to engage with and be driven by a pinion gear. The drawer gear drive rack 352 may also include a rack having a plurality of gear teeth configured to engage with and be driven by a pinion gear. Relative movement of between the cartridge frame 201 and the cartridge drawer 202 may be generated by separate pinion gears engaging and driving the frame gear drive rack 351 and the drawer gear drive rack 352. The cartridge drive system 350 may be engaged to generate the relative movement between the cartridge frame 201 and the cartridge drawer 202 that causes the cartridge frame 201 and the cartridge drawer 202 to adopt the various positions relative to one another as described herein.

In further embodiments, the cartridge drive system 350 may include alternative features configured to generate the linear motion necessary to cause the relative movement. For example, such features may include features to interact with a pinch roller system, an external push rod system including linear actuators configured to engage the cartridge drawer 202 and cartridge frame 201 to cause back and forth movement, a differential gear system, a pair of linear stages that respectively engage the cartridge drawer 202 and cartridge frame 201.

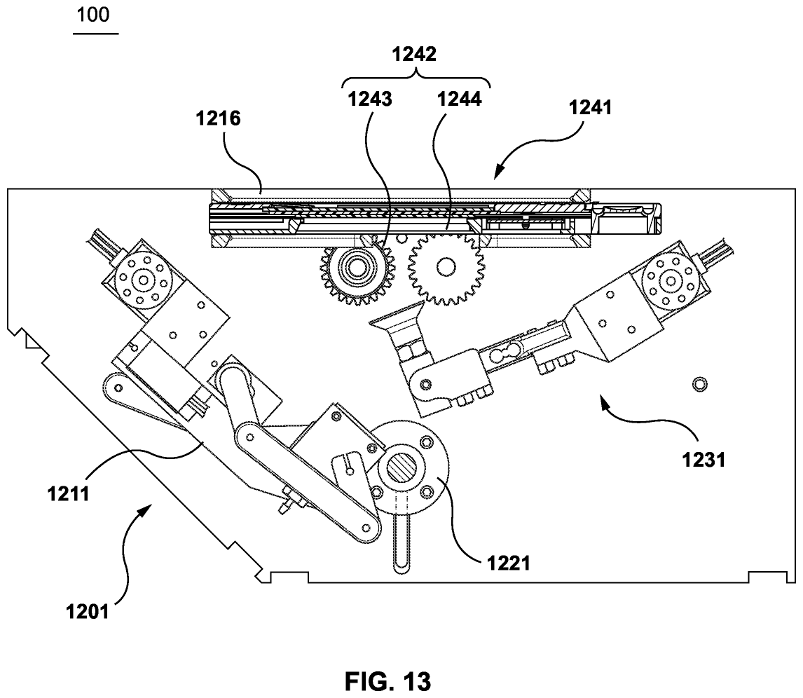

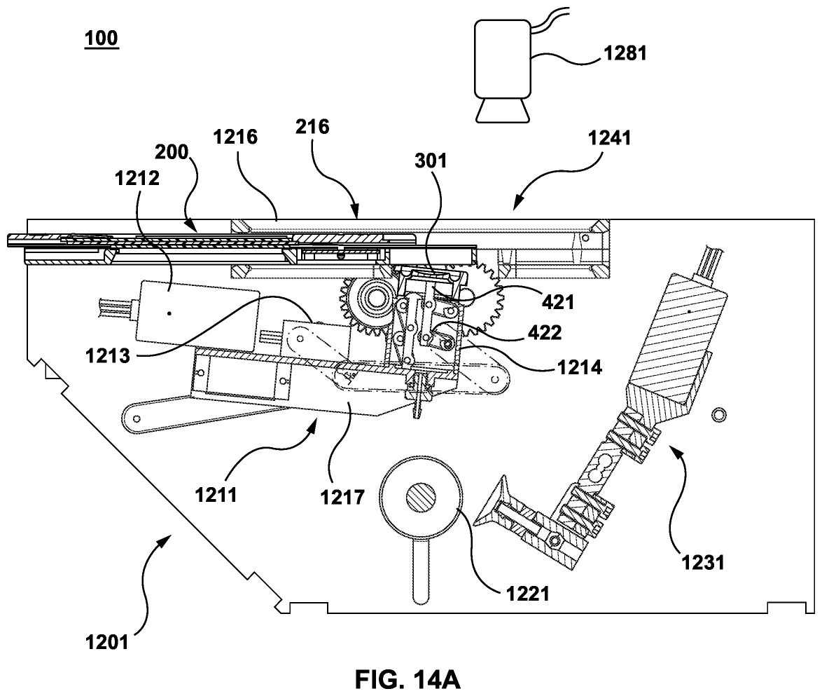

In embodiments, the relative movement of the sample cartridge 200 may be facilitated by the integrated sample processing system 100, as described in greater detail with respect to FIG. 13. In embodiments, the relative movement of the sample cartridge 200 may be facilitated by manual manipulation of an operator.

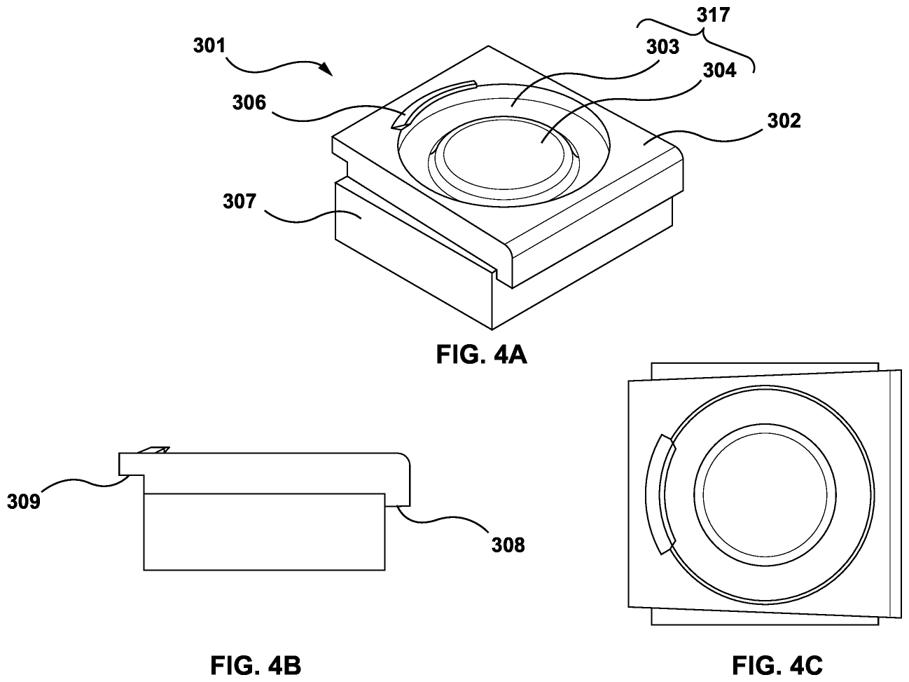

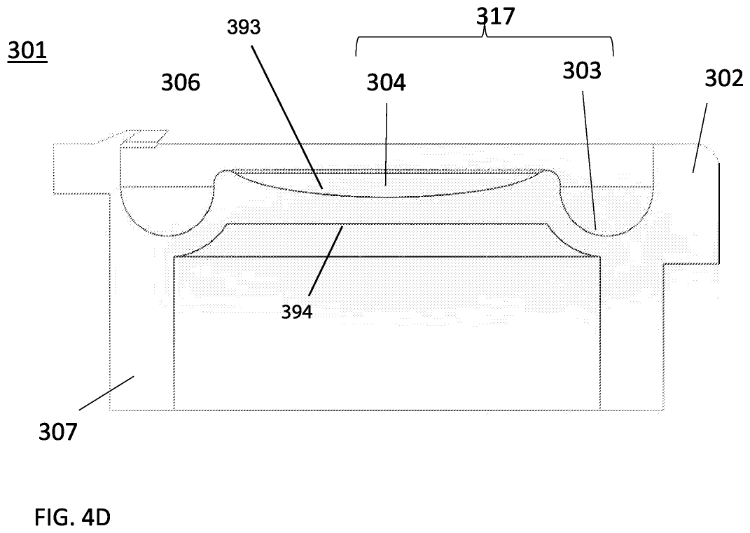

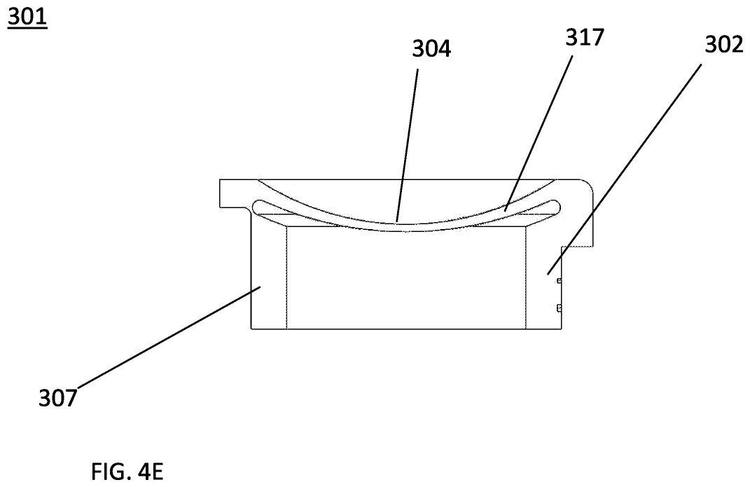

FIGS. 4A-D illustrate the sample receptacle 301. The sample receptacle 301 may include a receptacle base 307 supporting a receptacle frame 302, a trough 303, a sample platform 304, and a sample lip 306. The receptacle base 307 provides a support structure for the receptacle frame 302. The receptacle base 307 may include a plurality of walls and a cavity in the center of the walls. The receptacle frame 302 is supported by the receptacle base and provides an outer support structure for the sample receptacle 301. The receptacle frame 302 may include a portion of material (e.g., a flexible material such as a polymer, rubber, plastic, etc.) having an outer perimeter and an inner perimeter. The receptacle frame 302 and receptacle base 307 may be formed from a single material, may be integrally formed, may be separate adjoined pieces, or may include different materials. In embodiments, the receptacle base 307 may be formed from a material that is stiffer or stronger than a material of the receptacle frame 302. In embodiments, portions of the sample receptacle 301, for example, the sample platform 304, may include or be formed of a material that resists punctures. For example, during sample deposit onto the sample platform 304, a needle may be used. The sample platform 304 may include a material flexible enough to perform the functions disclosed herein yet tough enough to prevent or resist puncture.

The outer perimeter of the receptacle frame 302 may be, for example, approximately square, trapezoidal (as illustrated in FIGS. 4A-D) rectangular, circular, and/or any other suitable shape. Portions of the outer perimeter of the receptacle frame 302 may extend past the receptacle base 307. For example, the receptacle frame 302 may include a frame support 309 and a drawer support 308 extending beyond the perimeter of the receptacle base 307. The receptacle frame 302 may have an interior opening surrounded by the inner perimeter. Connecting to the walls of inner perimeter of the receptacle frame 302 is the trough 303. The trough 303 supports the sample platform 304, located within the interior opening of the receptacle frame 302. Together, the trough 303 and the sample platform 304 may be referred to as a membrane 317 or a flexible membrane. The sample platform 304 has a sample side 393 and an underside 394, located opposite the sample side 393. The trough 303 may be thinner in cross section than the receptacle frame 302 and the sample platform 304, thus permitting the sample platform 304 to move with respect to the receptacle frame 302 through bending or flexing of the trough 303 or other portions of the membrane 317. The trough 303 may also serve to capture and contain excess amounts of sample applied to the sample platform 304. The sample platform 304 may be round, square, or any other suitable shape and may be concave in cross-section so as to better contain a sample. The sample lip 306 is a protruding portion of material that extends above a surface of the receptacle frame 302. In an embodiment, the sample lip 306 may be curved to conform to the trough 303. Operation of the sample receptacle 301 is explained in greater detail below.

In embodiments, the sample receptacle 301 may include a membrane 317 having no trough, e.g., as shown in FIG. 4E. In such an embodiment, the membrane 317 may include the sample platform 304 and may extend to the receptacle frame 302 with no trough required.

In an embodiment, the sample receptacle 301 may further include a sample collection feature. The sample collection feature may be configured to facilitate sample release from a collection or biopsy tool, for example, a biopsy brush. The sample collection feature may be configured as a notch, a lip, a ledge, a port, a hole, etc., and may be configured to facilitate the release of a collected sample from a tool. For example, a biopsy brush may collect sample within a series of bristles. Running the bristles across the sample collection feature, e.g., a notch, may assist in causing the release of sample from the bristles.

In further embodiments, the sample receptacle 301 may be a substantially flat substrate and/or may be substantially rigid. In such embodiments, sample transfer may be achieved by advancing the sample receptacle 301 to the sample slide 401 such that the sample touches the sample slide 401 and the sample receptacle 301 does not deform.

FIG. 5 illustrates a sampling position of the sample cartridge 200. The cartridge drawer 202 may be configured to adopt a sampling position relative to the cartridge frame 201 exposing the sample receptacle 301 for receipt of a sample. As illustrated in FIG. 5, in the sampling position, the cartridge frame 201 and the cartridge drawer 202 may be aligned such that the ends of each are flush with one another. In the sampling position, the cartridge frame 201 and the cartridge drawer 202 may cooperate to support the sample receptacle 301. The sample receptacle 301 may be supported by a frame receptacle support ledge 371 of the cartridge frame 201 at the frame support 309 and a drawer receptacle support ledge 372 of the cartridge drawer 202 at the drawer support 308. The frame receptacle support ledge 371 and the drawer receptacle support ledge 372 together form a receptacle support. In the sampling position, the frame receptacle support ledge 371 and the drawer receptacle support ledge 372 are spaced apart an appropriate distance such that they may engage with and support the sample receptacle 301 through contact with the frame support 309 and the drawer support 308. In further embodiments, the sample receptacle 301 may be supported by a receptacle support formed solely within the cartridge frame 201 or solely within the cartridge drawer 202.

In embodiments, the sample cartridge 200 may include one or more features to lock the cartridge frame 201 and the cartridge drawer 202 in place, for example to prevent manual manipulation (deliberate or accidental). The integrated sample processing system 100 may be equipped with one or more actuators or actuated tools to disengage the locking features. For example, the locking features may include a snap or pin that prevents relative movement between the cartridge frame 201 and the cartridge drawer 202. The integrated sample processing system 100 may disengage or release the snap or pin to permit relative movement during sample processing, as described below. Subsequent to sample processing, the sample cartridge 200 may be released in the unlocked position or may be relocked with the snap or pin (or a new snap or pin) to prevent further manipulation or reuse.

During a sample processing method consistent with embodiments hereof, the sample cartridge 200 may be caused to adopt the sampling position. In examples, the sample cartridge 200 may be packaged and provided to a user in the sampling position to facilitate ease of use. In examples, the sample cartridge 200 may be arranged in the sampling position by the integrated sample processing system 100 or by a user prior to deposition of a sample. In the sampling position, a user or operator, for example a doctor or other medical personnel, may obtain a sample (e.g., a tissue sample or other biological sample) and may deposit the sample in the sample receptacle 301.

In further embodiments, deposition of the sample in the sample receptacle 301 may occur in any other suitable fashion. For example, the sample receptacle 301 may be packaged and provided separately from the sample cartridge 200 and may receive the sample remotely from the sample cartridge 200. In examples, the integrated sample processing system 100 may present the sample receptacle 301 to a user or operator for sample deposition separately or remotely from activity involving the sample cartridge 200. After sample deposition, the user or operator may provide the integrated sample processing system 100 or the sample cartridge 200 with the sample receptacle 301. The methods, systems, and devices discussed herein are not limited by the location of the sample receptacle 301 during sample deposition or by a method of sample deposition.

FIG. 6 illustrates a receptacle release position of the sample cartridge 200. The cartridge drawer 202 may be configured to adopt a receptacle release position relative to the cartridge frame 201. As described above, in the sampling position, the frame receptacle support ledge 371 of the cartridge frame 201 and the drawer receptacle support ledge 372 of the cartridge drawer 202 cooperate to the support the sample receptacle 301 via contact with the receptacle frame 302. In adopting the receptacle release position, the cartridge frame 201 and the cartridge drawer 202 are moved with respect to one another such that a distance D between the drawer receptacle support ledge 372 and the frame receptacle support ledge 371 increases. In the receptacle release position, the distance D is greater than a length L of the sample receptacle 301. Accordingly, in the receptacle release position, the drawer receptacle support ledge 372 and the frame receptacle support ledge 371 cannot support the sample receptacle 301, and the sample receptacle 301 is free to fall, drop, or otherwise be moved downward with respect to a top surface of the sample cartridge 200. In an embodiment, the sample receptacle 301 may be released and pass through a receptacle window 212 disposed within the cartridge drawer 202. The receptacle window 212 may be configured with dimensions larger than that of the sample receptacle 301. In further embodiments, the receptacle window 212 may be configured with dimensions smaller than those of the receptacle frame 302 and may thereby receive, contain, and support the sample receptacle 301 in a position on the cartridge drawer 202 and thus may move along with the cartridge drawer 202 as the sample cartridge 200 is manipulated. As discussed above, receptacle release may be an optional step, as sample deposition in the sample receptacle 301 may occur in various manners. In embodiments, the sample receptacle 301 may be supplied with a sample and provided to the integrated sample processing system 100 separate from the sample cartridge 200.

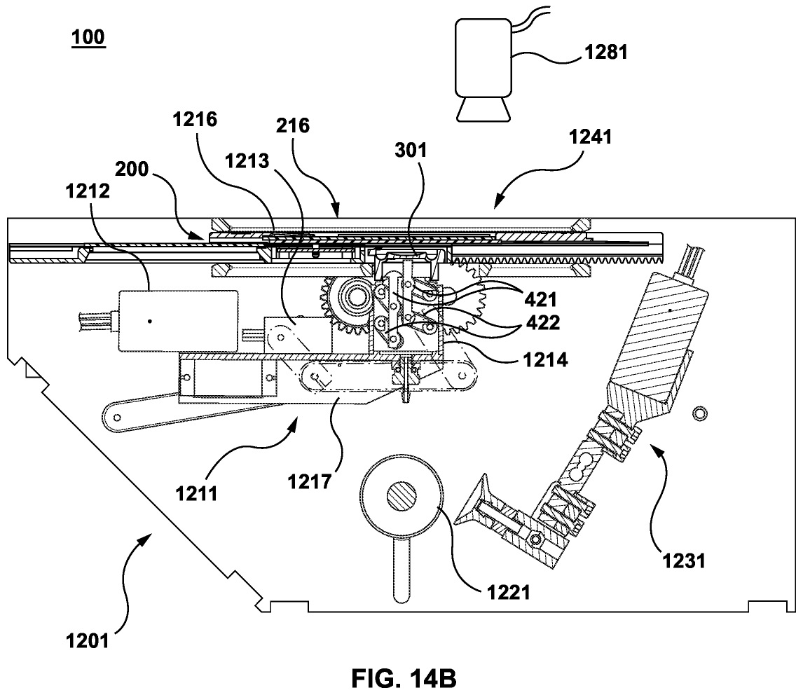

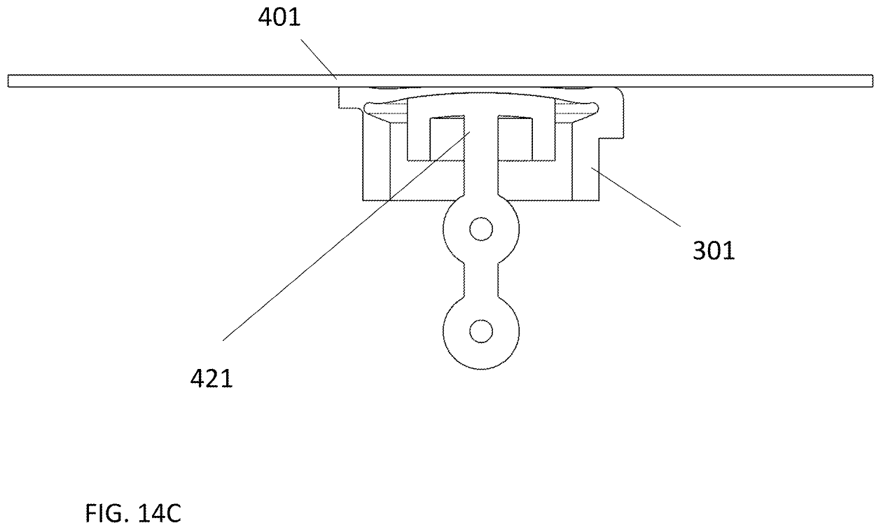

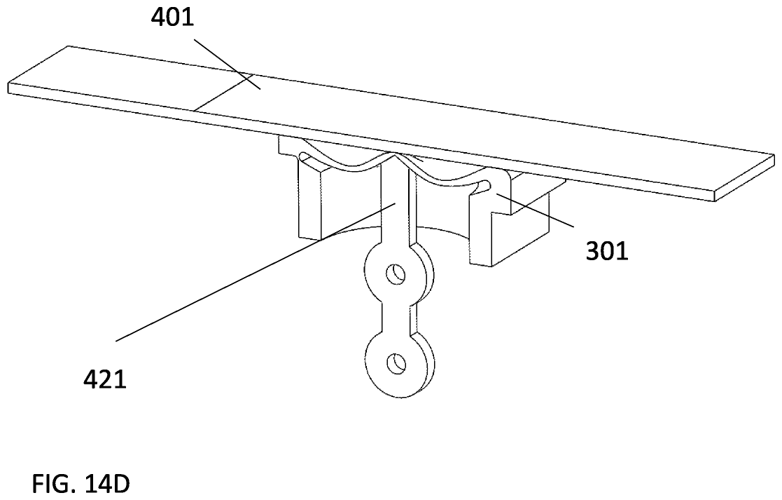

In embodiments, the receptacle release position may be achieved via automated manipulation of the sample cartridge 200 by the integrated sample processing system 100, as explained in greater detail with respect to FIG. 14A, e.g., in response to a receptacle release position command. In embodiments, the receptacle release position may be achieved via manual manipulation of the sample cartridge 200.

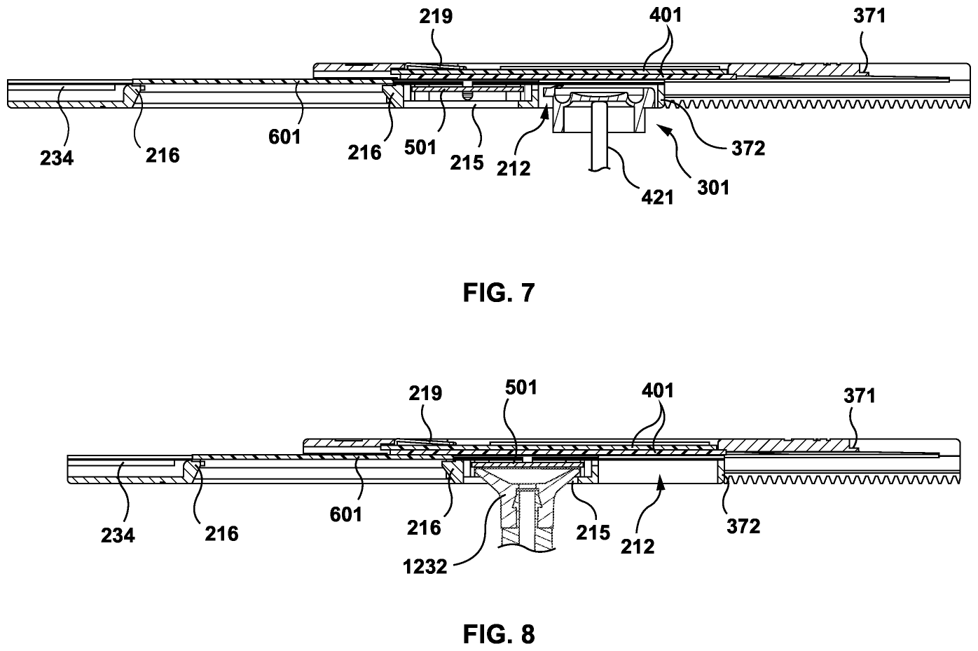

FIG. 7 illustrates a transfer position of the sample cartridge 200. The cartridge drawer 202 may be configured to adopt a transfer position relative to the cartridge frame 201. In the transfer position, the sample receptacle 301 may be aligned with the sample slide 401. Further, the receptacle window 212 of the cartridge drawer 202 may be aligned with the slide support 211 of the cartridge frame 201. Alignment between the receptacle window 212 and the slide support 211 permits transfer of a sample or a portion of a sample from the sample receptacle 301 to a slide 401 disposed within the slide support 211. The receptacle window 212, as discussed above may be sized to permit passage of the sample receptacle 301. Thus, the sample receptacle 301 may pass through the receptacle window 212 to a position in proximity to a sample slide 401 disposed within the slide support 211. When the sample cartridge 200 is maintained in an upright position such that that top surface 271 of the sample cartridge 200 is facing up, the sample receptacle 301 may approach a bottom surface 402 of a sample slide 401 by passing through the receptacle window 212.

The sample within the sample receptacle 301 may then be brought into contact with the sample slide 401 to cause transfer of a portion of the sample to the sample slide 401. As discussed above, the methods and techniques described herein may facilitate sample transfer and sample separation that uses a reduced amount of tissue, permitting a majority of the initial sample to be preserved. Transfer may be facilitated in several different ways.

In embodiments, pressure may be applied by a probe 421, operated manually or via automation, to an underside 394 of the sample platform 304. Application of the pressure causes the membrane 317 to flex or bend, permitting the sample located on the sample platform 304 to contact the sample slide 401. In embodiments, a shape of the probe 421 may be selected or determined according to properties or a type of the sample on the sample platform 304. For example, for samples containing predominantly liquid (e.g., fine needle aspirant), a pointed probe 421 may be selected to break surface tension of the liquid and ensure efficient transfer. For samples containing predominantly solids, a blunt probe 421 may be selected to ensure that a large surface of the solid tissue makes contact with the slide without perturbing the structure of the tissue itself.

The probe 421 may be selected ahead of time, for example, during sample processing procedures wherein a type of sample is expected. The probe 421 may be selected during sample processing, for example, by a user that assesses a deposited sample and selects a probe for the transfer operation. Further, the probe 421 may be selected via automated means, as discussed in greater detail below.

In embodiments, the transfer position may be achieved via automated manipulation of the sample cartridge 200 by the integrated sample processing system 100, as explained in greater detail with respect to FIG. 14B. Further the sample transfer operation may be performed by automated control of the probe 421 by the integrated sample processing system 100. In further embodiments, the transfer position and sample transfer operation may be achieved via manual manipulation of the sample cartridge 200 and manual operation of the probe 421.

Although sample transfer is described above with respect to the sample cartridge 200, the present disclosure is not so limited. The sample cartridge 200, as described herein, provides an example device structure for aligning the sample receptacle 301 and the sample slide 401. The method of sample transfer and the devices configured for facilitating the method may be carried out by aligning the sample receptacle 301 and the sample slide 401 and applying the probe 421 to the underside of sample receptacle 301 with or without the sample cartridge 200. For example, the method of sample transfer may be carried out manually by an operator. In another example, the method of sample transfer may be carried out by a sample processing system (e.g., integrated sample processing system 100) configured to manipulate the sample slide 401 and the sample receptacle 301 without a sample cartridge 200. In a further example, a user or operator may transfer sample to the sample slide 401 directly from a sample collection device (needle, forceps, etc.) The user or operator may place an appropriate amount of sample directly onto the sample slide 401 (e.g., a small amount of FNA liquid or a tissue touch preparation). The sample slide 401 may then be further processed by the integrated sample processing system 100, e.g., at a smearing operation.

FIG. 8 illustrates a smear position of the sample cartridge 200. The cartridge drawer 202 may be configured to adopt a smear position relative to the cartridge frame 201. In the smear position, the smear plate 501 is aligned with the sample slide 401. Further, the smear plate support 214 of the cartridge drawer 202 may be aligned with the slide support 211 of the cartridge frame 201. Alignment between the smear support and the slide support 211 permits smearing of a sample or a portion of a sample between the smear plate 501 and the sample slide 401. The smear plate 501 is brought into contact with the sample deposited on the sample slide 401. The sample is pressed between the smear plate 501 and the sample slide 401 and then, optionally, smeared by relative movement between the smear plate 501 and the sample slide 401.

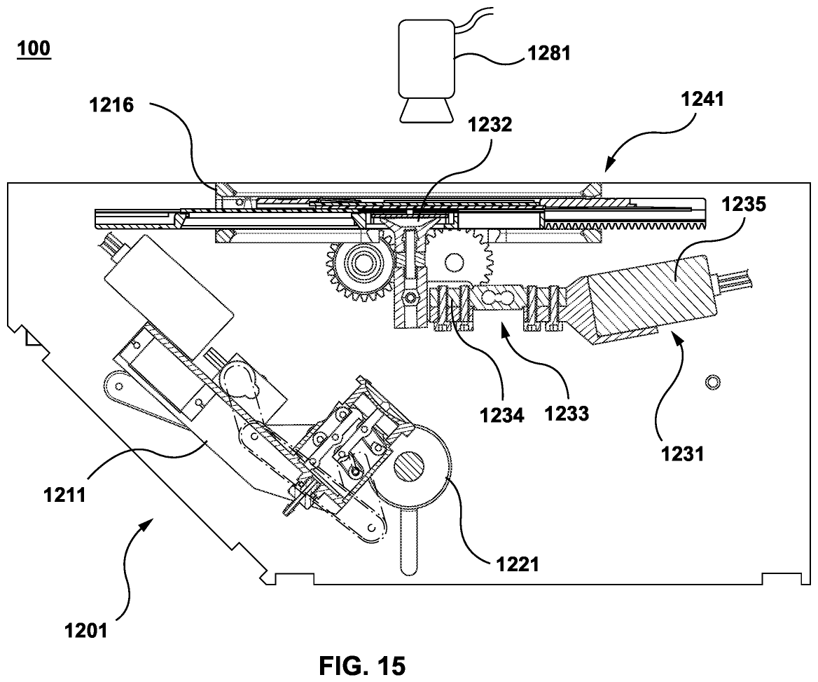

In embodiments, the smearing operation may be performed by the integrated sample processing system 100, as discussed in greater detail below with respect to FIG. 15. In embodiments, the smearing operation may be performed manually by an operator employing one or more tools configured to interact with the smear plate 501.

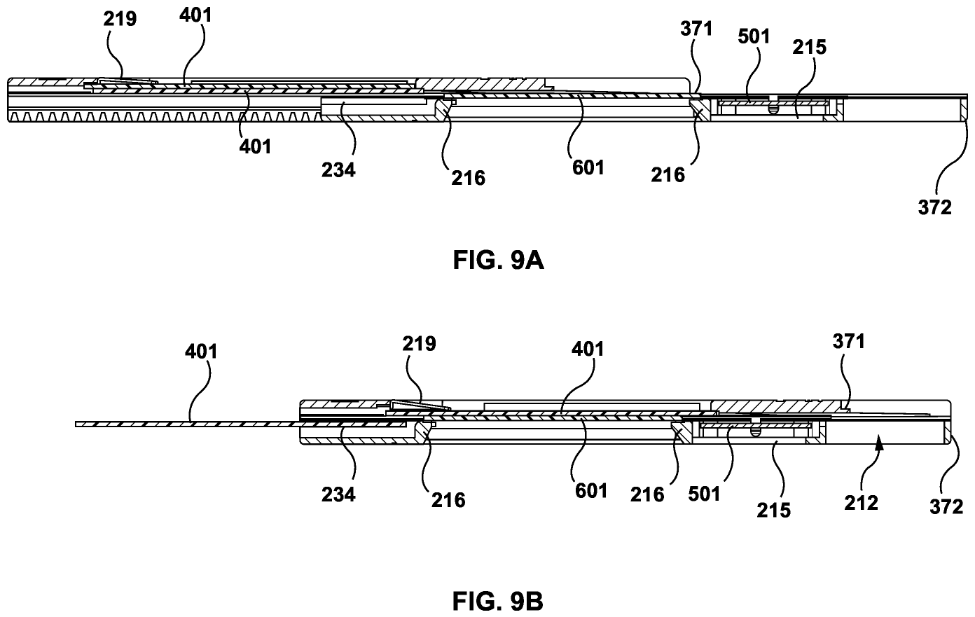

FIGS. 9A-B illustrates an eject position of the sample cartridge 200. The cartridge drawer 202 may be configured to adopt an eject position relative to the cartridge frame 201. In the eject position, one of the sample slides 401 may be extended beyond an end of the sample cartridge 200. The cartridge frame 201 and the cartridge drawer 202 are manipulated relative to one another so as to cause the sample slide 401 to extend out one end of the sample cartridge 200. In the eject position, the sample slide 401 may be grabbed by an external gripper (e.g., manual or automated gripping) and pulled from the sample cartridge 200 to be used in further processes. In the eject position, the sample slide 401 may also be maintained in an extended position and permitted to air-dry, for example, before further processing.

The eject position may be adopted through a two part movement. In a first ejection motion, the cartridge frame 201 and cartridge drawer 202 may be manipulated to expose an end of the bottom sample slide 401 such that it extends beyond the cartridge drawer 202, as shown in FIG. 9A. A slide release mechanism of the integrated sample processing system 100 may grasp or attach to the exposed sample slide 401. After securement to the sample slide 401, cartridge frame 201 and the cartridge drawer 202 may then be manipulated through a second ejection motion to adopt the eject position. The cartridge frame 201 is moved relative to the cartridge drawer 202 back to increase the overlap. The slide release mechanism retains a position of the sample slide 401 as the cartridge frame 201 moves away. The slide release mechanism may be configured to provide vertical support or force to guide the sample slide 401 past retaining steps, tabs, or other features in the cartridge frame 201. The end of the sample slide 401 that is secured by the support arm 218 is released as the cartridge frame 201 moves back towards the cartridge drawer 202, followed by the portion of the sample slide 401 that is supported by the support tabs 217. Unsupported, the sample slide 401 may then be aligned with a niche 234 in the cartridge drawer 202 and be free to drop into the niche 234, as shown in FIG. 9B. After the second ejection motion is complete, the bottom slide 401, which has moved into a position within the niche 234, is pushed past the end of the sample cartridge 200, where it may be further manipulated by a user and/or by the slide release mechanism of the integrated sample processing system 100.

As discussed above, sample cartridges 200 consistent with embodiments hereof may include two sample slides 401. In an example sample processing operation, a first sample slide 401 may be used for later processing. The sample may be deposited on the first sample slide 401 which may then be ejected and treated with a fixative such as alcohol and stored for further processing. Sample processing may then continue with a second transfer step, a second smearing step, etc. for the second sample slide 401.

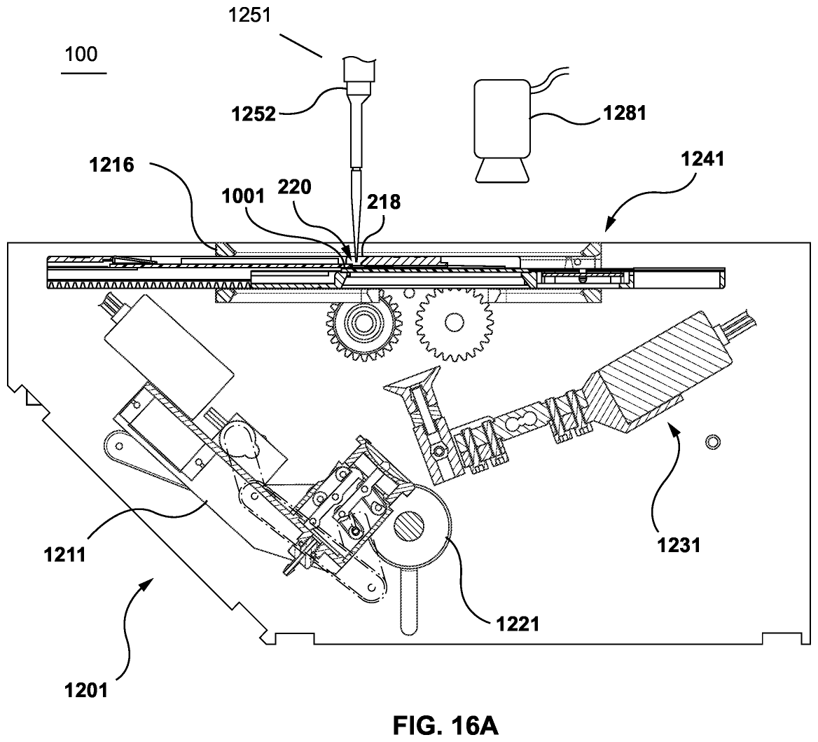

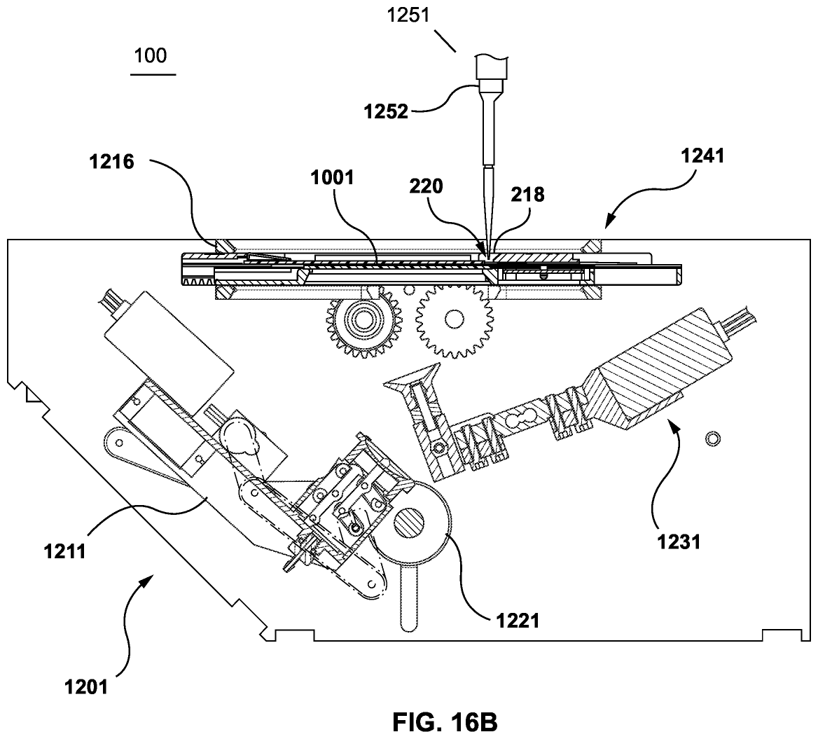

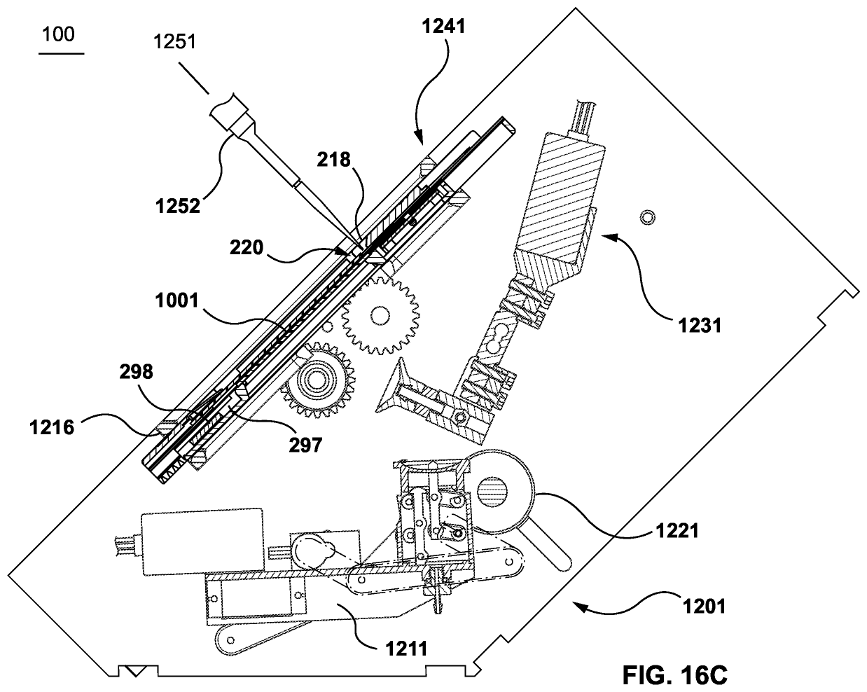

In embodiments, the slide ejection operation may be performed by the integrated sample processing system 100, as discussed in greater detail below with respect to FIGS. 16A-16B. In embodiments, the slide ejection operation may be performed manually by an operator.

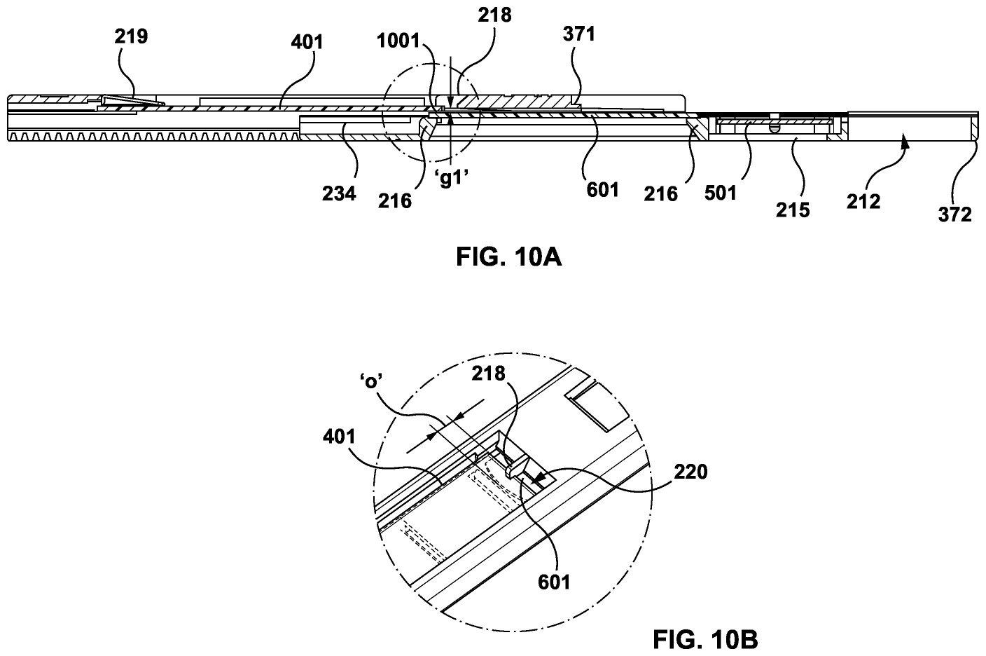

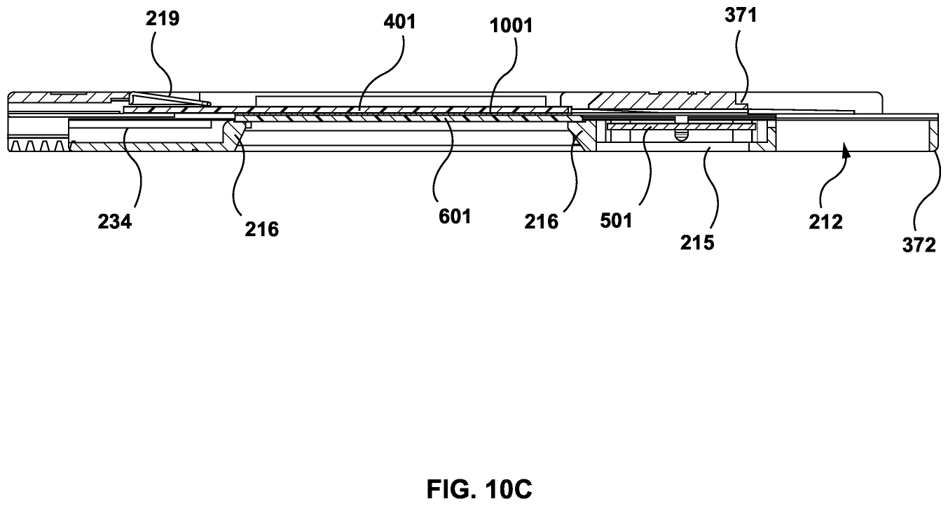

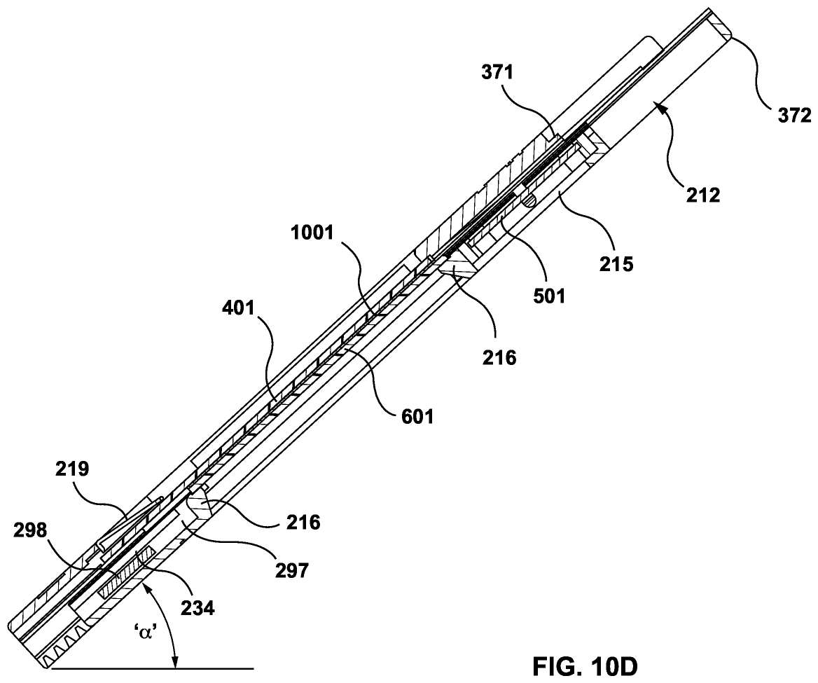

FIGS. 10A-10C illustrate a series of staining positions of the sample cartridge 200. The staining positions include a flood start position, a flood finish position, and a flush position of the sample cartridge 200. The staining positions are selected and adapted to facilitate staining of the sample slide 401. The staining positions for a staining operation are configured and adapted for use with a single sample slide 401 and the staining may be performed after a first sample slide 401 is ejected.

The cartridge drawer 202 and the cartridge frame 201 may be configured to position the sample slide 401 and the coverslip 601 in a flood start position, having a specific position relative to one another. In the flood start position, the sample slide 401 and the coverslip 601 are arranged such that the first slide surface 402 (e.g., a bottom surface) of the sample slide 401 having the sample disposed thereon and a slip surface 602 of the coverslip 601 have a vertical gap g and a horizontal overlap o with respect to one another. The vertical gap g may be defined by a vertical distance between approximately 0.03 and 0.3 mm. The horizontal overlap o may be defined by a horizontal distance between approximately 1 and 10 mm. The horizontal overlap o and the vertical gap g may be selected, for example, according to fluid properties of fluids anticipated for use in the staining process.

In embodiments, the cartridge frame 201 and the cartridge drawer 202 are configured to provide the above specified vertical gap g and horizontal overlap o when maintaining the flood start position. Specifically, the frame rails 310 of the cartridge frame 201 and the drawer rails 311 of the cartridge drawer 202 may be configured such that, when the cartridge drawer 202 is within the cartridge frame 201, a sample slide 401 is within the slide support 211, and a coverslip is within the coverslip support 216, the vertical gap g is maintained. The horizontal overlap o may be determined by the relative linear movement between the cartridge frame 201 and the cartridge drawer 202.

In embodiments, the cartridge frame 201 and the cartridge drawer 202 may be manufactured with loose tolerances, e.g., with vertical “play,” conducive to manufacturing techniques. In such embodiments, the vertical gap g may be achieved by providing a downward force on the exterior surface 242 of the cartridge frame 201 while holding the cartridge drawer 202 still (and/or an upward force on the cartridge drawer 202 while holding the cartridge frame 201 still). The downward force presses the cartridge frame 201 and the cartridge drawer 202 together, therefore eliminating the excess “play” of the loose tolerance and achieving the vertical gap g. In embodiments, the downward force may be applied by the integrated sample processing system 100, as shown in greater detail with respect to FIG. 13.

In embodiments, the vertical gap g may be set during a manufacturing processing through the use of the adhesive that secures the coverslip 601 and one or more spacers. For example, one or more spacers having a height equal to the desired vertical gap g may be positioned between the coverslip 601 and the sample slide 401. An appropriate amount of adhesive may be applied at the above described locations to secure the coverslip 601 to the cartridge drawer 202. The cartridge frame 201 and the cartridge drawer 202 may then be pressed together, as described above to eliminate the excess “play” of the loose tolerance. The spacers maintain the vertical gap g between the coverslip 601 and the sample slide 401 during this process. The adhesive supporting the coverslip 601 is flattened, compressed, or spread out such that, when it cures or hardens, it maintains a height of the coverslip 601 that achieves the desired vertical gap g when the sample cartridge 200 is subject to the downward force.

In the flood start position, as illustrated in FIG. 10A a fluid for flooding (such as a stain) may be applied to the coverslip 601 at the vertical gap g. For example, in an embodiment, the fluid may be applied through the space 220 between the end of the sample slide 401 and the bridge portion 241 of the cartridge frame 201 by a fluid dispenser such as a pipette or syringe associated with a fluid distribution system 1251, as discussed below. In another example, the fluid may be applied at the gap from the stain storage unit 701, by ejecting the fluid from a fluid outlet 703 in a stain storage module 702. Fluid may be ejected from the stain storage unit 701 by action of the fluid distribution system 1251, as discussed below. Enough fluid may be applied such that the volume 1001 defined by the vertical gap g and the horizontal overlap o is filled with fluid. Additional fluid may then be deposited on the coverslip 601. The additional fluid may be deposited continuously as the sample slide 401 and the coverslip 601 are advanced to the flood finish position, may be deposited in advance of the movement, and/or may be deposited in discrete amounts at appropriate times during the movement. Prior to the start of movement, the fluid fully occupies the volume 1001 between the sample slide 401 and the coverslip 601. Relative movement involves the sample slide 401 and the coverslip 601 being advanced such that the horizontal overlap o increases. During the movement, as the horizontal overlap o increases, at least enough additional fluid is provided to completely fill the volume 1001 between the sample slide 401 and the coverslip 601. Advancing from the flood start position to the flood finish position in this manner serves to eliminate or reduce the occurrence of bubbles or non-wetted spaces within the volume 1001 between the sample slide 401 and the coverslip 601. This technique may also reduce excess fluid waste. Because the process begins with the overlapping surfaces of the sample slide 401 and the coverslip 601 prewetted by the fluid, as the surfaces advance with respect to one another the fluid is pulled along by surface tension, preventing any bubbles or air-gaps from forming. The flood finish position, as illustrated in FIG. 10B, may be reached when the horizontal overlap reaches a maximum distance, i.e., the horizontal distance of the horizontal overlap is equal to the shorter of the sample slide 401 and the coverslip 601. In embodiments, the flood finish position may be selected as a position wherein the horizontal overlap reaches a selected distance less than the maximum horizontal distance.

The relative movement of the sample slide 401 and the coverslip 601 from the flood start position to the flood finish position and the application and addition of fluid may be performed by the integrated sample processing system 100, as discussed below with respect to FIGS. 16A-16C. In further embodiments, the relative movement and fluid addition may be performed manually and/or by another automated system.

In embodiments, the fluid for flooding may be applied in a first initial amount at the vertical gap g when the sample slide 401 and the coverslip 601 are in the flood start position. In embodiments, the fluid for flooding may be applied in a first amount to the sample slide 401 or the coverslip 601 prior to arranging the sample slide 401 and the coverslip 601 in the flood start position. In such an embodiment, when the sample slide 401 and the coverslip 601 reach the flood start position, the fluid may then be received at the vertical gap g. The fluid received at the vertical gap g may be wicked into the volume defined by the horizontal overlap o and the vertical gap g. In embodiments, the first amount of fluid may be applied initially and additional fluid, in second, third, fourth, etc., amounts may subsequently be applied as necessary, either during relative movement between the sample slide 401 and the coverslip 601 or before such movement. In embodiments, the first amount of fluid and any amount (including all) of the additional fluid may be applied at the same time, prior to or after the sample slide 401 and the coverslip 601 are arranged in the flood start position. In embodiments, additional fluid may be applied as the horizontal overlap o between the sample slide 401 and the coverslip 601 increases. The additional fluid may be applied in a continuous stream and/or in discrete amounts. In embodiments, as the horizontal overlap o increases, the size of the volume increases. As the volume increases, enough additional fluid is applied to ensure the volume remains full enough to prevent the formation of bubbles. The amount of additional fluid may be selected or determined according to the size of the volume. In each of the above embodiments, the fluid may be provided to either the coverslip 601 or the sample slide 401, as appropriate, depending on the orientation of these components.

After completion of the fluid flooding operation, the sample slide 401 and the coverslip 601 may be rotated to adopt a flush position, as shown in FIG. 10C. The flush position may be adopted via automated or manual manipulation of the sample slide 401 and the coverslip 601, with or without the sample cartridge 200. In the flush position, the sample slide 401 and the coverslip 601 are rotated in a conforming movement (i.e., the sample slide 401 and the coverslip 601 undergo a similar or same movement with limited relative movement) to adopt a position having a flush angle α with respect to a horizontal reference. The flush angle α may be selected according to properties of the fluids involved and the vertical gap g. In the flush position, a second, third, or more fluids may be applied at the vertical gap g between the sample slide 401 and the coverslip 601. The additional fluids, which may be referred to as flush fluids, may flow through the volume 1001 between the sample slide 401 and the coverslip 601, flushing out the previous fluids. As used herein, “flush fluids” refer to any subsequently applied fluid that flushes out a previous fluid. Flush fluids may include water, additional stains, alcohol, or any suitable fluid.

In this manner, a series of multiple fluids may be applied. The first fluid is applied before or while the sample slide 401 and the coverslip 601 are transitioned from the flood start position to the flood finish position. With the volume 1001 between the sample slide 401 and the coverslip 601 filled with fluid, additional fluids may be added to flush the previous fluids without creating any bubbles or gaps. Multiple fluids may be applied with appropriate timing between to complete a staining protocol. During a staining protocol, the sample slide 401 and the coverslip 601 may be rotated away from the flush position to better maintain the position of added fluids if such is required for the protocol. In embodiments, a staining protocol may be completed with application of water, alcohol, or other fluid.

In embodiments, the cartridge drawer 202 may include an excess fluids recess 297. The excess fluids recess 297 may be a cavity disposed with the cartridge base 232 at an end of the cartridge drawer 202 corresponding with the leading end 291. The excess fluids recess 297 may include an absorbent medium 298 positioned therein. The excess fluids recess 297 may include an opening proximal to an end of the coverslip 601. During staining operations, the excess fluids recess 297 and absorbent medium 298 may act as a cuspidor to collect and hold excess applied fluids.

After completion of the staining protocol, the sample slide 401 may be advanced into the eject position (leaving the coverslip 601 in place within the cartridge), as discussed above, and either ejected or permitted to air dry. In embodiments, air drying may include the forced application of heat or air flow to speed or facilitate drying. In embodiments, an imaging device 1281, as described below, may be used to image the sample slide 401 during a drying procedure to determine whether the drying is complete. In embodiments, as discussed in greater detail below, the sample slide 401 may be imaged after a flushing step but before an ejection or air drying step.

The translational movement of the sample slide 401 and the coverslip 601 from the flood finish position to the flush position and the application and addition of fluid may be performed by the integrated sample processing system 100, as discussed below with respect to FIGS. 16A-16C. In further embodiments, the translational movement and fluid addition may be performed manually and/or by another automated system.

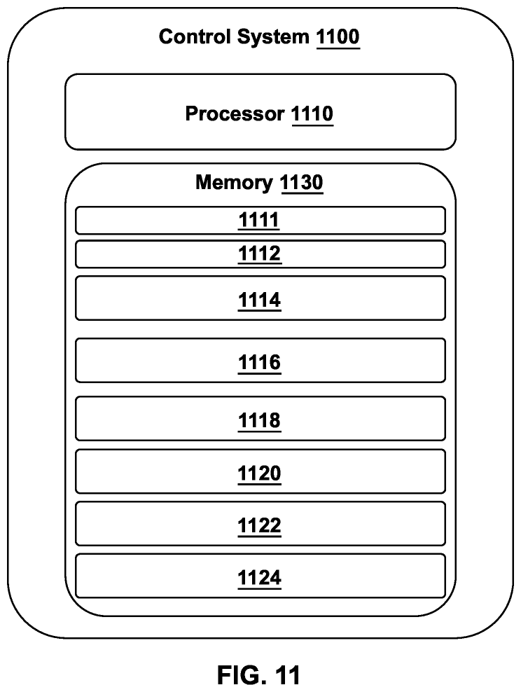

FIGS. 11-18 illustrates features of an integrated sample processing system 100. The integrated sample processing system 100, as described here, may perform, enable, and/or facilitate the performance of various aspects of sample processing methods as discussed herein. In embodiments, the integrated sample processing system 100 may be configured to receive and manipulate the sample cartridge 200, as described herein, to perform sample processing operations. As discussed above, features of the integrated sample processing system 100 may further be configured to operate without a sample cartridge 200 and/or may perform more, fewer, or different sample processing operations than each of those discussed herein.

FIG. 11 illustrates a computer system consistent with embodiments hereof. The control system 1100 is configured to provide commands to the various actuators, devices, and other components of the integrated sample processing system 100. The control system 1100 may include purpose built hardware specific to the integrated sample processing system 100 and/or may include other types of computational systems configured to interface with the various components of the integrated sample processing system 100. For example, the computing system may include a server, a personal computer, a smartphone, and/or a tablet computing device. Additionally, the function of the control system 1100 may be carried out via a cloud computing platform.

The control system 1100 may include one or more processors 1110 (also interchangeably referred to herein as processing units 1110, processors 1110, processor(s) 1110, processing circuits 1110, or processor 1110 for convenience), one or more storage or memory device(s) 1130, and/or other components. In other embodiments, the functionality of the processor may be performed by hardware (e.g., through the use of an application specific integrated circuit (“ASIC”), a programmable gate array (“PGA”), a field programmable gate array (“FPGA”), or any suitable combination of integrated circuit, etc.), or any combination of hardware and software. The storage device 1130 includes any type of non-transitory computer readable storage medium (or media) and/or non-transitory computer readable storage device. Such computer readable storage media or devices may store computer readable program instructions for causing a processor to carry out one or more methodologies described here. Examples of the computer readable storage medium or device may include, but is not limited to an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, but not limited to only those examples.

The processor 1110 is programmed by one or more computer program instructions stored on the storage device 1130 and executable by the processor 1110. For example, the processor 1110 may be programmed by a movement manager 1111, an orientation manager 1112, a transfer manager 1114, a smear manager 1116, a fluid manager 1118, a user interface manager 1120, an imaging manager 1122, and a process manager 1124. It will be understood that the functionality of the various managers as discussed herein is representative and not limiting. Additionally, the storage device 1130 may act as a data storage device to provide data storage for the integrated sample processing system 100. As used herein, for convenience, the various “managers” will be described as performing operations, when, in fact, the managers provide programming or software instructions to the processor 1110 (and therefore the control system 1100) to perform the operation. In embodiments, some or all of the functionality of the various managers as described herein may be implemented by hardware (e.g., integrated circuits) or a combination of hardware and software.

Generally, the movement manager 1111 is a software module including instructions to control actuators (e.g., the sample movement mechanism 1241) that provide or cause the relative movement between the various components of the sample cartridge 200 or between such components if processed by the integrated sample processing system 100 without the sample cartridge 200. The orientation manager 1112 is a software module including instructions to control actuators (e.g., sample orientation system 1221) that provide or cause changes to the orientation of the sample cartridge 200 or between processing components if processed by the integrated sample processing system 100 without the sample cartridge 200. The transfer manager 1114 is a software module including instructions to control actuators (e.g., the sample transfer mechanism 1211) that perform the sample transfer operation, e.g., probes and/or arms that manipulate the sample receptacle 301. The smear manager 1116 is a software module including instructions to control actuators (e.g., the sample smearing mechanism 1231) that manipulate the smear plate 501 for the smearing operation. The fluid manager 1118 is a software module including instructions to control actuators (e.g., the fluid distribution system 1251) that provide fluid (e.g., staining fluids such as Diff-Quik®, additional fluids such as water, alcohol, etc.) during a staining operation. The user interface manager 1120 is a software module including instructions to control the system user interface 103, e.g., to receive user inputs and provide user outputs, for example, to display 102. The imaging manager 1122 is a software module including instructions to control actuators and imaging devices (e.g., imaging device 1281) to perform the various imaging operations discussed herein. Finally, the process manager 1124 is a software module including instructions to organize the processing and command structure of the other managers and to perform any data analysis steps that may be required, as discussed herein. The various managers described herein may issue commands to the various actuators of the integrated sample processing system 100, as discussed below.

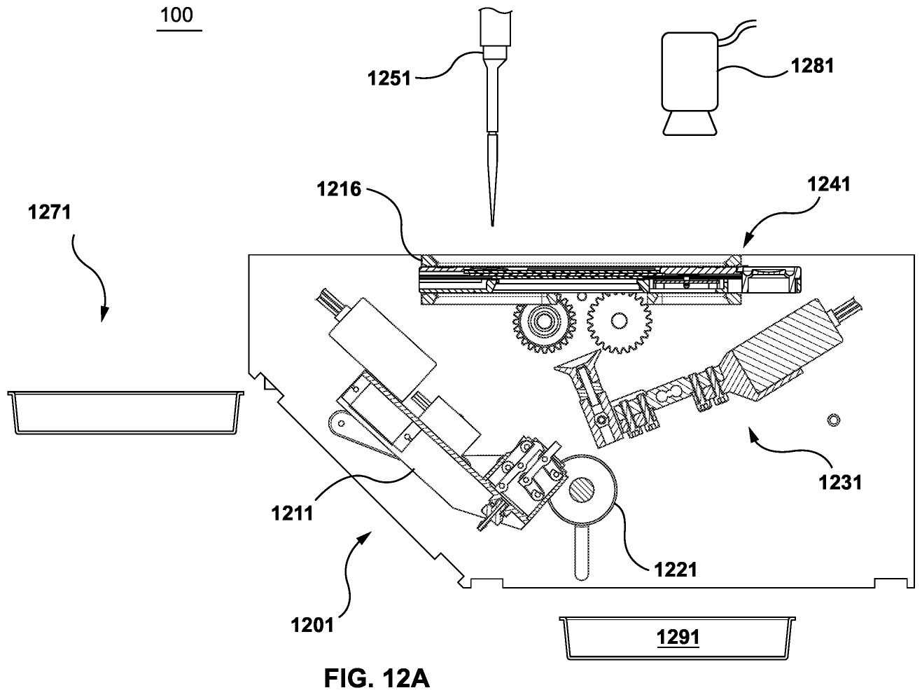

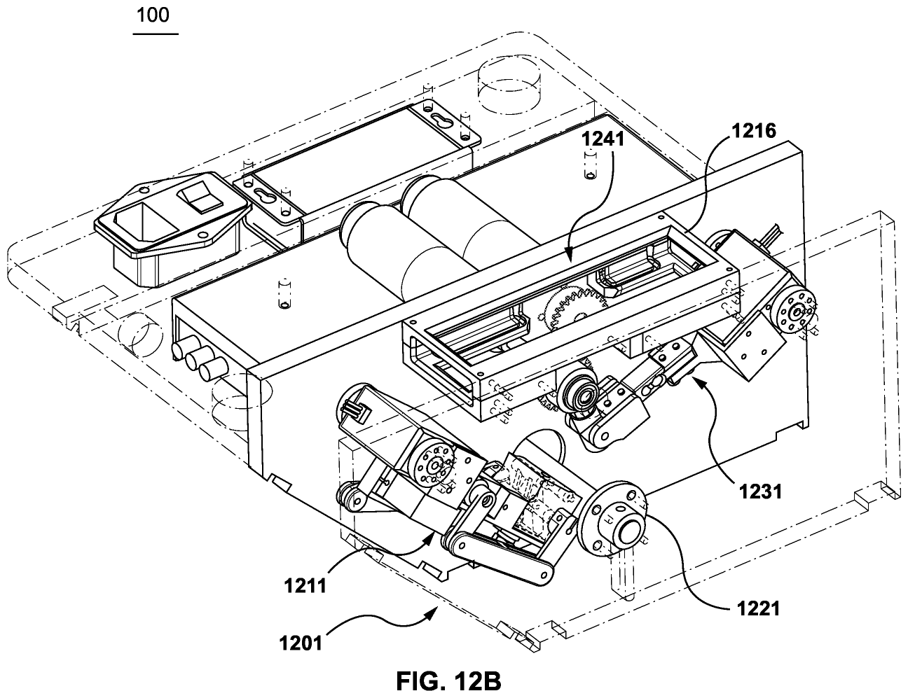

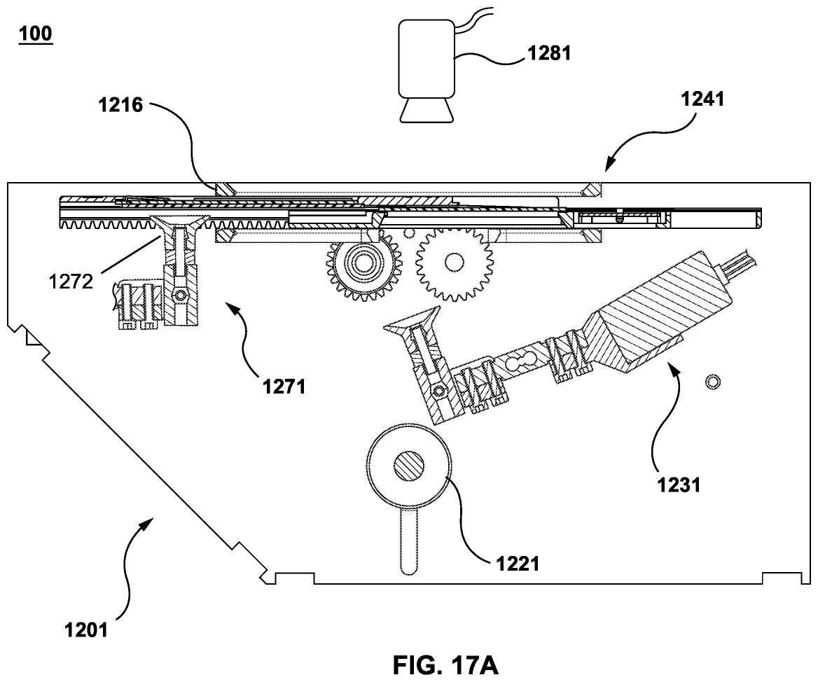

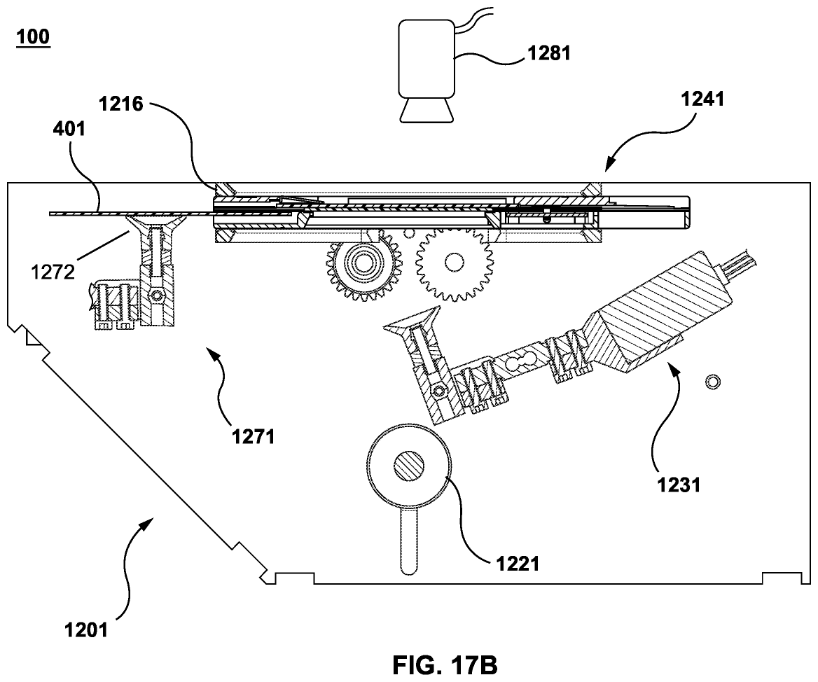

FIGS. 12A and 12B illustrate features of an integrated sample processing system 100 consistent with embodiments hereof. FIG. 12 illustrates a sample handling system 1201, a fluid distribution system 1251, a sample slide receipt system 1271 (a portion of the slide receipt system 1271 is illustrated in FIG. 12, other portions are illustrated in FIGS. 17A-17C), a sample orientation system 1221, and a sample receptacle receipt system 1291. The sample handling system 1201 further includes a sample transfer mechanism 1211, a sample smearing mechanism 1231, a sample orientation system 1221, and a sample movement mechanism 1241. In embodiments, the sample handling system 1201 may include an insertion bay 1216. The individual sub-systems and mechanism of the integrated sample processing system 100 may be configured to perform sample processing operations consistent with those discussed herein and may be configured to perform such operations in conjunction with the sample cartridge 200. In embodiments, various aspects of the integrated sample processing system 100 may be configured to perform sample processing operations consistent with those discussed herein without the use of the sample cartridge 200.

FIG. 13 illustrates the sample movement mechanism 1241. The sample movement mechanism 1241 is configured to facilitate or perform the relative movement of the sample processing components. In embodiments, the sample movement mechanism 1241 may be configured to facilitate or perform the relative movement of the sample processing components via manipulation of a housing configured to contain and support one or more of the sample processing components, such as the sample cartridge 200.

The sample movement mechanism 1241 may be configured to manipulate a sample cartridge 200 supplied to and contained within the insertion bay 1216. The insertion bay 1216 is a frame structure configured to receive the sample cartridge 200. In embodiments, the insertion bay 1216 may be configured to provide a downward force on the exterior surface 242 of the sample cartridge 200, as previously discussed. The downward force may be provided, for example, by one or more inclined surfaces that provide downward force as the sample cartridge 200 is advanced laterally. In further embodiments, the insertion bay 1216 may provide the downward force via automated or motorized actuators and/or by a lever based system. In embodiments, the insertion bay 1216 may include one or more compliant components, such as springs, compliant materials, etc., to control the amount of force provided to the sample cartridge 200.

The sample movement mechanism 1241 includes a linear drive system 1242 configured to interact with the cartridge drive system 350 as described above. In embodiments, the linear drive system 1242 may be a gear drive system including a frame drive gear 1243 and a drawer drive gear 1244. The frame drive gear 1243 may be configured to engage the frame gear drive rack 351 disposed on the cartridge frame 201 and the drawer drive gear 1244 may be configured to engage the drawer gear drive rack 352 disposed on the cartridge drawer 202. The sample movement mechanism 1241 is configured to receive commands from the movement manager 1111 to drive the relative movement between the cartridge frame 201 and the cartridge drawer 202 to align the various sample processing components during sample processing operations. The relative movement drive by the sample movement mechanism 1241 may be selected to provide specific positions, as discussed herein, for the cartridge frame 201 and the cartridge drawer 202 to adopt.

In further embodiments, the sample movement mechanism 1241 and the linear drive system 1242 may include any type of linear actuation device configured to engage the sample cartridge 200 and be controlled to generate the relative movement, including hydraulics, chain drive systems, lead screws, magnetic drive systems, pinch roller system, external push rod system, differential gear system, linear stage system, etc. In still further embodiments, the sample movement mechanism 1241 may be configured to cause relative movement between individual interaction and engagement with the individual sample processing components.

FIGS. 14A-B illustrate aspects of the sample transfer mechanism 1211 of the sample handling system 1201. FIG. 14A illustrates the sample transfer mechanism 1211, also referred to herein as a probe drive system, performing a sample receptacle capture operation in conjunction with the sample movement mechanism 1241 causing the sample cartridge 200 to adopt a receptacle release position. FIG. 14B illustrates the sample transfer mechanism 1211 performing a sample transfer operation in conjunction with the sample movement mechanism 1241 causing the sample cartridge to adopt a sample transfer position.

As shown in FIG. 14A, in response to a release position command from the processor 1110, the sample movement mechanism 1241 may operate to cause the cartridge drawer 202 to adopt a receptacle release position relative to the cartridge frame 201. In the receptacle release position, as discussed above, the sample cartridge 200 is manipulated such that the sample receptacle 301 is no longer supported by the frame receptacle support ledge 371 and the drawer receptacle support ledge 372. In conjunction with the release position command, the sample transfer mechanism 1211 may receive a command from the processor to adopt a receptacle capture position.

As illustrated in FIG. 14A, the sample transfer mechanism 1211 may include a rotational actuator 1212, a translation actuator 1213, a receptacle capture mechanism 1214, one or more probes 421, one or more probe actuators 422, and transfer frame 1217. The transfer frame 1217 is a mechanical structure coupled to and providing support for the various actuators of the sample transfer mechanism 1211. The rotational actuator 1212 may include, for example, a motor (such as a stepper motor, RC servo, DC motor, brushless motor) configured to provide rotational movement to the transfer frame 1217. The translation actuator 1213 is configured to provide translation movement of the receptacle capture mechanism 1214. The translation actuator 1213 may include, for example, one or more actuator driven linkages to provide lateral motion to the receptacle capture mechanism 1214. The receptacle capture mechanism 1214 is configured to grasp, hold, or otherwise capture the sample receptacle 301. In embodiments, the receptacle capture mechanism 1214 may include a vacuum chuck configured to capture the sample receptacle 301 via suction. The sample transfer mechanism 1211 further includes one or more probes 421 driven by one or more probe actuators 422. In an embodiment, e.g., as shown on FIG. 14A, each probe 421 may have a designated probe actuator 422 configured to cause the probe(s) 421 to advance and retract through a central opening of the receptacle capture mechanism 1214 to contact the sample receptacle 301. In further embodiments, a single probe actuator 422 may be configured to operate or actuate more than one different probe 421. In embodiments, the one or more probes 421 may be manually configurable on the probe actuator 422. In further embodiments, the one or more probes 421 may be automatically selected and mounted to the probe manufacturer by the sample transfer mechanism 1211.

The rotational actuator 1212 and the translation actuator 1213 cooperate to provide rotational movement and translation movement to cause the receptacle capture mechanism 1214 to adopt the receptacle capture position, the sample transfer position, and an idle position. The idle position, as shown, e.g., in FIG. 13, is any position in which the sample transfer mechanism 1211 is held such that it does not obstruct or interfere with other aspects of the sample handling system 1201.

The receptacle capture position, as shown in FIG. 14A, is adopted by the sample transfer mechanism 1211 to bring the receptacle capture mechanism 1214 into a position to grasp or capture the sample receptacle 301 when it is released from the sample cartridge 200 in the receptacle release position. In an embodiment, the rotational actuator 1212 and the translation actuator 1213 cooperate to move the receptacle capture mechanism 1214 into contact with the sample receptacle 301, the receptacle capture mechanism 1214 is activated to grasp/capture the sample receptacle 301 (e.g., the vacuum chuck provides suction), and the sample movement mechanism 1241 is actuated to cause the sample cartridge 200 to adopt a receptacle release position. The sample receptacle 301 may then be moved down through the receptacle window 212 and away from the sample cartridge 200.

The sample transfer position, as shown in FIG. 14B, may be adopted by the sample transfer mechanism 1211 in conjunction with the sample movement mechanism 1241 causing the sample cartridge 200 to adopt the transfer position, e.g., in response to a transfer position command. The sample movement mechanism 1241 may operate to align the sample slide 401 with the sample transfer position of the sample transfer mechanism 1211, such that the sample slide 401 is positioned for contact with a sample contained in the sample receptacle 301. In embodiments, the sample movement mechanism 1241 may manipulate the sample cartridge 200 such that the sample slide 401 is aligned with the receptacle window 212 of the cartridge drawer 202. The sample movement mechanism 1241 may raise the sample receptacle 301 through the receptacle window 212 and into proximity with the sample slide 401 to adopt the sample transfer position.

Once in the sample transfer position, the sample transfer mechanism 1211 may cause sample transfer via the probe actuator 422, e.g., in response to a probe transfer command, causing the probe 421 to extend and contact the underside 394 of the sample receptacle 301. Force against the underside 394 of the sample receptacle 301 causes the sample platform 304 to elevate, causing the sample to contact the sample slide 401, as described above.

The probe 421 may be applied to the underside of the sample receptacle 301 according to one or more probing characteristics. Probing characteristics may include a plurality of probe movement characteristics and/or a probe shape characteristic. The probe 421 may be actuated with a plurality of probe movement characteristics, including one or more of probe force, probe speed, and probe trajectory. Probe force is the amount of force the probe provides to the underside of the sample receptacle. Probe speed is the speed at which the probe moves to cause the sample transfer. Probe trajectory may include a time varied profile of probe speed and probe force. Each of probe force and probe speed may vary according to a probe trajectory motion profile during actuation. The probe movement characteristics may be selected and thus correspond to a sample type.

Additionally, probe shape characteristics may be selected according to a sample type. For example, a blunt probe 421 may be selected for solid or coherent tissue, to cause a broad portion of the membrane 317 of the sample receptacle 301 to contact the sample slide 401, as shown in FIG. 14C. A narrow or sharp probe 421 may be selected for a low viscosity sample, such as a fluid, to cause a narrower, more localized deformation of the membrane 317 to break the fluid surface tension to permit deposit on the sample slide 401, as illustrated in FIG. 14D.

In embodiments, both probe shape characteristics and probe movement characteristics may be selected according to probe type. For example, a fast speed paired with a “sharp” probe may be used for samples with low viscosity (fluids) to break the surface tension of the fluid for controlled deposit onto the slide. A slow speed paired with a “blunt” probe may be used for solid/coherent tissue samples for a controlled “touch imprint” of the tissue. As discussed above, the shape of the probe 421 may be also selected in accordance with characteristics of the sample, e.g., viscosity. For example, a sharp, narrow, or pointed probe tip may be suitable for transfer of samples having a lower viscosity while a blunt, flat, or rounded probe tip may be suitable for transfer of samples having a higher viscosity.

The probe movement characteristics and the probe shape characteristics of the probe 421 may be selected ahead of time (pre-selected), for example, during sample processing procedures wherein a specific type of sample is expected. The probe movement characteristics and the shape of the probe 421 may be selected during sample processing, for example, by a user that assesses a deposited sample and selects a probe for the transfer operation. Further, the probe movement characteristics and the shape of the probe 421 may be selected via automated means. For example, the imaging device 1281 may capture an image of the sample control system 1100 may make a determination to select an appropriate probe. In an embodiment, the sample receptacle 301 may be tilted by the sample transfer mechanism 1211 and the imaging device 1281 (or other sensor) may be used to sense motion. If a threshold amount of motion is detected, it may be determined that the sample contains large amounts of liquid and a sharp profile probe may be selected and employed with higher probe speed. If there is less than a threshold amount of motion, it may be determined that the sample is mostly solid and a flat profile probe with slower motion can be used for a “touch imprint.”

The sample transfer mechanism 1211, as described herein, is configured to position a sample receptacle 301 in proximity to sample slide 401 and apply a probe 421 to the sample receptacle 301 to transfer the sample. The specific collection of actuators and components, e.g., the rotational actuator 1212, the translation actuator 1213, the receptacle capture mechanism 1214, the probe actuator(s) 422, and the transfer frame 1217 are provided by way of example only. Other combinations of rotational and linear actuators may be used to facilitate or generate the described functionality.

In embodiments, the sample transfer mechanism 1211 may manipulate the sample receptacle 301 (and sample contained therein) in various ways to improve sample transfer. For example, prior to sample transfer initiated by the probe 421, the sample receptacle 301 may be positioned at an angle or tilted to cause fluid associated with the sample to flow away from solid matter of the sample and into the trough 303. Initiating sample transfer after separating fluid in this manner may permit tissue fragments in the sample to adhere to the sample slide 401 better.

In embodiments, the sample transfer mechanism 1211 may apply vibration or ultrasound energy to the sample in the sample receptacle 301. For example, the sample transfer mechanism 1211 may include one or more actuators, such as ultrasound probes or vibratory actuators to apply such energy to the sample receptacle 301. Vibration or ultrasound energy may break up blood clots that may be present in the sample. Sometimes, relevant cells may be contained within blood clots and it may be desirable to deposit these onto a sample slide 401, but a standard touch transfer of the clot may result in only blood being transferred.

In embodiments, the sample transfer mechanism 1211 may apply pressurized or forced air to the sample within the sample receptacle 301 to manipulate the sample. For example, it may be desirable to touch imprint different sides of a forceps obtained sample. Forced or pressurized air may be used to alter the sample position and thus facilitate multiple touch imprints on different sides of the sample.

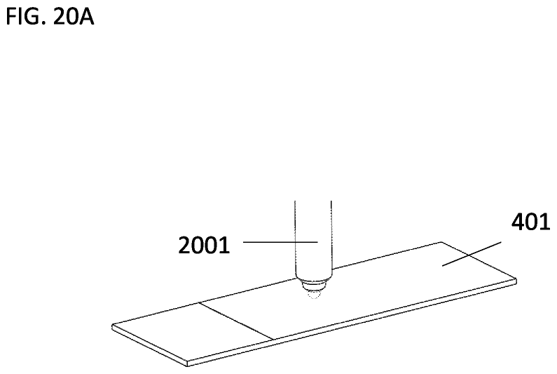

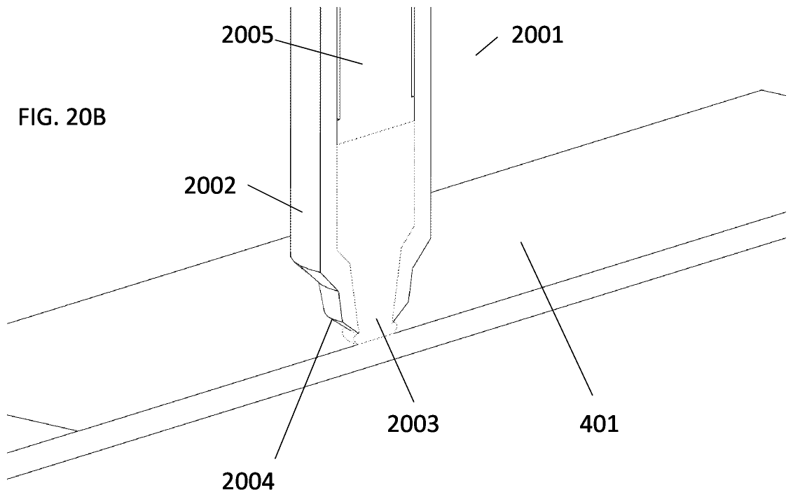

In further embodiments the sample transfer mechanism 1211 may operate in alternative ways to transfer sample from a sample receptacle to a sample slide. In some embodiments, alternative sample receptacles and/or alternative mechanisms may be employed. For example, in an embodiment, as illustrated in FIGS. 20A and 20B, a sample receptacle 2001 may include a cup shaped container 2002 with a hole 2003 at the bottom, optionally at the end of nozzle 2004. The hole 2003 may be sized such that sample does not leak through the hole when added to the sample receptacle 2001. During sample transfer, the sample transfer mechanism 1211 may cause the sample receptacle 2001 to be arranged over a sample slide 401 and may apply pressure, for example, via a plunger 2005 or other mechanism, to the sample to force the sample through the hole 2003 and onto the sample slide 401.

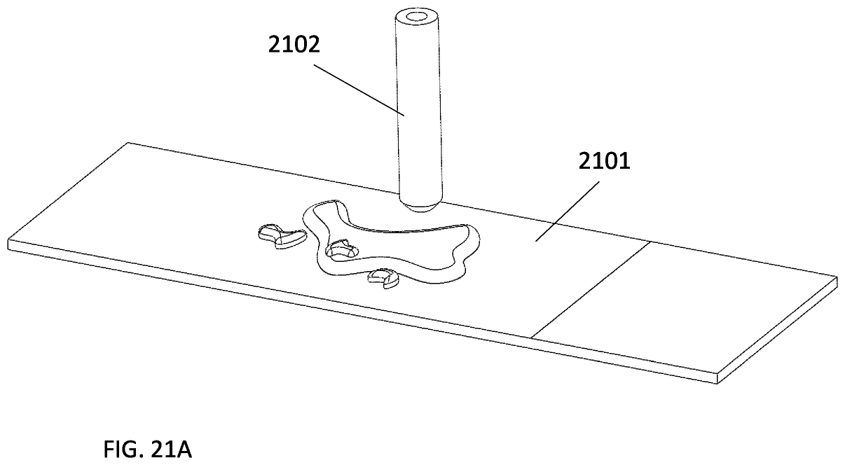

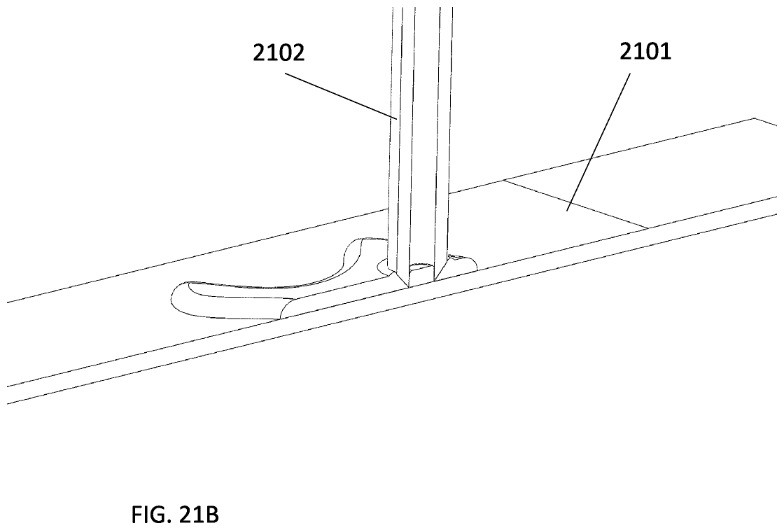

In another example, the sample transfer mechanism 1211 may operate as follows, as shown in FIGS. 21A and 21B. A sample receptacle 2101 may include a substantially flat substrate configured to receive the sample. The sample receptacle may be contained within a sample cartridge consistent with the present disclosure and/or may be handled separately by the integrated sample processing system 100. A sample tube 2102 is brought into contact with the sample receptacle 2101 at the location of the sample. The sample tube 2102 is a hollow cylinder. Accordingly, when the sample tube 2102 is brought into contact with the sample receptacle 2101, a portion of sample is contained within the sample tube 2102, as shown in FIG. 21B. Optionally, edges of the sample tube 2102 may be sharp and may be configured to cut the sample. A fluid is applied by the fluid distribution system 1251 (or other fluid system associated with the integrated sample processing system 100) to rinse or wash away excess sample on the sample receptacle 2101 outside of the sample tube 2102. In embodiments, the fluid may be formalin or other preservative fluid and the excess sample may be rinsed into a sample preservation container. The sample tube 2102 may then be lifted away from the sample receptacle 2101 by the sample transfer mechanism 1211. The sample remains within the sample tube 2102. In embodiments, an opposite end of the sample tube 2102 may be sealed to assist in maintaining the sample within the sample tube 2102. The sample movement mechanism 1241 may then operate to expose a portion of the sample slide 401 and align the sample slide 401 with the sample tube 2102 held by the sample transfer mechanism 1211. The sample tube 2102 may then be brought into proximity or contact with the sample slide 401 and the sample released onto the sample slide 401. In embodiments, release of the sample may be affected by release of the seal at the opposite end of the sample tube 2102, by vibration or other agitation, and/or by the application of air pressure to the opposite end of the sample tube 2102. In embodiments, the sample slide 401 may be arranged within the sample cartridge 200 or within the integrated sample processing system 100 without a sample cartridge 200 such that a deposition surface of the sample slide 401 is facing upwards to facilitate this technique.

In embodiments, an imaging device 1281 may be employed before, during, or after the sample transfer operation to assist in the sample transfer. The imaging device 1281 may include one or more cameras, CCDs, CMOS devices, and/or other devices capable of capturing images. The imaging device 1281 may further include optics, lenses, and/or other means of focusing, magnifying, and generally facilitating image capture. For example, the imaging device 1281 may include microscope lenses at multiple magnifications. In embodiments, the imaging device 1281 may include multiple imaging devices. For example, a first imaging device 1281 may be configured to capture images of the sample slide 401 during processing to help guide processing steps, as discussed below. A second imaging device 1281 may be configured to capture higher resolution images of the sample disposed on the sample slide 401 after completion of slide staining for use, for example, in cytological evaluation. The imaging device 1281 may be located and configured so as to capture images of the sample slide 401 when the sample slide 401 is positioned in the sample transfer position. In embodiments, the imaging device 1281 may be coupled to one or more actuators that facilitate movement of the imaging device 1281, for example to position the imaging device 1281 appropriately for image capture. The imaging device 1281 may operate in response to one or more imaging commands.

The imaging device 1281 may capture an image of the sample slide 401 prior to sample transfer. Such an image may be processed or otherwise analyzed by the control system 1100 (e.g., the process manager 1124) to determine that the sample slide 401 is properly located. The imaging device 1281 may capture an image of the sample in the sample receptacle 301 prior to sample transfer. Such an image may be processed or otherwise analyzed by the control system 1100 to determine characteristics of the sample that may be used in probe selection. Such an image may be processed to determine sample characteristics that may then be stored in association with the any other obtained sample data for later use. For example, the control system 1100 may operate to count or otherwise determine various features of the sample, such as a number of tissue chunks in the sample. Such features may assist in an evaluation of the sample image information.

The imaging device 1281 may capture an image of the sample slide 401 after sample transfer. Such an image may be processed or otherwise analyzed by the control system 1100 (e.g., the process manager 1124) to determine whether sample transfer was successful, e.g., whether an appropriate amount of sample was transferred to the sample slide 401. If too little sample was transferred, the control system 1100 may cause the sample transfer mechanism 1211 to repeat the sample transfer operation. If too much sample was transferred, the control system 1100 may cause the sample transfer mechanism 1211 to perform a sample scrape operation.

A sample scrape operation may be performed by the sample transfer mechanism 1211 bringing the sample lip 306 of the sample receptacle 301 into proximity with the transferred sample. The translation actuator 1213 may then be activated to cause the sample lip 306 of the sample receptacle 301 to scrape or drag across the transferred sample, with or without touching the sample slide 401, to reduce the amount of sample on the sample slide 401. In embodiments, the sample scrape operation may replace the sample smear operation described herein for distributing the transferred sample across the slide. In embodiments, the sample smear operation, described in greater detail below, may employ a feature of the sample receptacle 301 such as the sample lip 306 to perform the sample smearing.

In further embodiments, the sample transfer mechanism 1211 may perform one or more additional sample processing steps. For example, the sample receptacle 301 may include additional features configured to interact with or process the sample. In an example, a tool, such as a blade, needle or other cutting instrument may extend from the sample receptacle 301. In such an embodiment, the sample transfer mechanism 1211 may be configured to manipulate the sample receptacle and the tool disposed thereon to further process the sample, e.g., by breaking up a blood clot or tissue fragment.

FIG. 15 illustrates aspects of the sample smearing mechanism 1231 of the sample handling system 1201. The sample smearing mechanism 1231 includes grasping mechanism 1232, a force sensor 1233, a smearing mechanism frame 1234, and a rotational actuator 1235. The force sensor 1233, smearing mechanism frame 1234, and rotational actuator 1235 may be referred to as an actuated probe. The smearing mechanism frame 1234 is secured to the rotational actuator 1235 and provides a structure on which the grasping mechanism 1232 and the force sensor 1233 are located. The rotational actuator 1235, which may be a motor, such as a stepper motor, is configured to provide rotational movement to the smearing mechanism frame 1234 to bring the grasping mechanism 1232 into contact with the smear plate 501. The grasping mechanism 1232 may include a compliant structure with a contact surface, for example, a suction cup. The smear plate 501 may be disposed within the smear plate support 214 of the sample cartridge 200. In some embodiments, the sample smearing mechanism 1231 may retrieve or obtain a smear plate from an alternate location to perform the smearing operation.

In a sample smearing operation, the sample movement mechanism 1241 may receive a smear position command that cause smear plate 501 and the sample slide 401 to adopt a smear position. In embodiments, the smear position may be adopted via manipulating the sample cartridge 200 via the sample movement mechanism 1241. In the smear position, the smear plate 501 and the sample slide 401 may be vertically aligned. Within the sample cartridge 200, the smear plate window 215 may be vertically aligned with the sample slide window 11.

The sample smearing mechanism 1231 may receive a smearing command configured to cause the rotational actuator 1235 to rotate and bring the grasping mechanism 1232 into contact with second surface 512 of the smear plate 501. Further rotation of the rotational actuator 1235 causes the smear plate 501 to approach the slide 401 and to contact the sample disposed thereon. The smear plate 501 may be brought to a predetermined distance from the sample slide 401 to press or smear the sample against the sample slide 401. The sample movement mechanism 1241 may then be engage to move the sample slide 401 relative to the smear plate 501 to continue the smearing process.

The smearing process may be enhanced by operation of the compliant structure of the grasping mechanism 1232 and the force sensor 1233. The compliant nature of the grasping mechanism may assist when bringing the smear plate 501 into contact with the sample. For example, because the sample may not be uniformly distributed, may be solid or semi-solid, and/or may not be centrally located with respect to the smear plate 501, the compliance of the gripping mechanism 1232 may permit the gripping mechanism to flex or deform to better allow the smear plate 501 to contact and distribute the sample. The force sensor 1233 may be employed to control an amount of force that is applied during the smearing operation. The amount of force applied may be selected or determined according to one or more characteristics of the sample that is smeared, e.g., based on image information obtained by the imaging device 1281. For example, if it is determined based on the image information that there is a clot or larger piece of tissue present, a larger amount of force may be applied to flatten the tissue for better visualization by the imaging device 1281. Conversely, if there is just a thin layer of tissue on the sample slide 401, there may be a light smear using a small amount of force to ensure sure that cells in the sample are not crushed. In embodiments, the smearing operation may be omitted entirely based on a determination made by the control system 1100 via analysis of the image information. For example, if a touch preparation of a solid piece of tissue was performed, the cells may already be presented in a mono-layer on the glass slide and smearing may cause the cells to rupture or be crushed. In embodiments, the force may be dynamically adjusted during a smearing operation according to output from the force sensor 1233. Dynamic adjustment may include adjusting the force to maintain a steady force or adjusting the force to follow a pre-determined force profile.

In embodiments, the smearing operation may operate without the smear plate 501 discussed above. For example, the smearing mechanism 1231 may include a roller, either gripped by the grasping mechanism 1232 or disposed on the smearing mechanism frame 1234 in place of the grasping mechanism 1232. The smearing mechanism 1231 may be configured to provide the roller with a charge, e.g., a positive or negative charge, that causes the roller to repel the sample. The roller may then be employed to smear, e.g., by rolling over, or back and forth over, the deposited sample on the sample slide 401. The charge on the roller may aid in preventing the sample from sticking to the roller. After use, the roller may be disposed of and/or cleaned/sanitized. In another example, the smearing operation may employ a feature of the sample receptacle 301, such as the sample lip 306 or other feature, to perform the sample smearing without use of the smear plate 501.

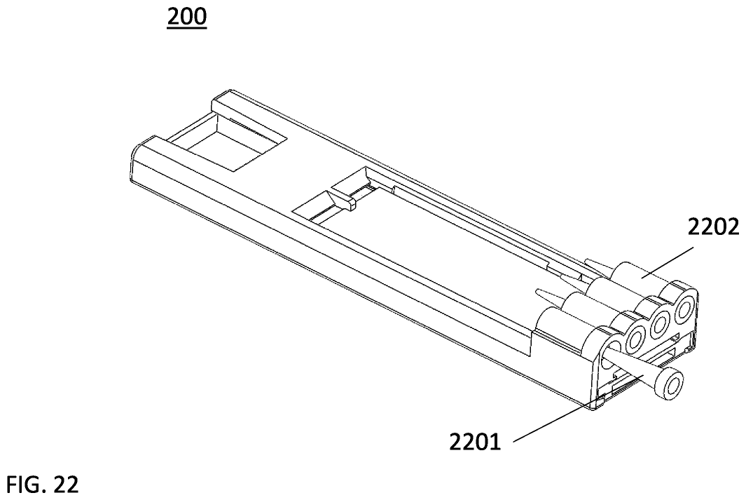

In further embodiments, the sample smearing mechanism 1231 may perform one or more additional sample processing steps. For example, the sample cartridge 200 may include additional features configured to interact with or process the sample. In an example, as illustrated in FIG. 22, one or more tools 2201, such as a blade, needle or other cutting instrument may be contained within a tool holder 2202 of the sample cartridge 200, with a window beneath permitting access by the sample smearing mechanism 1231. The grasping mechanism 1232 or other actuator associated with the sample handling system 1201 may be configured to grasp or control the tool to perform additional sample processing, before or after the smearing operation. In such an embodiment, the sample smearing mechanism 1231 may be configured to manipulate the sample receptacle and the tool disposed thereon to further process the sample, e.g., by breaking up a blood clot or tissue fragment.

In embodiments, the imaging device 1281 may be employed after a sample smearing operation. The imaging device 1281 may be used to capture an image of the smeared sample to analyze one or more smear characteristics, such as a thickness of smeared sample. Such an image may be processed or otherwise analyzed by the control system 1100 (e.g., the process manager 1124) to determine whether the smeared sample is acceptable for further sample processing steps (e.g., staining, imaging).

In embodiments, sample separation and/or smearing or distribution on the sample slide 401 may occur outside of or remote from the integrated sample processing system 100. The sample slide 401 may then be inserted into the sample processing system 100 (with or without a sample cartridge 200). The imaging device 1281 may be used to capture an image of the prepared sample or sample slide 401. Such an image may be processed or otherwise analyzed by the control system 1100 (e.g., the process manager 1124) to determine whether the prepared sample slide 401 is acceptable for further sample processing steps (e.g., staining, imaging).

The image of the sample slide 401 may be analyzed for various potential deficiencies. For example, an amount of sample may be assessed and a composition of the sample may be assessed.

In embodiments, if the prepared sample is not acceptable the sample processing system may eject the sample slide 401 (or sample cartridge 200) and prompt a user to take appropriate steps, e.g., adding additional sample to the sample slide 401, providing a new sample slide 401 and/or new sample cartridge 200, clearing excess blood, clotting, or other substance from the sample slide 401, or any other suitable action. In embodiments, if the sample is not acceptable the integrated processing system 100 itself may take action. For example, in the case of too little sample, the integrated processing system 100 may operate to repeat a sample transfer and a sample smearing operation to add sample. In the case of a sample containing excess blood, clotting, or other substance, the integrated processing system 100 may operate to perform a scraping technique using the sample lip 306, as described above.

FIGS. 16A-16C illustrates aspects of the fluid distribution system 1251. The fluid distribution system 1251 may include one or more fluid dispensers 1252, also referred to as fluid deposition devices, coupled to one or more dispenser actuators. The one or more fluid dispensers 1252 may include syringes, pipettes, or other suitable devices for dispensing fluids. The dispenser actuators may include one or more actuators for movement (horizontal and/or vertical) of the fluid dispensers 1252 and one or more actuators to control fluid dispensing by the fluid dispensers 1252. The fluid distribution system 1251 may be configured as a “sip and spit” system configured to obtain the required fluids from refillable or replaceable containers. The fluid distribution system 1251 may also be configured with tubing to directly supply the fluid dispensers 1252 with the necessary fluids. In embodiments, the fluid dispensers 1252 may further or alternatively include one or more actuators or actuated tools configured to interact with the stain storage units 701 of the sample cartridge to cause fluid deposition, as discussed further below. For example, the fluid dispensers 1252 may be configured to apply force or pressure to the fluid seals 704 of the stain storage modules 702 to cause ejection of fluid from the fluid outlets 703.

In embodiments, the fluid distribution system 1251 may operate in conjunction with the sample handling system 1201 to perform a staining operation. The control system 1100 may supply a flood start command to the sample movement mechanism 1241 to cause the sample slide 401 and the coverslip 601 to adopt the flood start position (FIG. 16A), e.g., in response to a flood start position command. The control system 1100 may further supply a fluid dispensing command to the fluid distribution system 1251 to cause the fluid distribution system 1251 to deliver fluids to the vertical gap g between the sample slide 401 and the coverslip 601, as discussed above. A flood finish command supplied to the sample movement mechanism 1241 by the control system 1100 may be configured to cause the sample slide 401 and the coverslip 601 to move relative to one another from the flood start position to the flood finish position (FIG. 16B) e.g., in response to a flood finish position command. As discussed above, additional fluid may be supplied by the fluid distribution system 1251 to the coverslip 601 during the flooding movement. After completion of the flooding movement, at the flood finish position, the staining operation may continue with the fluid flush operation.

A sample rotation command may be provided to the sample orientation system 1221 by the control system 1100. Responsive to the sample rotation command, the sample orientation system 1221 may cause rotation of the sample slide 401 and the coverslip 601. In embodiments, the sample orientation system 1221 may include a motor or other actuator configured to alter the orientation of the sample handling system 1201. In further embodiments, the sample orientation system 1221 may include a motor or other actuator configured to alter the orientation of the sample cartridge 200 without rotating the rest of the sample handling system 1201. After rotation, additional fluids may be supplied to the gap between the sample slide 401 and the coverslip 601 to flush previous fluids, as discussed above, e.g., in response to a flush command.

As discussed above, the fluid distribution system 1251 may include one or more actuators or actuated tools configured to interact with the stain storage unit 701 of the sample cartridge 200.

In embodiments, various agitation techniques may be employed during a slide staining operation to increase the efficiency or completeness of staining or reduce the time required for staining. For example, the sample movement mechanism 1241 may be employed to cause relative movements between the sample slide 401 and the coverslip 601 to cause shear forces in the fluid between the two. In another example, the sample movement mechanism 1241, or other actuator associated with the integrated processing system 100, may be employed to vibrate the sample cartridge 200, and therefore also the sample slide 401 and the coverslip 601. In another example, an ultrasound actuator may be employed to agitate the sample slide 401 and the coverslip 601. In still another example, any of the actuators associated with the integrated sample processing system 100, e.g., as part of the sample transfer mechanism 1211, the sample smearing mechanism 1231, the fluid distribution system 1251, or any additional actuators added to the integrated sample processing system 100 for this purpose, may be employed to contact and press on the coverslip 601 or the sample slide 401 to cause slight bending or flexing of these features to agitate stain.

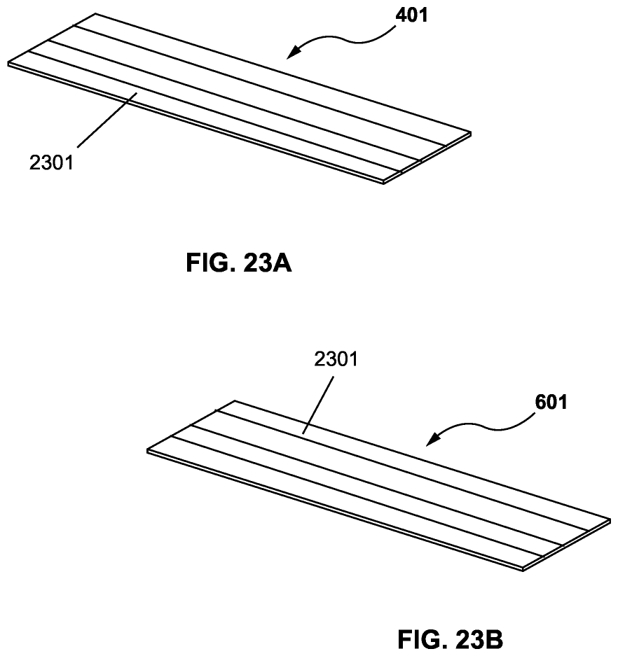

In further embodiments, the fluid distribution system 1251 may operate to selectively stain portions of the sample slide 401 with different stains in different places. In an embodiment, the fluid distribution system 1251 may cause selective staining by depositing stain on the coverslip 601 in strips running the length of the coverslip 601. As the coverslip 601 and the sample slide 401 are advanced from the flood start position to the flood finish position, the different strips of stain may stain different portions of the sample slide 401. Due to the low levels of movement and agitation during the transition from the flood start position to the flood finish position, mixing between the different strips of stain may be limited. Mixing between the different strips may be further limited or eliminated by one of the sample slide 401 or the coverslip 601 including a series of lengthwise ridges 2301 (which may be the same height as the vertical gap g) running their length, as illustrated in FIGS. 23A and 23B. When the sample slide 401 and the coverslip 601 are placed in proximity to one another, the lengthwise ridges 2301 create channels through which the stain fluid may be distributed. The fluid distribution system 1251 may dispense fluid to each channel separately such that when the coverslip 601 and the sample slide 401 are moved to a position of greater overlap, the fluid fills each longitudinal channel and provides lengthwise strips of alternate stains. In an embodiment, a series of widthwise ridges may be included on one of the sample slide 401 or the coverslip 601. Such ridges would create widthwise channels to which different fluids from the fluid distribution system 1251 are dispensed to provide widthwise strips of alternate stains. In an embodiment, a fluid dispensing cartridge may operate to dispense amounts of fluid across different portions of the sample slide 401 or the coverslip 601 before bringing the two into proximity to create differing regions of stain.

In embodiments, the imaging device 1281 may be employed after a slide staining operation to capture an image of the sample disposed on the sample slide 401 for further analysis, as discussed below. For example, after completion of staining, water may be the only fluid between the coverslip 601 and the sample slide 401. Thus, images may be captured with the fluid and coverslip 601 in place without excess distortion from a colored fluid. Imaging through the coverslip may facilitate better matching of a refractive index as compared to imaging a bare air-dried slide without coverslip.

In embodiments, the imaging device 1281 may be employed after or during a sample staining operation. The imaging device 1281 may be used to capture an image of the stained sample. Such an image may be processed or otherwise analyzed by the control system 1100 (e.g., the process manager 1124) to determine whether the stained sample is acceptable for further sample processing steps (e.g., staining, imaging). For example, the control system 1100 may make a determination that the sample is not evenly stained or is not completely stained. The control system 1100 may then operate to add additional stain or to perform one or more of the staining operation steps again. In embodiments, the imaging device 1281 may be employed for such assessment after or during any portion of the sample staining operation, from initial stain deposition, to stain distribution, to the flushing steps, etc.

FIGS. 17A-17C illustrate a slide ejection operation as performed by the sample movement mechanism 1241 and the slide receipt system 1271. The sample transfer mechanism 1211 is not illustrated in FIGS. 17A-17C to provide a clearer view of the slide receipt system 1271 The sample movement mechanism 1241 operates to manipulate the sample cartridge, e.g., as described with respect to FIG. 9A and FIG. 9B, to perform the first ejection motion and the second ejection motion so as to adopt the slide ejection position, e.g., in response to a slide ejection command. In the first ejection motion, the sample movement mechanism 1241 causes relative motion between the cartridge frame 201 and the cartridge drawer 202 to expose a sample slide 401 and permit grasping with a slide release mechanism 1272 of the slide receipt system 1271. The slide receipt system 1271 is a system including actuators and other elements configured for receiving a sample slide 401 from the sample cartridge 200 and placing the sample slides 401 in a container. The slide release mechanism 1272 may include a grasping device, such as a suction cup, robotic finger, or other gripper disposed on an actuated arm and configured for vertical and horizontal movement. In the second ejection motion, the sample movement mechanism 1241 causes relative motion between the cartridge frame 201 and the cartridge drawer 202 withdraw the cartridge frame 201 back over the cartridge drawer 202 while the sample slide 401 is held in place laterally (and optionally guided vertically) by the slide release mechanism 1272 to advance the sample slide 401 out of the sample cartridge 200 (e.g., out of the trailing end 292). After the slide ejection operation, the sample slide 401 may be removed fully from the sample cartridge 200 or may be permitted to air dry before capture by the slide receipt system 1271. In embodiments, the slide release mechanism 1272 may be further configured to guide the sample slide 401 to a receptacle of the slide receipt system 1271. The slide receipt system 1271 may include a container that facilitates organization of sample slides 401 created during a single biopsy procedure. The container may include receptacles for the stained slides 401, an alcohol and/or fixative container for non-stained sample slides 401, and receptacles for formalin and/or preservative containers for receiving the sample receptacle 301.

In embodiments, air drying may include the forced application of heat or air flow to speed or facilitate drying. In embodiments, an imaging device 1281, as described below, may be used to image the sample slide 401 during a drying procedure to determine whether the drying is complete.

In embodiments, the sample slide 401 may be advanced to the slide ejection position without the coverslip 601 for air drying, imaging, or any other further processing. In further embodiments, the sample slide 401 may be configured for release and advancement into the ejection position with the coverslip attached thereto. For example, after staining, an actuator of the integrated sample processing system 100, e.g., the sample transfer mechanism 1211 or the sample smearing mechanism 1231, may be configured to engage the coverslip 601 in the cartridge drawer 202, release the coverslip 601 from the cartridge drawer 202, and adhere the coverslip 601 to the sample slide 401. In examples, the sample slide 401 and the coverslip 601 may be adhered due to the presence of staining fluid. In further examples, one or more substances (e.g., adhesive) may be included on the sample slide 401 or the coverslip 601 to facilitate such adhesion. Such techniques may be employed for use with stains that are typically viewed with a cover slip, e.g., Toludine Blue.

In embodiments, the imaging device 1281 may operate during an imaging operation after completion of the slide ejection operation. For example, the imaging device 1281 may be configured to capture an image of the sample disposed on the sample slide 401 when the sample slide 401 is in the slide ejection position (e.g., extending from the sample cartridge 200). In embodiments, the slide receipt system 1271 may capture the sample slide 401 and transfer the sample slide 401 to an alternate location for imaging by the imaging device 1281.

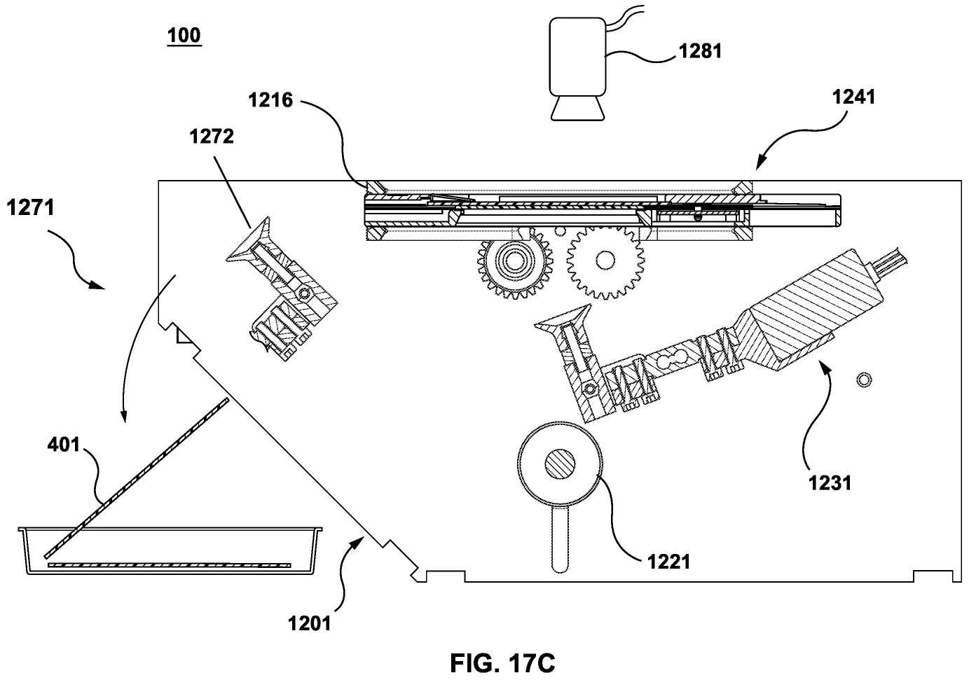

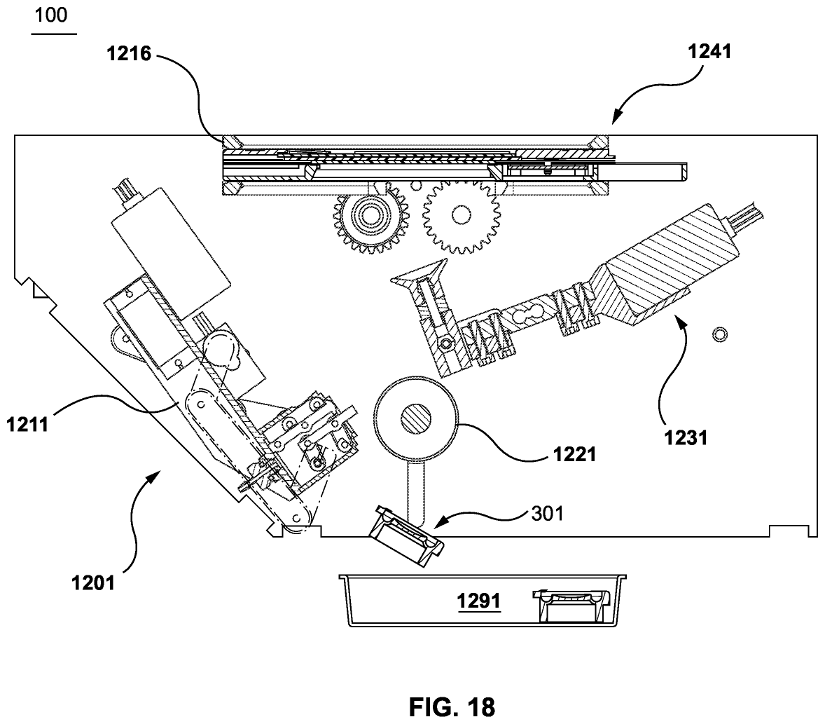

FIG. 18 illustrates aspects of the receptacle receipt system 1291. In embodiments, at any point after the sample transfer operation for the second sample slide 401, the sample receptacle 301 may be transferred to the receptacle receipt system 1291 for storage and preservation. The receptacle receipt system 1291 may include at least a container of preservative fluid (or, e.g., a frame or holder configured to hold such a container). In embodiments, the sample transfer mechanism 1211 may operate as part of the receptacle receipt system 1291. A receptacle release command supplied to the receptacle receipt system 1291 (e.g. to the sample transfer mechanism 1211) may cause the sample transfer mechanism 1211 to lower the sample receptacle 301 into proximity with a container of the receptacle receipt system 1291. The sample receptacle 301 may be released by the sample transfer mechanism 1211 for preservation in a preservative fluid contained in the container of the receptacle receipt system 1291. The preserved sample may be collected from the system and delivered to a pathology lab for further processing. The preservative fluid may include any suitable fluid, such as formalin or related media, saline, RPMI or related media, etc., that are appropriate for preserving an anticipated sample type. In embodiments, the container of the receptacle receipt system 1291 may include more than one container and or preservative fluid for preserving multiple different types of samples. In embodiments, the container of the receptacle receipt system 1291 and the container of the slide receipt system 1271 may be the same container. In embodiments, the integrated sample processing system 100 may mark or label the container with identifying indicia to associate the contained sample slides 401 and sample receptacle 301 with images and data obtained during the sample processing operations.

As discussed above, the imaging device(s) 1281 described herein may be configured to capture an image of the sample disposed on the sample slide 401 for sample evaluation at various points during sample processing. For example, after completion of staining, after sample slide ejection, and/or after receipt of the sample slide 401 by the slide receipt system 1271. Images captured of the sample on the sample slide 401 may be used for sample evaluation. The sample may be evaluated for adequacy, to determine whether the obtained sample is sufficient for purposes for which it was collected. The sample may further be evaluated to generate a preliminary diagnosis.

In an embodiment, the sample slide is scanned or imaged by the imaging device 1281 using a raster scan with an automated XY or XYZ stage. The captured image may include images that are stitched together and stored, transmitted, or otherwise used as a single digital file for remote pathologist viewing, viewing on the display 102, and/or automated analysis.

In embodiments, captured images may be displayed via display 102, which may be a high resolution display. Display of such images on display 102 at the integrated sample processing system 100 may permit a local user (e.g., interventionalist) to make judgments or decisions (adequacy assessments, preliminary diagnosis, etc.) based on the captured image shortly after collection of the sample.

In further embodiments, a remotely located pathologist may review and assess the captured image and provide results to a user/operator of the integrated sample processing system 100. In further embodiments, a remotely located pathologist may control the X and Y translation of the slide as well as the Z focus during imaging when making a remote assessment of adequacy and/or preliminary diagnosis.

In an embodiment, machine learning systems, expert systems, or other artificial intelligences systems or models may be used to make an automatic adequacy assessment, identify tissue/cell type, or provide a diagnosis at the time of sample evaluation. This information may be displayed to the interventionalist on the display 102 along with the confidence levels of the Al determination. Artificial intelligence analysis may operate on the control system 1100 and/or via remote computing systems.

In further embodiments, each sample slide 401, the sample receptacle 301, and any containers containing these may be automatically labelled with a sample identification by integrated sample processing system 100, for example, using laser etching or a printer element with patient or sample identification and clinical context for the biopsy sample. The sample identification may be in the form of a QR code, bar code, serial number, or any other suitable identification indicia that may be interpreted with a scanner or imaging device in a laboratory for further review of the slide. Additionally, the integrated sample processing system 100 may associate the sample identification in an internal database or records storage with any information, including image information and any further information derived therefrom, obtained, generated, or created by the integrated sample processing system 100 during processing of the sample associated with the labeled sample slide 401.

In further embodiments, the control system 1100 of the integrated sample processing system 100 may interface with other computer systems, for example, by a wired or wireless connection. In an example, the control system 1100 may interface with a surgical navigation system, or other clinical system. The control system 1100 may exchange information related to sample processing with the external/other computer system. For example, in an interface with a surgical navigation system, the control system 1100 may receive information from the surgical navigation system related to a harvested sample. Such information may include a location of harvest, method of harvest, and type of sample. Such information, collected by the surgical navigation system, may be stored in an internal database or records storage in association with the stored image information pertaining to the sample. In embodiments, the control system 1100 may transmit data to the external computer system. For example, in an interface with a surgical navigation system, the control system 1100 may transmit any information collected or generated with respect to the sample processing. In an example, the control system 1100 may send sample identifying information to the surgical navigation system so that a user may review information in the surgical navigation system and associate harvested samples with the images and information obtained by the integrated sample processing system 100. In another example, the control system 1100 may transmit a pathology result of the information analysis related to the sample (e.g., tumor, necrosis, normal tissue, malignancy, biomarkers, etc.) for association within the surgical navigation system with a harvest location or action.

In another embodiment, during the time that a sample slide 401 is being imaged with the imaging device 1281, a new sample cartridge 200 may be loaded into the machine for parallel scanning of the current sample and sample processing of the next sample.

In embodiments, as discussed above, a sample substrate containing a plurality of microwells may be employed in place of the sample slides 401. Sample transfer and smearing operations may operate similarly, with the sample being deposited and smeared across the plurality of microwells such that sample (e.g., tissue) is deposited into one or more of the plurality of microwells. After such deposition, each well among the plurality of microwells may be stained and/or imaged individually.

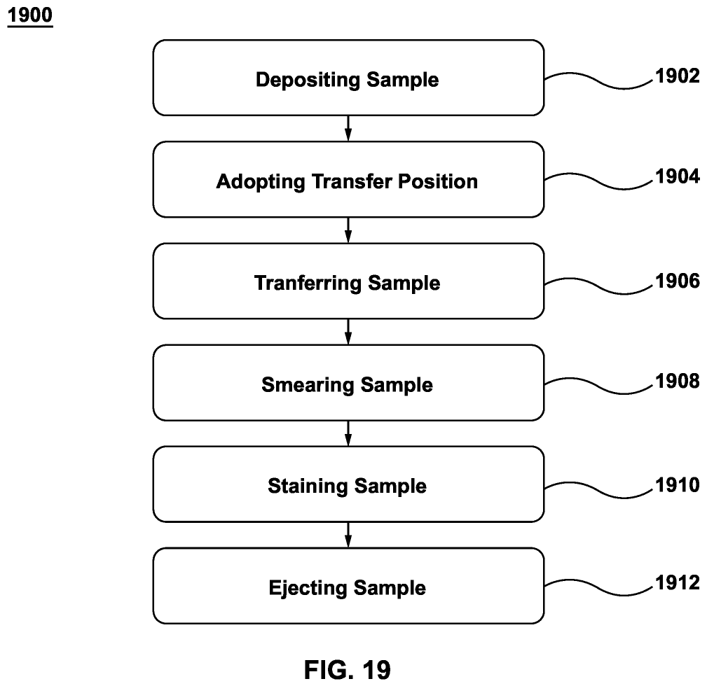

FIG. 19 illustrates a sample processing method consistent with embodiments hereof. The sample processing method 1900 may be performed according to the systems, techniques, and devices disclosed herein. The systems, techniques, and devices discussed herein provide examples that illustrate the operation and performance of elements of the sample processing method 1900 and are not exclusive. Accordingly, while the sample processing method 1900 may be performed by employing a sample cartridge 200 in conjunction with the integrated sample processing system 100 to carry out all of the steps described herein, this disclosure is not limited to such a combination. The steps and operations of the sample processing method 1900 described herein may be carried out in any suitable order and in any suitable combination. In embodiments, some or all of the steps and operations of the sample processing method 1900 may be carried with the sample cartridge 200 and manual processing techniques. In other examples, the integrated sample processing system 100 may perform any selection of the steps and operations of the sample processing method 1900 alone or in any combination, with or without the use of the sample cartridge. The steps and operations of the sample processing method 1900 may each stand alone or may be performed in any suitable combination with other steps and operations of the sample processing method 1900 and with any suitable combination of manual and automated processing techniques.

In an operation 1902, the sample processing method includes sample deposition. Sample deposition may include depositing a sample in a sample receptacle that includes a membrane. As described herein, the sample receptacle may be the sample receptacle 301. The sample receptacle may be disposed within a sample cartridge during or after sample deposition, as described herein. The sample receptacle may be received by an integrated sample processing system, as described herein, either alone or disposed within a sample cartridge. The sample receptacle may be contained or disposed with the integrated sample processing system (with or without a sample cartridge) when the sample is deposited.

In an operation 1904, the sample processing method includes sample transfer. Sample transfer, also referred to herein as sample separation, includes aligning a sample receptacle with a sample slide, applying a probe to an underside of the sample receptacle to cause the sample to be pressed to the sample slide to deposit at least a portion of the sample on the sample slide. In embodiments, this may involve deforming the sample receptacle (or a portion thereof, such as membrane), though application of the probe. In embodiments, the sample receptacle may be flat and/or rigid and the probe may advance the sample receptacle to the sample slide without deformation. In embodiments, aligning the sample receptacle with the sample slide may be performed according to manipulation of a sample cartridge, as described herein. In embodiments, aligning the sample receptacle with the sample slide may include bringing the sample receptacle and the sample slide into proximity with one another. In embodiments, aligning the sample receptacle with the sample slide may be performed by an integrated sample processing system, with or without a sample cartridge, as described herein. The sample cartridge, as described herein, represents an illustrative way of facilitating sample transfer, but is not required. The sample transfer operation may be performed by any structure or device, manually or automatically operated, that is capable of maintaining the relative positioning and causing the relative movement between the sample slide and the sample receptacle. For example, the sample slide may be manipulated by a slide movement mechanism without a sample cartridge and aligned with the sample receptacle grasped by a sample transfer mechanism. In embodiments, the probe may be applied to the underside of the sample receptacle by a probe actuator or manually, as described herein. Further methods and techniques for sample transfer are described above.

In an operation 1906, the sample processing method includes sample smearing. Sample smearing includes steps and techniques adapted for spreading, smearing, or otherwise distributing a deposited sample across a sample slide in preparation for staining and imaging. Sample smearing may include engaging a smear plate with a gripping device disposed on an actuated probe, controlling the actuated probe to cause contact between the smear plate and a sample disposed on a sample slide, controlling a force applied by the smear plate, and causing a relative movement between the smear plate and the sample slide to distribute the sample. Sample smearing may be performed by an integrated sample processing system, as discussed herein, with or without use of a sample cartridge. The sample cartridge, as described herein, represents an illustrative way of facilitating sample smearing, but is not required. The sample smearing operation may be performed by any structure or device, manually or automatically operated, that is capable of maintaining the relative positioning and causing the relative movement between the sample slide and the smear plate. For example, the sample slide may be manipulated by a slide movement mechanism without a sample cartridge and engaged by a smear plate gripped by a smearing mechanism. Further methods and techniques for sample smearing are described above.

In an operation 1908, the sample processing method includes sample staining. Sample staining includes steps and techniques described herein adapted for applying fluid (e.g., a staining fluid) to a sample containing sample slide. Sample staining may include arranging a sample slide and a coverslip in a flood start position having a vertical gap and a horizontal overlap, applying a fluid at the vertical gap, and arranging the sample slide and the coverslip in a flood finish position through relative movement. The relative movement between the sample slide and the coverslip causes the horizontal overlap between the sample slide and the coverslip to increase and the volume between the sample slide and the coverslip to fill with fluid. The flood start position may be defined such that a slide surface of the sample slide and a slip surface of the coverslip have a vertical gap of a predefined vertical distance and the sample slide and the coverslip have a horizontal overlap of a predefined horizontal distance. The flood finish position may be defined such that the horizontal overlap has a maximum horizontal distance. Additional fluid may be applied during the relative movement to ensure that there is enough fluid to fill the volume between the sample slide and the coverslip. In embodiments, a sample staining operation may further include rotation of the sample slide and the coverslip to a flush angle and application of additional fluid to the vertical gap. The sample staining operation as described herein may be performed by the integrated sample processing system, with or without a sample cartridge. The sample cartridge, as described herein, represents an illustrative way of facilitating sample staining, but is not required. The sample staining operation may be performed by any structure or device, manually or automatically operated, that is capable of maintaining the relative positioning and causing the relative movement between the sample slide and the coverslip. Further methods and techniques for sample staining are described above.

In an operation 1910, the sample processing method includes imaging the sample. Imaging the sample may include capturing an image of the sample via an imaging device, including one or more cameras and one or more lenses (e.g., microscope lenses, etc.). The imaging device may be included within the integrated sample processing system and/or may be located remotely. Images of the sample may be captured at various resolutions and magnifications. Images of the sample may be captured according to a single image capture or as multiple image captures (e.g., in a scanning process). Images of the sample may be collected together for storage, transmission, analysis, etc., as a single image file or as multiple image files. Images of the sample may be analyzed by an operator or user at the location of the integrated sample processing system 100 (e.g., via a display) or at a remote location. Images of the sample may be analyzed fully or partially through artificial intelligence systems, either locally at the integrated sample processing system and/or via remote computation (e.g., cloud services, remote servers, etc.). Images of the sample may be analyzed for various purposes, including, but not limited to, sample adequacy, initial, preliminary, or partial diagnosis, or any other determination.

In an operation 1912, the sample processing method includes ejecting the sample slide. The ejected sample slide may be captured by a slide receipt system and stored in a container with preservative fluid for further processing or use.

The sample processing methods described herein may thus provide for increased accuracy and consistency, decreased analysis time, and increased throughput of sample processing. Such advantages may be particularly valuable when provided in an on-site environment for providing rapid sample evaluation and thus improving outcomes. The sample processing methods described herein are not limited to on-site processing, and may be employed to improve sample processing in any environment, including surgical tumor or tissue resections, remote or off-site pathology laboratories, clinical facilities, academic research institutions, and others.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The embodiments described above are illustrative examples and it should not be construed that the present invention is limited to these particular embodiments. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the methods or processes). In addition, while certain features of embodiments hereof are described as being performed by a single module or unit for purposes of clarity, it should be understood that the features and functions described herein may be performed by any combination of units or modules. Thus, various changes and modifications may be affected by one skilled in the art without departing from the spirit or scope of the invention as defined in the appended claims.

Further embodiments include:

Embodiment 1 is a method of sample separation, the method comprising: depositing a sample in a sample receptacle, the sample receptacle comprising a membrane, aligning the sample receptacle with a sample slide, applying a probe to an underside of the sample receptacle to cause a motion of the membrane, and pressing the sample to the sample slide via the motion to deposit at least a portion of the sample on the sample slide.

Embodiment 2 is the method of embodiment 1, further comprising selecting the probe according to a sample type, wherein a shape of the selected probe corresponds to the sample type.

Embodiment 3 is the method of embodiment 1 or 2, further comprising selecting a probing characteristic according to a sample type.

Embodiment 4 is the method of embodiment 3, wherein the probing characteristic includes a probe movement characteristic including at least one of probe force, probe speed, and probe trajectory.

Embodiment 5 is the method of embodiment 3 or 4, wherein the probing characteristic includes a probe shape characteristic.

Embodiment 6 is the method of any of embodiments 1-5, further comprising assessing the sample to determine at least one of: an amount of the sample deposited, and a characteristic of the sample.

Embodiment 7 is the method of embodiment 6, wherein assessing the sample is performed based on a captured image.

Embodiment 8 is the method of embodiment 6 or 7, wherein assessing the sample is performed during depositing of the sample.

Embodiment 9 is the method of any of embodiments 1-8, further comprising engaging a lip of the membrane with the sample to remove excess sample from the sample slide.

Embodiment 10 is a method of sample smearing, the method comprising: engaging, via an actuated probe, a gripping device with a first side of a smear plate, controlling the actuated probe to cause contact between a second side of the smear plate and a sample disposed on a surface of a sample slide, controlling a force applied to the smear plate during contact with the sample, and causing relative movement between the smear plate and the sample slide to distribute the sample on the surface of the sample slide.

Embodiment 11 is the method of embodiment 10, wherein controlling the force is performed according to a force measurement made by a force sensor associated with the actuated probe.

Embodiment 12 is the method of embodiment 10 or 11, wherein the gripping device includes a compliant suction cup.

Embodiment 13 is the method of any of embodiments 10-12, wherein controlling the force includes dynamically adjusting the force during the relative movement.

Embodiment 14 is the method of any of embodiments 10-13, further comprising determining an amount of the force to be applied according to image information obtained of the sample disposed on the surface.

Embodiment 15 is the method of any of embodiments 10-14, further comprising controlling a distance between the smear plate and the surface of the sample slide.

Embodiment 16 is the method of any of embodiments 10-15, further comprising assessing the sample distributed on the slide according to an image of the sample to determine a smear characteristic, and causing additional relative movement between the smear plate and the sample slide to further distribute the sample on the surface of the sample slide responsive to the smear characteristic.

Embodiment 17 is a method of sample staining, the method comprising: arranging a sample slide and a coverslip in a flood start position; the flood start position being defined such that a slide surface of the sample slide having a sample disposed thereon and a slip surface of the coverslip have a vertical gap and the sample slide and the coverslip have a horizontal overlap, the vertical gap and the horizontal overlap defining a volume; applying a fluid to at least one of the sample slide or the coverslip such that the fluid is present at the vertical gap when the sample slide and the coverslip are arranged in the flood start position; arranging the sample slide and the coverslip in a flood finish position through relative movement that increases the horizontal overlap, the flood finish position being defined such that the horizontal overlap has a maximum horizontal distance, thereby causing the fluid to fill the volume; and applying additional fluid to the at least one of the sample slide or the coverslip to fill the volume as the horizontal overlap increases.

Embodiment 18 is the method of embodiment 18, further comprising arranging the sample slide and the coverslip in a flush position through conforming movement, the flush position being defined by a flush angle between the sample slide and the coverslip and a horizontal reference, and applying an additional fluid at the vertical gap to flush the fluid.

Embodiment 19 is the method of any of embodiments 14-18, wherein the vertical gap is defined by a vertical distance between approximately 0.05-0.25 mm and the horizontal overlap at the flood start position is defined by a horizontal distance between 1 and 10 mm.

Embodiment 20 is a sample cartridge, the sample cartridge comprising: a cartridge frame including a slide support configured to support a sample slide, and a cartridge drawer including a coverslip support configured to support a coverslip at a coverslip window, the cartridge drawer being configured for movement relative to the cartridge frame, wherein the cartridge frame and the cartridge drawer are configured to cooperate to maintain a vertical gap between the sample slide and the coverslip, and wherein the cartridge drawer is further configured to move from a flood start position relative to the cartridge frame to a flood finish position relative to the cartridge frame.

Embodiment 21 is the sample cartridge of embodiment 20, wherein the cartridge drawer further comprises a smear plate support configured to support a smear plate, and the cartridge drawer is further configured to adopt a smear position relative to the cartridge frame aligning the smear plate with the sample slide for smearing the sample.

Embodiment 22 is the sample cartridge of embodiment 20 or 21, further comprising a receptacle support, wherein the cartridge drawer further comprises a receptable window, the cartridge drawer is configured to adopt a sampling position relative to the cartridge frame wherein the sample receptable is supported by the receptable support, and the cartridge drawer is configured to adopt a transfer position relative to the cartridge frame aligning the receptable window with the slide support in a position that permits transfer of a sample in the sample receptacle to the sample slide when positioned in the slide support.

Embodiment 23 is the sample cartridge of embodiment 22, wherein movement by the cartridge drawer from the flood start position to the flood finish position is configured to spread a staining fluid between the coverslip and sample slide.

Embodiment 24 is the sample cartridge of any of embodiments 20-23, further comprising a cuspidor configured to contain an absorbent medium.

Embodiment 25 is the sample cartridge of any of embodiments 20-24, wherein the cartridge frame further comprises a pair of rails, and the cartridge drawer is configured for relative movement with respect to the cartridge frame on the pair of rails.

Embodiment 26 is the sample cartridge of embodiment 25, wherein the cartridge frame further comprises a frame gear drive rack configured to receive a frame drive gear, the cartridge drawer further comprises a drawer gear drive rack configured to receive a drawer drive gear, and the frame gear drive rack and the drawer gear drive rack are configured to cause the relative movement between the cartridge frame and the cartridge drawer.

Embodiment 27 is the sample cartridge of any of embodiments 20-26, wherein the sample slide is a second sample slide and the slide support is configured to support a first sample slide disposed beneath the second sample slide.

Embodiment 28 is the sample cartridge of any of embodiments 20-27, wherein the cartridge drawer is further configured to adopt a receptacle release position relative to the cartridge frame for releasing the sample receptacle from the sample cartridge.

Embodiment 29 is the sample cartridge of any of embodiments 20-28, wherein the cartridge drawer is further configured to move the sample slide into a slide ejection position.

Embodiment 30 is a method for sample preparation, the method comprising: arranging a sample slide disposed within a cartridge frame of a sample cartridge and a coverslip disposed within a cartridge drawer of the sample cartridge in a flood start position, the flood start position being defined such that a slide surface of the sample slide having a sample disposed thereon and a slip surface of the coverslip have a vertical gap and the sample slide and the coverslip have a horizontal overlap, the vertical gap and the horizontal overlap defining a volume, receiving a fluid at a vertical gap between the sample slide and the coverslip, and moving the cartridge drawer relative to the cartridge frame from a flood start position to a flood finish position.

Embodiment 31 is the method of embodiment 30, further comprising depositing the sample in a sample receptacle, moving the cartridge drawer relative to the cartridge frame from the sampling position to a transfer position that aligns a sample slide supported in a slide support of the cartridge frame with a receptacle window of the cartridge drawer, and transferring the sample from the sample receptacle to the sample slide by passing the sample receptacle through the receptacle window to permit the sample to contact the sample slide.

Embodiment 32 is the method of embodiment 30 or 31, further comprising moving the cartridge drawer relative to the cartridge frame to a smear position that aligns a smear plate support of the cartridge frame with the sample slide, and smearing the sample against the sample slide with a smear plate disposed within the smear plate support.

Embodiment 33 is the method of any of embodiments 30-32, further comprising spreading the fluid between the sample slide and the coverslip during movement by the cartridge drawer from the flood start position to the flood finish position.

Embodiment 34 is the method of any of embodiments 30-33, further comprising receiving a flush fluid at the vertical gap, and flushing the fluid with the flush fluid.

Embodiment 35 is the method of any of embodiments 30-34, further comprising absorbing excess fluid or flush fluid by an absorbent medium arranged within a cuspidor of the sample cartridge.

Embodiment 36 is the method of any of embodiments 30-35, wherein moving the cartridge drawer relative to the cartridge frame includes engaging a frame gear drive rack disposed on the cartridge frame with a frame drive gear, engaging a drawer gear drive rack disposed on the cartridge drawer with a drawer drive gear, and controlling movement of the cartridge drawer on a pair of rails of the cartridge frame with at least one of the frame drive gear and the drawer drive gear.

Embodiment 37 is the method of any of embodiments 30-36, wherein the sample slide is a second sample slide, the method further comprising transferring the sample from the sample receptacle to a first sample slide disposed beneath the second sample slide, smearing the sample on the first sample slide, and ejecting the first sample slide.

Embodiment 38 is the method of any of embodiments 30-37, wherein moving the cartridge drawer relative to the cartridge frame from the sampling position to the transfer position includes moving the cartridge drawer into a receptacle release position, and receiving the sample receptacle by a sample transfer mechanism.

Embodiment 39 is the method of any of embodiments 30-38, further comprising moving the sample slide into an ejection position.

Embodiment 40 is the method of any of embodiments 30-39, further comprising obtaining an image of the sample slide.

Embodiment 41 is the method of embodiment 40, wherein obtaining an image of the sample slide is performed while the sample slide and the coverslip are overlapping.

Embodiment 42 is the method of embodiment 40 or 41, further comprising ejecting the sample slide prior to obtaining the image.

Embodiment 43 is a sample processing system, the sample processing system comprising: at least one processing circuit, an insertion bay configured to receive a sample cartridge having a cartridge frame and a cartridge drawer, and a linear drive system, controllable by the at least one processing circuit and configured to generate relative movement between the cartridge fame and the cartridge drawer.

Embodiment 44 is the sample processing system of embodiment 43, further comprising a probe disposed on a probe drive system, wherein the at least one processing circuit is configured to: provide a transfer position command to the linear drive system to cause the cartridge drawer to adopt a transfer position relative to the cartridge frame aligning a receptacle window of the cartridge drawer with a sample slide supported by the cartridge frame, and provide a probe transfer command to the probe drive system to: bring a sample receptacle into proximity with the sample slide, and transfer a sample from the sample receptacle to the sample slide by a probe.

Embodiment 45 is the sample processing system of embodiment 43 or 44, further comprising an imaging device, wherein the at least one processing circuit is configured to provide an imaging command to the imaging device to cause the imaging device to capture image information of the sample on the sample slide.

Embodiment 46 is the sample processing system of any of embodiments 43-45, further comprising an actuated probe including a gripping mechanism, wherein the at least one processing circuit is further configured to: provide a smear position command to the linear drive system to cause the cartridge drawer to adopt a smear position relative to the cartridge frame aligning a smear plate disposed in the cartridge drawer with the sample slide, and provide a smearing command to the actuated probe to cause the gripping mechanism disposed on the actuated probe to contact the smear plate and cause the smear plate to press the sample on the sample slide.

Embodiment 47 is the sample processing system of any of embodiments 43-46, further comprising a fluid dispenser, wherein the at least one processing circuit is configured to: provide a flood start position command to the linear drive system to cause the cartridge drawer to adopt a flood start position wherein a coverslip disposed in the cartridge drawer is maintained with a vertical gap between the sample slide and the coverslip, provide a fluid dispensing command to cause the fluid dispenser to provide a fluid to the coverslip at the vertical gap, and provide a flood finish position command to the linear drive system to cause the cartridge drawer to adopt a flood finish position.

Embodiment 48 is the sample processing system of embodiment 47, further comprising a sample orientation system, wherein the at least one processing circuit is further configured to provide a rotation command to the sample orientation system to cause the insertion bay to rotate from a substantially horizontal position to an angled position.

Embodiment 49 is the sample processing system of embodiment 48, wherein the at least one processing circuit is further configured to provide a flush command to cause the fluid dispenser to provide a flush fluid to the vertical gap to flush the fluid.

Embodiment 50 is the sample processing system of any of embodiments 43-49, wherein the at least one processing circuit is configured to provide a receptacle release position command to the linear drive system to cause the cartridge drawer to adopt a receptacle release position relative to the cartridge frame for releasing a sample receptacle from the sample cartridge.

Embodiment 51 is the sample processing system of any of embodiments 43-50, wherein the at least one processing circuit is configured to provide a slide ejection command to the linear drive system to cause the cartridge drawer to adopt a slide ejection position.

Embodiment 52 is the sample processing system of any of embodiments 44-51, wherein the at least one processing circuit is configured to provide a receptacle release command to the probe drive system to cause the probe drive system to release the sample receptacle to a receptacle receipt system.

Embodiment 53 is the sample processing system of any of embodiments 43-52, wherein the linear drive system is configured to engage a cartridge drive system of the sample cartridge.

Embodiment 54 is a sample cartridge, the sample cartridge comprising: one or more sample receptacles, one or more sample slides, one or more staining fluids, and one or more cover slips.

Embodiment 55 is the sample cartridge or embodiment 54, further comprising a first cartridge component and a second cartridge component, wherein the first cartridge component and the second cartridge component are configured for relative movement with respect to one another in a linear dimension.

Embodiment 56 is the sample cartridge of embodiment 54 or 55, wherein at least one of the one or more sample receptacles and the one or more sample slides are removable.

Embodiment 57 is the sample cartridge of any of embodiments 54-56, wherein the sample cartridge is configured to facilitate processing of a sample contained therein such that no part of the sample contacts a sample processing system operating on the sample cartridge.

Embodiment 58 is a sample processing system, the sample processing system comprising: a sample handling system including: a sample transfer mechanism, a sample smearing mechanism, and a sample movement mechanism, a fluid distribution system, and a control system.

Embodiment 59 is the sample processing system of embodiment 58, further comprising at least one imaging device.

Embodiment 60 is the sample processing system of embodiment 58 or 59, wherein the sample handling system is configured to receive a sample cartridge containing a sample, and the control system is configured to cause the sample handling system to manipulate the sample cartridge to perform sample processing steps without the sample contacting the sample transfer mechanism. the sample smearing mechanism, the sample orientation mechanism, or the sample movement mechanism.

Embodiment 61 is a sample cartridge comprising: a first cartridge component including a slide support configured to support a sample slide; and a second cartridge component including a receptacle window, the second cartridge component being configured for movement relative to the first cartridge component, wherein: the second cartridge component is configured to adopt a sampling position relative to the first cartridge component to support a sample receptacle, and the second cartridge component is configured to adopt a transfer position relative to the first cartridge component aligning the receptacle window with the slide support in a position that permits transfer of a sample in the sample receptacle to the sample slide when positioned in the slide support.

Embodiment 62 is a method for sample preparation, comprising: depositing a sample in a sample receptacle of a sample cartridge having a first cartridge component and a second cartridge component arranged in a sampling position relative to one another; moving the second cartridge component relative to the first cartridge component from the sampling position to a transfer position that aligns a sample slide supported in a slide support of the first cartridge component with a receptacle window of the second cartridge component; and transferring the sample from the sample receptacle to the sample slide.

Embodiment 63 is a sample cartridge comprising: a first cartridge component including a slide support configured to support a sample slide; and a second cartridge component including a smear plate support configured to support a smear plate, wherein: the second cartridge component is configured to adopt a smear position relative to the first cartridge component aligning the smear plate with the sample slide for smearing the sample.

Embodiment 64 is a method for sample preparation, comprising: arranging a second cartridge component of a sample cartridge relative to a first cartridge component of the sample cartridge to a smear position that aligns a smear plate support of the second cartridge component with a sample slide supported by the first cartridge component; and smearing the sample against the sample slide with a smear plate disposed within the smear plate support.

We claim:

1. A method of sample separation, comprising:
depositing a sample in a sample receptacle, the sample receptacle comprising a membrane;
aligning the sample receptacle with a sample slide;
applying a probe to an underside of the sample receptacle to cause a motion of the membrane; and
pressing the sample to the sample slide via the motion to deposit at least a portion of the sample on the sample slide.

2. The method of claim 1, further comprising selecting the probe according to a sample type, wherein a shape of the probe corresponds to the sample type.

3. The method of claim 1, further comprising selecting a probing characteristic according to a sample type.

4. The method of claim 3, wherein the probing characteristic includes a probe movement characteristic including at least one of probe force, probe speed, and probe trajectory.

5. The method of claim 3, wherein the probing characteristic includes a probe shape characteristic.

6. The method of claim 1, further comprising assessing the sample to determine at least one of:
an amount of the sample deposited, and
a characteristic of the sample.

7. The method of claim 6, wherein assessing the sample is performed based on a captured image.

8. The method of claim 6, wherein assessing the sample is performed during depositing of the sample.

9. The method of claim 1, further comprising engaging a lip of the membrane with the sample to remove excess sample from the sample slide.

10. A method of sample smearing, comprising:
engaging, via an actuated probe, a gripping device with a first side of a smear plate;
controlling the actuated probe to cause contact between a second side of the smear plate and a sample disposed on a surface of a sample slide;
controlling a force applied to the smear plate during contact with the sample; and
causing relative movement between the smear plate and the sample slide to distribute the sample on the surface of the sample slide.

11. The method of claim 10, wherein controlling the force is performed according to a force measurement made by a force sensor associated with the actuated probe.

12. The method of claim 10, wherein the gripping device includes a compliant suction cup.

13. The method of claim 10, wherein controlling the force includes dynamically adjusting the force during the relative movement.

14. The method of claim 10, further comprising determining an amount of the force to be applied according to image information obtained of the sample disposed on the surface.

15. The method of claim 10, further comprising controlling a distance between the smear plate and the surface of the sample slide.

16. The method of claim 10, further comprising:
assessing the sample distributed on the sample slide according to an image of the sample to determine a smear characteristic; and
causing additional relative movement between the smear plate and the sample slide to further distribute the sample on the surface of the sample slide responsive to the smear characteristic.

17. A method of sample staining, comprising:
arranging a sample slide and a coverslip in a flood start position; the flood start position being defined such that a slide surface of the sample slide having a sample disposed thereon and a slip surface of the coverslip have a vertical gap and the sample slide and the coverslip have a horizontal overlap, the vertical gap and the horizontal overlap defining a volume;
applying a fluid to at least one of the sample slide or the coverslip such that the fluid is present at the vertical gap when the sample slide and the coverslip are arranged in the flood start position;
arranging the sample slide and the coverslip in a flood finish position through relative movement that increases the horizontal overlap, the flood finish position being defined such that the horizontal overlap has a maximum horizontal distance, thereby causing the fluid to fill the volume; and
applying additional fluid to the at least one of the sample slide or the coverslip to fill the volume as the horizontal overlap increases.

18. The method of claim 17, further comprising:
arranging the sample slide and the coverslip in a flush position through conforming movement, the flush position being defined by a flush angle between the sample slide and the coverslip and a horizontal reference; and
applying a second fluid at the vertical gap to flush the fluid.

19. The method of claim 17, wherein the vertical gap is defined by a vertical distance between approximately 0.05-0.25 mm and the horizontal overlap at the flood start position is defined by a horizontal distance between 1 and 10 mm.

20. A sample cartridge comprising:
a first cartridge component including a slide support configured to support a sample slide; and
a second cartridge component including a coverslip support configured to support a coverslip at a coverslip window, the second cartridge component being configured for movement relative to the first cartridge component,
wherein:
the first cartridge component and the second cartridge component are configured to cooperate to maintain a vertical gap between the sample slide and the coverslip, and
the second cartridge component is further configured to move from a flood start position relative to the first cartridge component to a flood finish position relative to the first cartridge component.

21. The sample cartridge of claim 20, wherein the second cartridge component further comprises a smear plate support configured to support a smear plate, and
the second cartridge component is further configured to adopt a smear position relative to the first cartridge component aligning the smear plate with the sample slide for smearing the sample.

22. The sample cartridge of claim 20, further comprising:
a receptacle support, and wherein:
the second cartridge component further comprises a receptacle window,
the second cartridge component is configured to adopt a sampling position relative to the first cartridge component wherein a sample receptacle is supported by the receptacle support, and
the second cartridge component is configured to adopt a transfer position relative to the first cartridge component aligning the receptacle window with the slide support in a position that permits transfer of a sample in the sample receptacle to the sample slide when positioned in the slide support

23. The sample cartridge of claim 22, wherein relative movement by the second cartridge component from the flood start position to the flood finish position is configured to spread a staining fluid between the coverslip and sample slide.

24. The sample cartridge of claim 20, further comprising a cuspidor configured to contain an absorbent medium.

25. The sample cartridge of claim 20, wherein:
the first cartridge component further comprises a pair of rails, and
the second cartridge component is configured for relative movement with respect to the first cartridge component on the pair of rails.

26. The sample cartridge of claim 25, further comprising a cartridge drive system, the cartridge drive system being configured to cause the relative movement between the first cartridge component and the second cartridge component.

27. The sample cartridge of claim 20, wherein the sample slide is a second sample slide and the slide support is configured to support a first sample slide disposed beneath the second sample slide.

28. The sample cartridge of claim 22, wherein:
the second cartridge component is further configured to adopt a receptacle release position relative to the first cartridge component for releasing the sample receptacle from the sample cartridge.

29. The sample cartridge of claim 20, wherein the second cartridge component is further configured to move the sample slide into a slide ejection position.

30. A method for sample preparation, comprising:
arranging a sample slide disposed within a first cartridge component of a sample cartridge and a coverslip disposed within a second cartridge component of the sample cartridge in a flood start position, the flood start position being defined such that a slide surface of the sample slide having a sample disposed thereon and a slip surface of the coverslip have a vertical gap and the sample slide and the coverslip have a horizontal overlap, the vertical gap and the horizontal overlap defining a volume;
receiving a fluid at a vertical gap between the sample slide and the coverslip; and
moving the second cartridge component relative to the first cartridge component from a flood start position to a flood finish position.

31. The method of claim 30, further comprising:
depositing the sample in a sample receptacle supported by the sample cartridge in a sampling position;
moving the second cartridge component relative to the first cartridge component from the sampling position to a transfer position that aligns a sample slide supported in a slide support of the first cartridge component with a receptacle window of the second cartridge component; and
transferring the sample from the sample receptacle to the sample slide by passing the sample receptacle through the receptacle window to permit the sample to contact the sample slide.

32. The method of claim 30, further comprising:
moving the second cartridge component relative to the first cartridge component to a smear position that aligns a smear plate support of the second cartridge component with the sample slide; and
smearing the sample against the sample slide with a smear plate disposed within the smear plate support.

33. The method of claim 30, further comprising:
spreading the fluid between the sample slide and the coverslip during relative movement by the second cartridge component from the flood start position to the flood finish position.

34. The method of claim 30, further comprising:
receiving a flush fluid at the vertical gap; and
flushing the fluid with the flush fluid.

35. The method of claim 30, further comprising absorbing excess fluid or flush fluid by an absorbent medium arranged within a cuspidor of the sample cartridge.

36. The method of claim 30, wherein moving the second cartridge component relative to the first cartridge component includes:
engaging a cartridge drive system with a linear drive system; and
controlling relative movement of the second cartridge component on a pair of rails of the first cartridge component with the linear drive system.

37. The method of claim 30, wherein the sample slide is a second sample slide, the method further comprising:
transferring the sample from a sample receptacle to a first sample slide disposed beneath the second sample slide;
smearing the sample on the first sample slide; and
ejecting the first sample slide.

38. The method of claim 31, wherein moving the second cartridge component relative to the first cartridge component from the sampling position to the transfer position includes:
moving the second cartridge component into a receptacle release position; and
receiving the sample receptacle by a sample transfer mechanism.

39. The method of claim 30, further comprising moving the sample slide into an ejection position.

40. The method of claim 30, further comprising:
obtaining an image of the sample slide.

41. The method of claim 40, wherein obtaining an image of the sample slide is performed while the sample slide and the coverslip are overlapping.

42. The method of claim 40, further comprising ejecting the sample slide prior to obtaining the image.

43. A sample processing system comprising:
at least one processing circuit;
an insertion bay configured to receive a sample cartridge having a first cartridge component and a second cartridge component;
a linear drive system, controllable by the at least one processing circuit and configured to generate relative movement between the first cartridge component and the second cartridge component.

44. The sample processing system of claim 43, further comprising a probe disposed on a probe drive system,
wherein the at least one processing circuit is configured to:
provide a transfer position command to a linear drive system to cause the second cartridge component to adopt a transfer position relative to the first cartridge component aligning a receptacle window of the second cartridge component with a sample slide supported by the first cartridge component; and
provide a probe transfer command to the probe drive system to:
bring a sample receptacle into proximity with the sample slide, and
transfer a sample from the sample receptacle to the sample slide by a probe.

45. The sample processing system of claim 43, further comprising an imaging device,
wherein the at least one processing circuit is configured to provide an imaging command to the imaging device to cause the imaging device to capture image information of a sample on a sample slide.

46. The sample processing system of claim 43,
further comprising an actuated probe including a gripping mechanism,
wherein the at least one processing circuit is further configured to:
provide a smear position command to the linear drive system to cause the second cartridge component to adopt a smear position relative to the first cartridge component aligning a smear plate disposed in the second cartridge component with a sample slide; and
provide a smearing command to the actuated probe to cause the gripping mechanism disposed on the actuated probe to contact the smear plate and cause the smear plate to press the sample on the sample slide.

47. The sample processing system of claim 43, further comprising a fluid dispenser,
wherein the at least one processing circuit is configured to:
provide a flood start position command to the linear drive system to cause the second cartridge component to adopt a flood start position wherein a coverslip disposed in the second cartridge component is maintained with a vertical gap between a sample slide and the coverslip,
provide a fluid dispensing command to cause the fluid dispenser to provide a fluid to the coverslip at the vertical gap, and
provide a flood finish position command to the linear drive system to cause the second cartridge component to adopt a flood finish position.

48. The sample processing system of claim 47, further comprising a sample orientation system,
wherein the at least one processing circuit is further configured to:
provide a rotation command to the sample orientation system to cause the insertion bay to rotate from a substantially horizontal position to an angled position.

49. The sample processing system of claim 48, wherein the at least one processing circuit is further configured to provide a flush command to cause the fluid dispenser to provide a flush fluid to the vertical gap to flush the fluid.

50. The sample processing system of claim 43, wherein the at least one processing circuit is configured to provide a receptacle release position command to the linear drive system to cause the second cartridge component to adopt a receptacle release position relative to the first cartridge component for releasing a sample receptacle from the sample cartridge.

51. The sample processing system of claim 43, wherein the at least one processing circuit is configured to provide a slide ejection command to the linear drive system to cause the second cartridge component to adopt a slide ejection position.

52. The sample processing system of claim 44,
wherein the at least one processing circuit is configured to provide a receptacle release command to the probe drive system to cause the probe drive system to release the sample receptacle to a receptacle receipt system.

53. The sample processing system of claim 43, wherein the linear drive system is configured to engage a cartridge drive system of the sample cartridge.

54. A sample cartridge comprising:
one or more sample receptacles;
one or more sample slides;
one or more staining fluids; and
one or more cover slips.

55. The sample cartridge of claim 54, further comprising:
a first cartridge component; and
a second cartridge component,
wherein the first cartridge component and the second cartridge component are configured for relative movement with respect to one another in a linear dimension.

56. The sample cartridge of claim 54, wherein at least one of the one or more sample receptacles and the one or more sample slides are removable.

57. The sample cartridge of claim 54, wherein the sample cartridge is configured to facilitate processing of a sample contained therein such that no part of the sample contacts a sample processing system operating on the sample cartridge.

58. A sample processing system comprising:
a sample handling system including:
a sample transfer mechanism,
a sample smearing mechanism, and
a sample movement mechanism;
a fluid distribution system; and
a control system.

59. The sample processing system of claim 58, further comprising:
at least one imaging device.

60. The sample processing system of claim 58, wherein
the sample handling system is configured to receive a sample cartridge containing a sample, and
the control system is configured to cause the sample handling system to manipulate the sample cartridge to perform sample processing steps without the sample contacting the sample transfer mechanism, the sample smearing mechanism, the sample orientation mechanism, or the sample movement mechanism.

61. A sample cartridge comprising:
a first cartridge component including a slide support configured to support a sample slide; and
a second cartridge component including a receptacle window, the second cartridge component being configured for movement relative to the first cartridge component,
wherein:
the second cartridge component is configured to adopt a sampling position relative to the first cartridge component to support a sample receptacle, and
the second cartridge component is configured to adopt a transfer position relative to the first cartridge component aligning the receptacle window with the slide support in a position that permits transfer of a sample in the sample receptacle to the sample slide when positioned in the slide support.

62. A method for sample preparation, comprising:
depositing a sample in a sample receptacle of a sample cartridge having a first cartridge component and a second cartridge component arranged in a sampling position relative to one another;
moving the second cartridge component relative to the first cartridge component from the sampling position to a transfer position that aligns a sample slide supported in a slide support of the first cartridge component with a receptacle window of the second cartridge component; and
transferring the sample from the sample receptacle to the sample slide.

63. A sample cartridge comprising:
a first cartridge component including a slide support configured to support a sample slide; and
a second cartridge component including a smear plate support configured to support a smear plate,
wherein:
the second cartridge component is configured to adopt a smear position relative to the first cartridge component aligning the smear plate with the sample slide for smearing the sample.

64. A method for sample preparation, comprising:
arranging a second cartridge component of a sample cartridge relative to a first cartridge component of the sample cartridge to a smear position that aligns a smear plate support of the second cartridge component with a sample slide supported by the first cartridge component; and
smearing the sample against the sample slide with a smear plate disposed within the smear plate support.
